(19) United States
(12) Patent Application Publication
(10) Pub. No.: US 2025/0303360 A1
(43) Pub. Date: Oct. 2, 2025

(54) CONTACTOR MEDIA AND CONTACTOR SYSTEMS FOR FLUIDS

(71) Applicant: Intrnls, Inc, Wales, WI (US)

(72) Inventors: David A. Walker, Wales, WI (US); Matthew N. Pearlson, Wales, WI (US)

(21) Appl. No.: 19/241,311

(22) Filed: Jun. 17, 2025

Related U.S. Application Data
(63) Continuation-in-part of application No. 18/986,605, filed on Dec. 18, 2024.
(60) Provisional application No. 63/611,489, filed on Dec. 18, 2023.

(51) Int. Cl. B01D 53/78

(52) U.S. Cl. CPC B01D 53/78; B01D 2247/04; B01D 2259/124

(57) ABSTRACT

A contactor media can include continuous surface segments. The continuous surface segments can define first and second capillary flow paths. A first continuous surface segment can have at least 50% of its surface area follow at least one of: (a) a contour of a first zero-thickness surface having a Gaussian curvature (“G_{c}”) of −400 mm⁻²≤G_{c}<−0.01 mm⁻²; and (b) a contour of a second zero-thickness surface having at least one principal curvature (kᵢ) of −20 mm⁻¹≤kᵢ<−0.1 mm⁻¹.

### CROSS REFERENCE TO RELATED APPLICATIONS

This application claims the benefit of and priority to U.S. Provisional Application No. 63/611,489 filed Dec. 18, 2023, and is a continuation-in-part of U.S. application Ser. No. 18/986,605, the contents of which are incorporated herein by reference in their entirety.

### FIELD

The present technology is generally related to fluid contactors and contactor media for gas-liquid contactors, and more specifically is related to phase-phase contactors (e.g., gas-liquid contactors and liquid-liquid contactors).

### BACKGROUND

Gas-liquid contactors are utilized in industrial processes to help facilitate mass exchange between gas and liquid phases. Sometimes, gas-liquid contactors are as rudimentary as simple evaporative processes (e.g., a ‘swamp cooler’ in which water evaporates into the air); but the same technologies can be leveraged for more complex processes (e.g., carbon dioxide scrubbing and capture).

### SUMMARY

There may exist a desire to increase phase-phase (e.g., gas-liquid or liquid-liquid) contact surface area of a contactor media while also using a geometry that decreases operational costs. In this context, operating costs may be driven by the electricity needed to operate fans and pumps that induce motion in the different phases, respectively. For example, fans may move the gas phase through the densely packed media, while pumps may recirculate the liquid phase to the top of the packed media stack to continually wet the media surface, where the liquid phase trickles down through the media due to gravity. The selection of appropriate gas-liquid contactor media may seek to increase mass transfer rates while decreasing these costs. As such, the pressure drop of the gas stream moving through the media and hold-up of the liquid stream trickling down through the media are parameters of interest to decrease and increase, respectively. Furthermore, conventional contactor media is typically physically manipulated (e.g., thermoformed into corrugated architectures) in order to assist in wetting of the contactor media by the liquid and usually necessitates higher flow rates of the liquid phase; consequently, these factors typically increase pressure drop of the gas stream moving through the media.

The systems and methods disclosed herein include contactor media with continuous surfaces to structure the liquid phase via surface wetting (e.g., capillary action) which occur in designed regions of curvature. The high surface area of the contactor media, along with appropriate regions of curvature, can hold more liquid, increasing liquid phase hold-up, while also structuring the liquid phase over large spans that increase gas-liquid exchange, as compared to conventional contactor media.

In one aspect, a contactor media is disclosed. The contactor media includes continuous surface segments, wherein a first continuous surface segment has at least 50% of its surface area follow at least one of: (a) a contour of a first zero-thickness surface having a Gaussian curvature (“G_{c}”) of −400 mm⁻²≤G_{c}<−0.01 mm⁻²; and (b) a contour of a second zero-thickness surface having at least one principal curvature (kᵢ) of −20 mm⁻¹≤kᵢ<−0.1 mm⁻¹. The first continuous surface segment provides at least: (a) a total liquid hold-up of between about 1 kg/m³ to about 800 kg/m³ or (b) a static liquid hold-up of about 0.1 kg/m³ to about 800 kg/m³.

The first continuous surface segment may have a geometry that is different from that of a second continuous surface segment. At least 80% of the first continuous surface segment may follow the contour of the first zero-thickness surface having the Gaussian curvature of −100 mm⁻²≤G_{c}<0 mm⁻². The first continuous surface segment may have a thickness of about 1 μm to about 100 mm. The contactor medium may further include a second continuous surface segment joined to the first continuous surface segment, wherein the second continuous surface segment has a thickness different from that of the first continuous surface segment. The contactor medium may further include a second continuous surface segment that has at least 50% of its surface area follow at least one of: (a) a contour of a third zero-thickness surface having a Gaussian curvature (“G_{c}”) of −400 mm⁻²≤G_{c}<−0.01 mm⁻²; and (b) a contour of a fourth zero-thickness surface having at least one principal curvature (kᵢ) of −20 mm⁻¹≤kᵢ<−0.1 mm⁻¹.

At least some of the continuous surface segments may include a periodic surface geometry. The periodic surface geometry may be a triply periodic surface geometry. The first continuous surface segment may include a sheet gyroid. The first continuous surface segment may form a tube. The contactor medium may include a plurality of the tubes arranged in a hexagonal packing structure. The first continuous surface segment may form a rectangular prism. The contactor medium may include a plurality of the rectangular prisms arranged parallel to one another.

Each continuous surface segment may include a unit cell; and the contactor media may include a plurality of the unit cells arranged in a repeating pattern. The first continuous surface segment may include a first repeating unit cell, a second continuous surface segment may include a second repeating unit cell, and a third continuous surface segment may include a third repeating unit cell. The first continuous surface segment and the third continuous surface segment may be disposed directly on opposite sides of the second continuous surface segment, forming an I-beam shape.

The contactor media may further include a carbon dioxide (CO₂) capture liquid. The CO₂ capture liquid may include MEA (monoethanolamine), DEA (diethanolamine), TEA (triethanolamine), MDEA (methyl diethanolamine), piperazine, glycine, KVO₃ (potassium metavanadate), KOH (potassium hydroxide), NaOH (sodium hydroxide), LiOH (lithium hydroxide), Ca(OH)₂ (calcium hydroxide), an amino acid, or a combination of any two or more thereof. The contactor media may include CO₂ capture liquid flow in a first direction and gas flow in a second direction, the second direction being cross-flow, counter-flow, or concurrent flow to the first direction. The first continuous surface segment may include a surface with surface features of about 1 μm to about 500 μm.

In another aspect, a contactor media is disclosed. The contactor media includes a gyroidal continuous surface segment forming a channel with a bilobed-shaped cross-section; wherein the gyroidal continuous surface segment has at least 50% of its surface area follow at least one of: (a) a contour of a first zero-thickness surface having a Gaussian curvature (“G_{c}”) of −400 mm⁻²≤G_{c}<−0.01 mm⁻²; and (b) a contour of a second zero-thickness surface having at least one principal curvature (kᵢ) of −20 mm⁻¹≤kᵢ<−0.1 mm⁻¹; and wherein the gyroidal continuous surface segment provides at least: (a) a total liquid hold-up of between about 1 kg/m³ to about 800 kg/m³ or (b) a static liquid hold-up of about 0.1 kg/m³ to about 800 kg/m³.

Also disclose herein are contactor media including continuous surface segments, forming a contactor body. At least 50% of a surface area of a first continuous surface segment follows at least one contour selected from the group consisting of (a) a first contour of a first zero-thickness surface having a Gaussian curvature (“G_{c}”) of −400 mm⁻²≤G_{c}<−0.01 mm⁻²; (b) a second contour of a second zero-thickness surface having at least one principal curvature (kᵢ) of −20 mm⁻¹≤kᵢ<−0.1 mm⁻¹, or any combinations thereof.

In one aspect, the at least one contour defines a first continuous capillary flow path extending in a first direction across the contactor body. The contactor body further defines a second continuous capillary flow path extending in the first direction across the contractor body and spaced apart from the first continuous capillary flow path transverse to the first direction. The first continuous capillary flow path and the second capillary continuous flow path are separated by one or more inactive surfaces such that flow from the first continuous capillary flow path to second continuous capillary flow path crosses the inactive surfaces transverse to the first direction.

In another aspect, the contactor body includes a first (e.g., upper) terminal end, a second (e.g., lower) terminal end disposed opposite the first terminal end, a first terminal side, and a second terminal side disposed opposite the first terminal side, the first and second terminal sides extending between the first and second terminal ends. The first direction of the first continuous flow path extends in a direction from the first terminal side of the contactor body to the second terminal side of the contactor body.

In another aspect, the contactor body can form a corrugation with an axis substantially parallel to the first continuous capillary flow path, the first continuous capillary flow path extending onto or along the corrugation. The contactor body can include a corrugation with an axis substantially perpendicular to the first continuous capillary flow path, the first continuous capillary flow path extending across the corrugation. In some cases, the contactor body includes a multi-axis corrugation.

In some cases, the contactor media disclosed herein further include an interstitial structure extending from the first continuous surface segment into a continuous flow path defined by the at least one contour. The interstitial structure can add surface area within the continuous flow path. In some cases, the interstitial structure is a lattice structure. In some cases, the lattice structure defines a rectangular grid. In some cases, a hydraulic diameter provided by the interstitial structure in combination with the first continuous surface segment along the continuous flow path is between 0.2 mm and 4 mm. The at least one contour can define a first continuous flow path extending in a first direction across the contactor body. A hydraulic diameter provided by the at least one contour along the continuous flow path is between 0.2 mm and 4 mm.

Also disclosed herein are contactor systems. The contactor systems include a rich material feed configured to transfer rich material to a capture unit, a capture liquid feed configured to transfer a capture fluid to the capture unit. The capture unit, including a contactor media that includes continuous surface segments that form a contactor body. At least 50% of its surface area of a first continuous surface segment of the continuous surface segments follows at least one contour selected from the group consisting of (a) a first contour of a first zero-thickness surface having a Gaussian curvature (“G_{c}”) of −400 mm⁻²≤G_{c}<−0.01 mm⁻²; (b) a second contour of a second zero-thickness surface having at least one principal curvature (kᵢ) of −20 mm⁻¹≤kᵢ<−0.1 mm⁻¹, or any combinations thereof. The first continuous surface segment of the contactor media is configured to support the rich material to interact with the capture liquid, to produce a captured material.

In some cases, the rich material feed includes a fluid. In some cases, the fluid is selected from the group consisting of ambient atmosphere, a point source, or a combination thereof. In some cases, the rich material feed is natural gas. In some cases, the fluid includes carbon dioxide, a sulfur-containing compound, or combinations thereof.

In one aspect, the capture fluid includes a liquid. In some cases, the liquid includes MEA (monoethanolamine), DEA (diethanolamine), TEA (triethanolamine), MDEA (methyl diethanolamine), piperazine, glycine, KVO3 (potassium metavanadate), KOH (potassium hydroxide), NaOH (sodium hydroxide), LiOH (lithium hydroxide), Ca(OH)2 (calcium hydroxide), an amino acid, or any combinations thereof.

In another aspect, the contactor systems disclosed herein can further include a recycled capture liquid feed configured to transfer recycled capture liquid from the captured materials processing unit to the capture unit.

Also disclosed herein, is a method of capturing a material. The method includes wetting at least a portion of a contactor media with a capture liquid, the contactor media comprising continuous surface segments, forming a contactor body. Wetting at least the portion of the contactor media includes wetting a first continuous surface segment of the continuous surface segments, at least 50% of the surface area of the first continuous surface segment follows at least one contour selected from the group consisting of (a) a first contour of a first zero-thickness surface having a Gaussian curvature (“G_{c}”) of −400 mm⁻²≤G_{c}<−0.01 mm⁻²; (b) a second contour of a second zero-thickness surface having at least one principal curvature (kᵢ) of −20 mm⁻¹≤kᵢ<−0.1 mm⁻¹, or any combinations thereof. The method includes flowing a rich material across the contactor media. The method includes reacting the rich material with the capture liquid to produce a deplete material and a captured material.

In another aspect, the contour defines a first continuous capillary flow path transversing across the contactor body. A second continuous capillary flow path transversing across the contractor body disposed below the first a first continuous capillary flow path. The first continuous capillary flow path and the second capillary continuous flow path are separated by inactive surfaces such that flow between the first continuous capillary flow path and second continuous capillary flow path crosses the inactive surfaces.

In another aspect, the contactor media disclosed herein having a first continuous surface segment can provide at least: (a) a total liquid hold-up of between about 1 kg/m³ to about 800 kg/m³ or (b) a static liquid hold-up of about 0.1 kg/m³ to about 800 kg/m³. The liquid is about 1 M KOH at a flow rate of about 0.5 L·s⁻¹·m⁻² and a gas flow frontal velocity is about 1.5 m/s. In some cases, the first continuous surface segment provides a total liquid hold-up of between about 30 kg/m³ to about 120 kg/m³ when the liquid is about 1 M KOH at a flow rate of about 0.5 L·s⁻¹·m⁻² and a gas flow frontal velocity is about 1.5 m/s. In some cases, the first continuous surface segment provides a static liquid hold-up at 1 hour of about 10 kg/m³ to about 120 kg/m³ when the liquid is about 1 M KOH at a flow rate of about 0.5 L·s⁻¹·m⁻² and a gas flow frontal velocity is about 1.5 m/s.

In another aspect of the contactor media disclose herein, in some cases the Gaussian curvature can be about −0.25 mm⁻²≤G_{c}<−4 mm⁻²; and (b) a contour of a second zero-thickness surface having at least one principal curvature (kᵢ) of −0.5 mm⁻¹≤kᵢ<−2 mm⁻¹.

Also disclosed herein is a contactor media including a contactor body that includes a first end, a second end, first side extending between the first and second ends, a second side extending between the first and second ends opposite the first side, a rear face extending between the first and second ends and between the first and second sides, and a front face extending between the first and second ends and between the first and second sides. The contactor body includes continuous surface segments that define internal flow areas of the contactor body, between the front and rear faces, and openings at the front and rear faces that open from the internal flow areas out the contactor body. The internal flow areas include a first capillary flow path and a second capillary flow path. The first capillary flow path is in fluid communication with the second capillary flow path via: one or more first openings of the openings, each of the one or more first openings including a substantially closed boundary (e.g., closed perimeter) at the front face of the contactor body; and one or more second openings of the openings, each of the one or more second openings including a substantially closed boundary (e.g., closed perimeter) at the rear face of the contactor body.

In one aspect, the one or more first openings includes a first plurality of openings at the front face and the one or more second openings includes a second plurality of openings at the rear face.

In another aspect, between the front and rear faces, the contactor body does not include a capillary flow path arranged to provide substantial capillary flow from the first capillary flow path to the second capillary flow path.

In some cases, the first capillary flow path is fluidly connected to the second capillary flow path only by the one or more first openings and the one or more second openings, substantially along a length of the first capillary flow path between the first and second sides (i.e., along at least 90% of the length or more, in total—but not necessarily along 90% of the length continuously).

In some cases, the contactor body defines a sheet. In some cases, the sheet is a corrugated sheet.

In another aspect, the first capillary flow path is defined by a first continuous surface segment. In some cases, at least 50% of a surface area of the first continuous surface segment follows at least one contour selected from the group consisting of (a) a first contour of a first zero-thickness surface having a Gaussian curvature (“G_{c}”) of −400 mm⁻²≤G_{c}<−0.01 mm⁻²; (b) a second contour of a second zero-thickness surface having at least one principal curvature (kᵢ) of −20 mm⁻¹≤kᵢ<−0.1 mm⁻¹, or any combinations thereof. In some cases, the contactor media further includes an interstitial structure extending from the first continuous surface segment to further define the first capillary flow path.

In some cases, the first continuous surface segment follows a repeated gyroid geometry along the contactor body between the first and second sides. In some cases, the repeated gyroid geometry is a partial portion of a gyroid unit cell.

In some cases, the repeated gyroid geometry is a slice of the gyroid unit cell having a thickness of about 25% of a unit thickness of the gyroid unit cell.

Also disclosed herein is a contactor media having a contactor body that includes a first end, a second end, first side extending between the first and second ends, a second side extending between the first and second ends opposite the first side, a rear face extending between the first and second ends and between the first and second sides, and a front face extending between the first and second ends and between the first and second sides. The contactor body includes continuous surface segments that define internal flow areas of the contactor body, between the front and rear faces, and openings at the front and rear faces that open from the internal flow areas out the contactor body. In some cases, the internal flow areas include a first capillary flow path and a second capillary flow path. In some cases, the first capillary flow path is fluidly connected to the second capillary flow path only via the openings at the front and rear faces, along at least 90% of a length of the first capillary flow path between the first and second sides.

In another aspect, the openings include a plurality of first openings, each of the plurality of first openings including a closed perimeter at the front face of the contactor body; and a plurality of second openings of the openings, each of the plurality of second openings including a closed perimeter at the rear face. In some cases, the internal flow areas of the contactor body do not include a capillary flow path that connects the first capillary flow path to the second capillary flow path between the front and rear faces.

### BRIEF DESCRIPTION OF THE DRAWINGS

FIG. 1 is an illustration of a first phase (e.g., a gas) flow and a second phase (e.g., a liquid) flow through an array of tube-shaped contactor media comprising a continuous surface that provides second phase hold-up through surface wetting.

FIG. 2 is an illustration of a first phase (e.g., a gas) flow and a second phase (e.g., a liquid) flow axially through an array of rectangular prism-shaped contactor media comprising a continuous surface that provides second phase hold-up through surface wetting.

FIG. 3 is an illustration of a first phase (e.g., a gas) flow and a second phase (e.g., a liquid) flow diagonally through an array of rectangular prism-shaped contactor media comprising a continuous surface that provides second phase hold-up through surface wetting.

FIG. 4 is an illustration of a first phase (e.g., a gas) flow and a second phase (e.g., a liquid) flow through an array of chevron-shaped, corrugated contactor media comprising a continuous surface that provides second phase hold-up through surface wetting.

FIG. 5 is an illustration of a first phase (e.g., a gas) flow and a second phase (e.g., a liquid) flow through an array of lamellar contactor media comprising a continuous surface that provides second phase hold-up through surface wetting.

FIG. 6 is a photograph of a hexagonal packing array of tube-shaped contactor media, where each tube-shaped media comprises a continuous surface that provides second phase hold-up through surface wetting and a non-woven polymer pad distributor disposed above the tube-shaped contactor media. The tube-shaped contactor media appears blue (alternatively identified by darker grey shading) because of static liquid hold-up of a liquid including blue dye for visualization.

FIG. 7 is a cross-sectional photograph of a plurality of tube-shaped contactor media, where each tube-shaped media comprises a continuous surface that provides second phase hold-up through surface wetting arranged in a hexagonal array. The tube-shaped contactor media appears blue (alternatively identified by darker grey shading) because of static liquid hold-up of a liquid including blue dye for visualization. The arrow indicated the direction of air flow into the plane of the page.

FIG. 8 is an image of a gyroidal tube contactor medium comprising a gyroidal continuous surface that provides second phase hold-up through surface wetting with surface features configured to uniformly fill with second phase. The contactor media appears green (alternatively identified by darker grey shading) because of static liquid hold-up of a liquid including green dye for visualization.

FIG. 9 illustrates, in perspective view, an array of I-beam-shaped contactor media, where each I-beam sheet comprises a continuous surface that provides second phase hold-up through surface wetting.

FIG. 10 is a perspective view of the plurality of I-beam-shaped contactor media of FIG. 9.

FIG. 11 is an illustration of a rectangular section of a gyroidal contactor medium comprising a continuous surface that provides second phase hold-up through surface wetting.

FIG. 12 is an illustration of a gyroidal tube contact medium section formed by rotation distortion of the rectangular gyroidal contactor medium of FIG. 11.

FIG. 13 is an axial cross-sectional illustration of a gyroidal tube contactor medium comprising a continuous surface that provides second phase hold-up through surface wetting.

FIG. 14A is an illustration of a closer view of the gyroidal contactor medium comprising a continuous surface that provides second phase hold-up through surface wetting.

FIG. 14B is the illustration of FIG. 14A with shading indicating surface features for surface wetting.

FIG. 15 is a cross-sectional illustration of surface wetting of the gyroidal contactor medium in FIG. 14A. The inset in the top right is a top down cavity view.

FIG. 16A is an illustration of a downflow hanging contactor media reactor.

FIG. 16B is an illustration of a radial contactor media reactor.

FIG. 17 is a reaction scheme for CO₂ capture in a metal hydroxide liquid used in liquid-air contactors.

FIG. 18 is an illustration of a skeletal gyroid unit cell.

FIG. 19 is an illustration of a three-dimensional array of the skeletal gyroid unit cells of FIG. 18.

FIG. 20 is an illustration of a sheet gyroid unit cell comprising a continuous surface that provides second phase hold-up through surface wetting.

FIG. 21 is an illustration of a three-dimensional array of the sheet gyroid unit cells of FIG. 20.

FIG. 22 is an illustration of three gyroid unit cells that may be used to form an I-beam-shaped structure.

FIG. 23 is an illustration of an I-beam-shaped contactor media comprising a continuous 2D surface with a defined thickness that provides second phase hold-up through surface wetting.

FIG. 24 is an illustration of a second phase distributor disposed on a second phase introduction side of a gyroidal contactor media configured to direct second phase into the gyroidal contactor media.

FIG. 25 is another view of the liquid distributor of FIG. 24.

FIG. 26A is an illustration of a contactor media distribution inlet configured to direct second phase laterally through the distributor layer.

FIG. 26B is an illustration of the contactor media distribution inlet in FIG. 26A showing the potential for lateral second phase flow directions.

FIG. 27A is an illustration of a second phase distributor mid-layer configured to direct second phase flow laterally between regions of contactor media.

FIG. 27B is an illustration of the contactor media in FIG. 27A showing second phase flow directions.

FIG. 28A is an illustration of a radial view of a contactor media comprising a continuous surface that provides second phase hold-up through surface wetting configured to direct second phase vertically.

FIG. 28B is an illustration of an axial view of the contactor media of FIG. 28A.

FIG. 28C is an illustration of a top view of the contactor media of FIG. 28A.

FIG. 29A is an illustration of a radial view of a contactor media comprising a continuous surface that provides second phase hold-up through surface wetting configured to direct second phase horizontally.

FIG. 29B is an illustration of an axial view of the contactor media of FIG. 29A.

FIG. 29C is an illustration of a top view of the contactor media of FIG. 29A.

FIG. 30A is a photograph of the contactor media of FIG. 29A retaining liquid, with the contactor media identified by darker grey shading due to static liquid hold-up of a liquid that is dyed for visualization.

FIG. 30B is the photograph of FIG. 30A with notations indicating liquid flow paths and liquid flow barriers of the contactor media.

FIG. 31A is a photograph of a gyroidal contactor media comprising a continuous surface that provides liquid hold-up through surface wetting at saturation with the liquid, with areas of static liquid hold-up indicated in darker grey shading due to dye in the liquid included for visualization.

FIG. 31B is a photograph of the gyroidal contactor media of FIG. 31A retaining liquid 45 minutes after saturation.

FIG. 31C is a photograph of the gyroidal contactor media of FIG. 31A retaining liquid 95 minutes after saturation demonstrating the contactor media has a static liquid hold-up in excess of 75% of the total liquid hold-up at times greater than 60 minutes following saturation.

FIG. 31D is a photograph of the gyroidal contactor media of FIG. 31A 135 minutes after saturation.

FIG. 31E is a photograph of the gyroidal contactor media of FIG. 31A retaining liquid 205 minutes after saturation.

FIG. 32 is a photograph of evaporation patterns on the gyroidal contactor media of FIG. 31E, with lighter grey shading indicating areas where the liquid has evaporated.

FIG. 33 is a photograph of four different gyroidal contact media that each has a continuous surface that follows a contour of a zero-thickness surface having a Gaussian curvature of decreasing values (left to right; negative values becoming larger in magnitude) and follows a contour of a zero-thickness surface having a principal curvature of decreasing values.

FIG. 34 is a photograph of two different gyroidal contact media that each has a continuous surface with a different thickness.

FIG. 35 shows a photograph of a gyroidal contact media that has a continuous surface that follows the contour of a zero-thickness surface having a Gaussian curvature (“G_{c}”) of −400 mm⁻²≤G_{c}<−0.01 mm⁻², where the geometry is a gyroid of gyroids.

FIG. 36 shows a schematic of an embodiment of a direct air capture system as disclosed herein.

FIG. 37 shows a graphical representation of steady-stated normalized mass transfer coefficient as a function of principle curvature.

FIG. 38 shows a representative normalized mass transfer coefficient (%) as a function of capture solution load (L/s/m²) of the contactor mediums, systems, and methods disclosed herein. The mass transfer coefficient is normalized to a traditional contactor media at a flow of 2.7 L/(sm²).

FIG. 39 shows the steady state normalized mass transfer coefficient as a function of capture solution loading flux (L/s/m²).

FIG. 40 shows a schematic of one embodiment of an air contactor unit as disclosed herein.

FIG. 41 shows a schematic of a method for using a contactor media for direct air capture of carbon dioxide or other substances.

FIG. 42 shows an embodiment of a contactor media as disclosed herein, containing a square grid interstitial structure within a gyroidal contactor media.

FIG. 43 shows an embodiment of a contactor media as disclosed herein, containing a square grid interstitial structure within a gyroidal contactor media, and including 1D corrugations.

FIGS. 44 and 45 show cross section views of the contactor media shown in FIG. 43, along cross section plane 4370.

FIG. 46 shows an embodiment of a contactor media as disclosed herein, containing a square grid interstitial structure within a gyroidal contactor media, and including 1D corrugations.

FIG. 47 shows an embodiment of a contactor media as disclosed herein, including 1D corrugations.

FIG. 48 shows an embodiment of a contactor media as disclosed herein, including 2D corrugations.

FIG. 49 shows an embodiment of a contactor media, used in counter flow geometry, as disclosed herein, including 2D corrugations (inset).

FIG. 50 shows top-down views of cross sections of the contactor media of FIG. 49.

FIG. 51 shows an axial view illustration of the contactor media of FIG. 29A, (as in FIG. 29B) where the grey shading indicates wetted surfaces.

FIG. 52 shows a cross-sectional illustration of full surface wetting of the gyroidal contactor medium in FIG. 14A.

FIG. 53 shows illustrations, in axonometric and top views, of a 5 mm gyroidal contactor unit cell with a 1 mm wall thickness. The left panel shows the full unit cell, the center panel shows 73% of the unit cell, and the right panel shows 62.5% of the unit cell. The inset from the center panel shows top and bottom views of about a 25% slice of the unit cell, starting at the 73% portion of the center panel.

FIG. 54 shows illustrations, in axonometric and top views, of a 5 mm gyroidal contactor unit cell with a 0.3 mm wall thickness. The left panels show the full unit cell, the center panels show 73% of the unit cell, and the right panels show 62.5% of the unit cell. The inset from the center panel shows top and bottom views of about a 25% slice of the unit cell, starting at the 73% portion of the center panel, and the inset from the right panel shows top view and bottom views of about a 25% slice of the unit cell, starting at the 62.5% portion of the right panel.

FIG. 55 shows top-down cross section views of a 5 mm gyroidal unit cell with various offsets relative to the gyroidal geometry.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

### Definitions

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The term “active surface area” as used herein refers to areas of the contactor media where surface wetting (e.g., capillary action) and/or static liquid hold-up may occur or is favored due to the local Gaussian curvature or due to a principal curvature of the domain of the contactor media.

The term “contactor media” (also referred to herein as “contact media”) as used herein refers to objects configured to facilitate phase-phase interactions. The phase-phase interaction may include an interaction of a gas phase and a liquid phase, a first gas phase and a second gas phase, a first liquid phase and a second liquid phase, a first gas phase and a second gas phase, or a combination of any two or more thereof. For example, contactor media may include structures that provide flow through of a first phase and hold-up of a second phase to facilitate phase-phase interactions. For example, contactor media may include structures that provide liquid hold-up to facilitate gas-liquid interactions. For example, contactor media may include sponges, geometric structures, other porous structures, or a combination of any two or more thereof.

The term “phase-phase contact area” as used herein refers to the area of phase-phase interaction. The phase-phase interaction may include an interaction of a gas phase and a liquid phase, a first gas phase and a second gas phase, a first liquid phase and a second liquid phase, or a combination of any two or more thereof. The phase-phase contact area may be determined by the geometry of the contactor media. For example, phase-phase contact area may include pores, cavities, voids, caverns, concave geometry, structures with negative Gaussian curvature, or a combination of any two or more thereof.

The term “gas-liquid contact area” as used herein refers to the area of gas-liquid interaction. The gas-liquid contact area may be determined by the geometry of the contactor media. For example, gas-liquid contact area may include pores, cavities, voids, caverns, concave geometry, structures with negative Gaussian curvature, or a combination of any two or more thereof.

The term “axial” as used herein refers to a parallel direction or vector with respect to a plane of an object, or the plane of a phase (e.g., a liquid or a gas). For example, the object may include the contactor media.

The term “radial” as used herein refers to a perpendicular direction or vector with respect to a plane of an object, or the plane of a phase (e.g., a liquid or a gas). For example, the object may include the contactor media.

The term “continuous surface” as used herein refers to an uninterrupted three-dimensional object that possesses a predetermined thickness, where an approximate midpoint of the predetermined thickness follows the contour of a zero-thickness two-dimensional surface. The zero-thickness surface serves as the underlying structure or shape that the continuous surface conforms to. While the surface is continuous, it does not have to be uniformly thick or consistently angled. For example, the continuous surface may include surface features (e.g., texture) or be embossed, which may provide nonuniform thickness or include angle changes, respectively. As another example, the continuous surface may have a gradient change in thickness across its extent.

The term “zero-thickness surface” as used herein refers to the two-dimensional surface located at the center of the continuous surface's thickness. The zero-thickness surface serves as the midpoint between the outer boundaries of the continuous surface's thickness, effectively dividing it into two equal volumes. The zero-thickness surface does not have a thickness. The zero-thickness surface is a conceptual plane that marks the central reference point of the continuous surface's thickness, providing a basis for understanding the geometry of the continuous surface. For example, the zero-thickness surface can be two-dimensional surface at the center of the thickness of the three-dimensional sheet gyroid.

The term “Gaussian curvature” (G_{c}) as used herein refers to a product of two principal curvatures, K₁ and K₂, defined at a given point on a two-dimensional surface as G_{c}=K₁·K₂. The Gaussian curvature has units of length⁻².

The term “mean curvature” (H) as used herein refers to the mean of two principal curvatures, K₁ and K₂, defined at a given point on a two-dimensional surface as H=(K₁+K₂)/2. The mean curvature has units of length⁻¹.

The term “principal curvature” as used herein refers to two values, a first value, K₁, for the maximum curvature and a second value, K₂, for the minimum curvature of a two-dimensional surface region. The principal curvature values are defined as K₁=1/r₁ and K₂=1/r₂, where r₁ and r₂ are the radii of curvature for the plane of maximal and minimal curvature, respectively. The principal curvature has units of length⁻¹.

The term “negative principal curvature” as used herein refers generally to a concave domain. For example, all points on the inner surface of a cylindrical pipe has at least one negative principal curvature, as this is a concave domain from the viewpoint of the observer.

The term “follow” as used herein means to follow the same overall trend or path as the defined curve or zero-thickness surface, even if the trend or path includes sharp angles, smooth bends, or combinations thereof. For example, follow may mean approximating the trend or path in which a series of flat and/or angled surfaces are utilized to approximate a smooth curvature. For example, follow may include representing complex curvatures with a large number of flat triangular surfaces (e.g., using a CAD (computer assisted design) process). For example, follow may include approximating the overall trend or path of a defined smooth three-dimensional curve with 3D printing processes which produce three dimensional pixels (voxels), and may include flat and/or jagged edges (e.g., having surface features of about 50 μm in size) which approximate the smooth three dimensional curve on the millimeter length scale.

The term “total liquid hold-up” as used herein refers to the sum of the static liquid hold-up and the dynamic liquid hold-up in units of mass per volume (e.g., kg/m³). The total liquid hold-up is dependent upon the liquid viscosity, the surface tension of adhesion (which is dependent on the material chosen for the contactor media and the gas flowing through the contactor media) the geometry of the contactor media, the fluid flow and material being pushed into the system, and the gas flow and material being pushed into the system.

The term “static liquid hold-up” as used herein refers to the amount of liquid measured in the contactor media, with no liquid or gas being actively being pushed into the system, measured in units of mass per volume (e.g., kg/m³). The static liquid hold-up can be measured at any point in time after the liquid ceases being pushed into the contactor media. The static liquid hold-up is dependent on factors including the liquid properties (e.g., viscosity, surface tension, density, and three-phase contact angle) the surface tension of adhesion (which is dependent on the material chosen for the contactor media, surface treatment of the contactor media, and the gas flowing through the contactor media) and the geometry of the contactor media. For example, the static liquid hold-up may be measured by taking a dry contactor media of a known weight and volume, (1) fully immersing the contactor media in a container of liquid until wetted to saturation, (2) removing the contactor media from the container of liquid and allowing the contactor media to drain for a period of time (e.g., 5 minutes, 45 minutes, 60 minutes, 90 minutes, 120 minutes, 140 minutes, or 200 minutes) at a predetermined temperature and relative humidity (e.g., 20° C. to 25° C. and 100% relative humidity to decrease the effects of evaporation on the measurement), and then (3) measuring the weight of the contactor media, where the static liquid hold-up is the amount of liquid remaining in the contactor media measured by subtracting the weight of the dry contactor media from the weight of the wet contactor media measured in step (3).

The term “dynamic liquid hold-up” as used herein refers to the amount of liquid measured in the contactor media with liquid actively being pushed into the system, and air flow being applied to the contactor media, measured in units of mass per volume (e.g., kg/m³). The dynamic liquid hold-up is dependent upon the geometry of the contactor media, the fluid flow and material being pushed into the system, and the gas flow and material being pushed into the system.

The term “substantial capillary flow” indicates capillary flow, under constant flow conditions (i.e., constant temperature, pressure, pressure drop, and fluid composition(s)), along a capillary flow path that connects a first (e.g., capillary) flow path and a second (e.g., capillary) flow paths, that one or more of: exceeds 25% of a concurrent flow rate along the first flow path, or provides more than 25% of a total concurrent flow rate from the first capillary flow path to the second capillary flow path.

### Contactor Media

Disclosed herein are phase-phase (e.g., gas-liquid, liquid-liquid, gas-gas) contactor media with continuous surfaces to structure the phase-phase via surface wetting (e.g., capillary action). The contactor media may provide flow through of a first phase with a substantially lower or similar pressure drop as compared to conventional contactor media. Concurrently, the high surface area surfaces of the contactor media can hold more of a second phase, increasing second phase hold-up, while also structuring the second phase over large spans that increase phase-phase exchange, as compared to conventional contactor media. The contactor media may control second phase flow by using surface wetting to retain the second phase in the contactor media balanced against the force of gravity to pull the second phase down through the contactor media. As described herein, the first phase may be a phase that may flow through the contactor media, and the second phase may be a phase that is configured to capture the first-phase component from the first phase.

The contactor media may have increased active surface area for surface wetting (e.g., capillary action) and/or static liquid hold-up relative to inactive surface area, as compared to conventional contactor media. ‘Inactive’ surface areas are substantially unable to hold liquid, generally contributing substantially nothing to mass transport. For example, media with a higher total surface area, where a greater percentage of the total surface area is inactive, may provide less efficient mass transport than media with lower total surface area where a greater percentage of the total surface area is active surface area. The contactor media disclosed herein may, by having a greater percentage of active surface area, have a higher probability of capturing and holding a droplet of fluid within the contactor media to facilitate mass transport.

The first phase may include a component and the second phase may be a phase that is configured to capture the component from the first phase. The component may be mass (where the contactor facilitates mass transfer) or may be heat transfer (where the contactor facilitates heat transfer). Nonlimiting examples of the mass transfer components include CO₂, NH₃, H₂, O₂, CH₄, SO₂, NO₂, O₃, CO, CH₃SH, NOₓ, SOₓ, or a combination of any two or more thereof. In the case of heat transfer, the transfer may occur via actual transfer of thermal energy between the two phases, or by the evaporation of one phase (e.g., water evaporating). Unless otherwise specified, reference to gas-liquid contactor media may similarly apply to liquid-liquid contactor media and gas-gas contactor media.

The contactor media may be used as a gas-liquid contactor media. For example, the contactor media may be used for CO₂ capture or scrubbing applications. For example, the contactor media may be used for point source capture to reduce CO₂ emissions from flue gas from industrial facilities. As another example, the contactor media may be used in direct air capture (DAC) technologies to remove CO₂ from ambient air. In another example, the contractor media may be used in the scrubbing of CO₂, sulfur-containing compounds (e.g., hydrogen sulfide, sulfur oxides), or other gasses, from a natural gas stream as means of purifying the stream.

For example, the contactor media may include one or multiple continuous surface segments. The continuous surface segments may be joined to form a larger continuous surface segment (e.g., seamless joined during manufacturing or joined together with adhesive following manufacturing). The continuous surface segments may be disposed on one another to form an array of continuous surface segments. The continuous surface segments may include network of flow paths, a network of flow directing structures, or a combination of these; such networks can define a regular or periodic geometry. The material of the continuous surface segments and the geometry of the continuous surface segments may increase (e.g., maximize) a Gibbs free energy of adhesion of the liquid phase to the continuous surface segments.

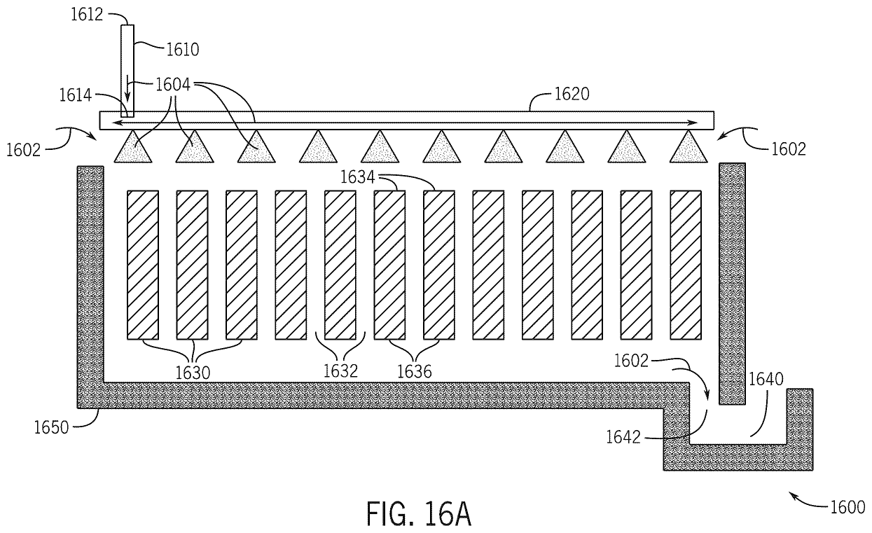

The contactor media may also include surface segments arranged in an array, where each surface segment is a separate continuous surface segment. The segments may be arranged directly disposed on one another or with spacing between segments. The segments may be arranged with even spacing between segments, or with uneven spacing. Spacing between two segments may be even across the space or may be different across the space (e.g., increasing gradient, sine-wave shaped). Spacing may be about 1 mm to about 100 mm (e.g., about 1 mm to about 90 mm, about 1 mm to about 80 mm, about 1 mm to about 70 mm, about 1 mm to about 60 mm, about 1 mm to about 50 mm, about 1 mm to about 40 mm, about 1 mm to about 30 mm, about 1 mm to about 20 mm, or about 1 mm to about 10 mm). For example, the segments may be arranged radially around a central object (e.g., a fan), as shown in FIG. 16B.

In an aspect, a contactor media includes continuous surface segments that provides liquid hold-up through surface wetting. A first continuous surface segment may have at least 50% of its surface area follow at least one of: (a) a contour of a first zero-thickness surface having a Gaussian curvature (“G_{c}”) of −400 mm⁻²≤G_{c}<−0.01 mm⁻²; and (b) a contour of a second zero-thickness surface having at least one principal curvature (kᵢ) of −20 mm⁻¹≤kᵢ<−0.1 mm⁻¹. Continuous surface segments are real, three-dimensional structures that may follow the contour of a theoretical two-dimensional mathematical surface. As non-limiting examples, these two-dimensional mathematical surfaces may include various types of ‘minimal surfaces’ which are defined by being a surface where at all points the mean curvature is zero.

The first continuous surface segment may have a portion of its surface area follow a contour of a first zero-thickness surface having a Gaussian curvature, G_{c}, of −400 mm-2≤G_{c}<−0.0001 mm⁻². For example, the portion of the surface may be at least 20%, at least 30%, at least 40%, at least 50%, at least 60%, at least 70%, at least 80%, or at least 90% of the continuous surface segment surface area. For example, the first zero-thickness surface may have a G_{c} of −400 mm⁻²≤G_{c}<−0.0001 mm⁻², −200 mm⁻²≤G_{c}<−0.0001 mm⁻², −100 mm⁻²≤G_{c}<−0.0001 mm⁻², −50 mm⁻²≤G_{c}<−0.0001 mm⁻², −25 mm⁻²≤G_{c}<−0.0001 mm⁻², −10 mm⁻²≤G_{c}<−0.0001 mm⁻², −4 mm⁻²≤G_{c}<−0.0001 mm⁻², −1 mm⁻²≤G_{c}<−0.0001 mm⁻², −0.25 mm⁻²≤G_{c}<−0.0001 mm⁻², −0.04 mm⁻²≤G_{c}<−0.0001 mm⁻², −0.01 mm⁻²≤G_{c}<−0.0001 mm⁻², −400 mm 2≤G_{c}<−0.004 mm⁻², −200 mm⁻²≤G_{c}<−0.004 mm⁻², −100 mm⁻²≤G_{c}<−0.004 mm⁻², −50 mm⁻²≤G_{c}<−0.004 mm⁻², −25 mm⁻²≤G_{c}<−0.004 mm⁻², −10 mm⁻²≤G_{c}<−0.004 mm⁻², −4 mm⁻²≤G_{c}<−0.004 mm⁻², −1 mm⁻²≤G_{c}<−0.004 mm⁻², −0.25 mm⁻²≤G_{c}<−0.004 mm⁻², −0.04 mm⁻²≤G_{c}<−0.004 mm⁻², −0.01 mm⁻²≤G_{c}<−0.004 mm⁻², −400 mm⁻²≤G_{c}<−0.01 mm⁻², −200 mm⁻²≤G_{c}<−0.01 mm⁻², −50 mm⁻²≤G_{c}<−0.01 mm⁻², −25 mm⁻²<<<−0.01 mm⁻², −10 mm⁻²≤G_{c}<−0.01 mm⁻², −4 mm⁻²≤G_{c}<−0.01 mm⁻², −1 mm⁻²≤G_{c}<−0.01 mm⁻², −0.25 mm⁻²≤G_{c}<−0.01 mm⁻², −0.04 mm⁻²≤G_{c}<−0.01 mm⁻², −400 mm⁻²≤G_{c}<−0.04 mm⁻², −200 mm⁻²≤G_{c}<−0.04 mm⁻², −50 mm⁻²≤G_{c}<−0.04 mm⁻², −25 mm⁻²≤G_{c}<−0.04 mm⁻², −10 mm⁻²≤G_{c}<−0.04 mm⁻², −4 mm⁻²≤G_{c}<−0.04 mm⁻², −1 mm⁻²≤G_{c}<−0.04 mm⁻², −0.25 mm⁻²≤G_{c}<−0.04 mm⁻², −400 mm⁻²≤G_{c}<−0.25 mm⁻², −200 mm⁻²≤G_{c}<−0.25 mm⁻², −50 mm⁻²≤G_{c}<−0.25 mm⁻², −25 mm⁻²≤G_{c}<−0.25 mm⁻², −10 mm⁻²≤G_{c}<−0.25 mm⁻², −4 mm⁻²≤G_{c}<−0.25 mm⁻², −1 mm⁻²≤G_{c}<−0.25 mm⁻², −400 mm⁻²≤G_{c}<−1 mm⁻², −200 mm⁻²≤G_{c}<−1 mm⁻², −50 mm⁻²≤G_{c}<−1 mm⁻², −25 m⁻²≤G_{c}<−1 mm⁻², −10 mm⁻²≤G_{c}<−1 mm⁻², or −4 mm⁻²≤G_{c}<−1 mm⁻². For example, at least 80% of the first continuous surface segment may follow the contour of the first zero-thickness surface having the Gaussian curvature of −100 mm⁻²≤G_{c}<0 mm⁻².

The first continuous surface segment may have a portion of its surface area follow a contour of a second zero-thickness surface having at least one of its principal curvatures, kᵢ, of −40 mm⁻¹≤kᵢ<−0.002 mm⁻¹. For example, the portion of the surface may be at least 20%, at least 30%, at least 40%, at least 50%, at least 60%, at least 70%, at least 80%, or at least 90% of the continuous surface segment surface area. For example, the second zero-thickness surface may have at least one kᵢ of −20 mm⁻¹≤kᵢ<−0.002 mm⁻¹, −10 mm⁻¹≤kᵢ<−0.002 mm⁻¹, −5 mm⁻¹≤kᵢ<−0.002 mm⁻¹, −2 mm⁻¹≤kᵢ<−0.002 mm⁻¹, −1 mm⁻¹≤kᵢ<−0.002 mm⁻¹, −0.5 mm⁻¹≤kᵢ<−0.002 mm⁻¹, −0.2 mm⁻¹≤kᵢ<−0.002 mm⁻¹, −40 mm⁻¹≤kᵢ<−0.01 mm⁻¹, −20 mm⁻¹≤kᵢ<−0.01 mm⁻¹, −10 mm⁻¹≤kᵢ<−0.01 mm⁻¹, −5 mm⁻¹≤kᵢ<−0.01 mm⁻¹, −2 mm⁻¹≤kᵢ<−0.01 mm⁻¹, −1 mm⁻¹≤kᵢ<−0.01 mm⁻¹, −0.5 mm⁻¹≤kᵢ<−0.01 mm⁻¹, −0.2 mm⁻¹≤kᵢ<−0.01 mm⁻¹, −40 mm⁻¹≤kᵢ<−0.02 mm⁻¹, −20 mm⁻¹≤kᵢ<−0.02 mm⁻¹, −10 mm⁻¹≤kᵢ<−0.02 mm⁻¹, −5 mm⁻¹≤kᵢ<−0.02 mm⁻¹, −2 mm⁻¹≤kᵢ<−0.02 mm⁻¹, −1 mm⁻¹≤kᵢ<−0.02 mm⁻¹, −0.5 mm⁻¹≤kᵢ<−0.02 mm⁻¹, −0.2 mm⁻¹≤kᵢ<−0.02 mm⁻¹, −40 mm⁻¹≤kᵢ<−0.1 mm⁻¹, −20 mm⁻¹≤kᵢ<−0.1 mm⁻¹, −10 mm⁻¹≤kᵢ<−0.1 mm⁻¹, −5 mm⁻¹≤kᵢ<−0.1 mm⁻¹, −2 mm⁻¹≤kᵢ<−0.1 mm⁻¹, −1 mm⁻¹≤kᵢ<−0.1 mm⁻¹, −0.5 mm⁻¹≤kᵢ<−0.1 mm⁻¹, −0.2 mm⁻¹≤kᵢ<−0.1 mm⁻¹, −40 mm⁻¹≤kᵢ<−0.2 mm⁻¹, −20 mm⁻¹≤kᵢ<−0.2 mm⁻¹, −10 mm⁻¹≤kᵢ<−0.2 mm⁻¹, −5 mm⁻¹<k; <−0.2 mm⁻¹, −2 mm 1≤kᵢ<−0.2 mm⁻¹, −1 mm⁻¹≤kᵢ<−0.2 mm⁻¹, −0.5 mm⁻¹≤kᵢ<−0.2 mm⁻¹, −40 mm⁻¹≤kᵢ<−0.5 mm⁻¹, −20 mm⁻¹≤kᵢ<−0.5 mm⁻¹, −10 mm⁻¹≤kᵢ<−0.5 mm⁻¹, −5 mm⁻¹≤kᵢ<−0.5 mm⁻¹, −2 mm⁻¹≤kᵢ<−0.5 mm⁻¹, −1 mm⁻¹≤kᵢ<−0.5 mm⁻¹, −40 mm⁻¹≤kᵢ<−1 mm⁻¹, −20 mm⁻¹≤kᵢ<−1 mm⁻¹, −10 mm⁻¹≤kᵢ<−1 mm⁻¹, −5 mm⁻¹≤kᵢ<−1 mm⁻¹, or −2 mm⁻¹≤kᵢ<−1 mm⁻¹.

The first continuous surface segment may have a portion of its surface area follow both a first zero-thickness surface having a G_{c} of −400 mm⁻²≤G_{c}<−0.0001 mm⁻² and a second zero-thickness surface having at least one kᵢ of −40 mm⁻¹≤kᵢ<−0.002. For example, the portion of the surface may be at least 20%, at least 30%, at least 40%, at least 50%, at least 60%, at least 70%, at least 80%, or at least 90% of the continuous surface segment surface area. For example, the first zero-thickness surface may have a G_{c} of −400 mm⁻²≤G_{c}<−0.0001 mm⁻², −200 mm⁻²≤G_{c}<−0.0001 mm⁻², −100 mm⁻²≤G_{c}<−0.0001 mm⁻², −50 mm⁻²≤G_{c}<−0.0001 mm⁻², −25 mm⁻²≤G_{c}<−0.0001 mm⁻², −10 mm⁻²≤G_{c}<−0.0001 mm⁻², −4 mm⁻²≤G_{c}<−0.0001 mm⁻², −1 mm⁻²≤G_{c}<−0.0001 mm⁻², −0.25 mm⁻²≤G_{c}<−0.0001 mm⁻², −0.04 mm⁻²≤G_{c}<−0.0001 mm⁻², −0.01 mm⁻²≤G_{c}<−0.0001 mm⁻², −400 mm⁻²≤G_{c}<−0.004 mm⁻², −200 mm⁻²≤G_{c}<−0.004 mm⁻², −100 mm⁻²≤G_{c}<−0.004 mm⁻², −50 mm⁻²≤G_{c}<−0.004 mm⁻², −25 mm⁻²≤G_{c}<−0.004 mm⁻², −10 mm⁻²≤G_{c}<−0.004 mm⁻², −4 mm⁻²≤G_{c}<−0.004 mm⁻², −1 mm⁻²≤G_{c}<−0.004 mm⁻², −0.25 mm⁻²≤G_{c}<−0.004 mm⁻², −0.04 mm⁻²≤G_{c}<−0.004 mm⁻², −0.01 mm⁻²≤G_{c}<−0.004 mm⁻², −400 mm⁻²≤G_{c}<−0.01 mm⁻², −200 mm⁻²≤G_{c}<−0.01 mm⁻², −50 mm⁻²≤G_{c}<−0.01 mm⁻², −25 mm⁻²≤G_{c}<−0.01 mm⁻², −10 mm⁻²≤G_{c}<−0.01 mm⁻², −4 mm⁻²≤G_{c}<−0.01 mm⁻², −1 mm⁻²≤G_{c}<−0.01 mm⁻², −0.25 mm⁻²≤G_{c}<−0.01 mm⁻², −0.04 mm⁻²≤G_{c}<−0.01 mm⁻², −400 mm⁻²≤G_{c}<−0.04 mm⁻², −200 mm⁻²≤G_{c}<−0.04 mm⁻², −50 mm⁻²≤G_{c}<−0.04 mm⁻², −25 mm⁻²≤G_{c}<−0.04 mm⁻², −10 mm⁻²≤G_{c}<−0.04 mm⁻², −4 mm⁻²≤G_{c}<−0.04 mm⁻², −1 mm⁻²≤G_{c}<−0.04 mm⁻², −0.25 mm⁻²≤G_{c}<−0.04 mm⁻², −400 mm⁻²≤G_{c}<−0.25 mm⁻², −200 mm⁻²≤ G_{c}<−0.25 mm⁻², −50 mm⁻²≤G_{c}<−0.25 mm⁻², −25 mm⁻²≤G_{c}<−0.25 mm⁻², −10 mm⁻²≤G_{c}<−0.25 mm⁻², −4 mm⁻²≤G_{c}<−0.25 mm⁻², −1 mm⁻²≤G_{c}<−0.25 mm⁻², −400 mm⁻²≤G_{c}<−1 mm⁻², −200 mm⁻²≤G_{c}<−1 mm⁻², −50 mm⁻²≤G_{c}<−1 mm⁻², −25 m⁻²≤G_{c}<−1 mm⁻², −10 mm⁻²≤G_{c}<−1 mm⁻², or −4 mm⁻²≤G_{c}<−1 mm⁻². For example, the second zero-thickness surface may have at least one kᵢ of −20 mm⁻¹≤kᵢ<−0.002 mm⁻¹, −10 mm⁻¹≤kᵢ<−0.002 mm⁻¹, −5 mm⁻¹≤kᵢ<−0.002 mm⁻¹, −2 mm⁻¹≤kᵢ<−0.002 mm⁻¹, −1 mm⁻¹≤kᵢ<−0.002 mm⁻¹, −0.5 mm⁻¹≤kᵢ<−0.002 mm⁻¹, −0.2 mm⁻¹≤kᵢ<−0.002 mm⁻¹, −40 mm⁻¹<k; <−0.01 mm⁻¹, −20 mm⁻¹≤kᵢ<−0.01 mm⁻¹, −10 mm⁻¹≤kᵢ<−0.01 mm⁻¹, −5 mm⁻¹≤kᵢ<−0.01 mm⁻¹, −2 mm⁻¹≤kᵢ<−0.01 mm⁻¹, −1 mm⁻¹≤kᵢ<−0.01 mm⁻¹, −0.5 mm⁻¹≤kᵢ<−0.01 mm⁻¹, −0.2 mm⁻¹≤kᵢ<−0.01 mm⁻¹, −40 mm⁻¹≤kᵢ<−0.02 mm⁻¹, −20 mm⁻¹≤kᵢ<−0.02 mm⁻¹, −10 mm⁻¹≤kᵢ<−0.02 mm⁻¹, −5 mm⁻¹≤kᵢ<−0.02 mm⁻¹, −2 mm⁻¹≤kᵢ<−0.02 mm⁻¹, −1 mm⁻¹≤kᵢ<−0.02 mm⁻¹, −0.5 mm⁻¹≤kᵢ<−0.02 mm⁻¹, −0.2 mm⁻¹≤kᵢ<−0.02 mm⁻¹, −40 mm⁻¹≤kᵢ<−0.1 mm⁻¹, −20 mm⁻¹≤kᵢ<−0.1 mm⁻¹, −10 mm⁻¹≤kᵢ<−0.1 mm⁻¹, −5 mm⁻¹≤kᵢ<−0.1 mm⁻¹, −2 mm⁻¹≤kᵢ<−0.1 mm⁻¹, −1 mm⁻¹≤kᵢ<−0.1 mm⁻¹, −0.5 mm⁻¹≤kᵢ<−0.1 mm⁻¹, −0.2 mm⁻¹≤kᵢ<−0.1 mm⁻¹, −40 mm⁻¹≤kᵢ<−0.2 mm⁻¹, −20 mm⁻¹≤kᵢ<−0.2 mm⁻¹, −10 mm⁻¹≤kᵢ<−0.2 mm⁻¹, −5 mm⁻¹≤kᵢ<−0.2 mm⁻¹, −2 mm⁻¹≤kᵢ<−0.2 mm⁻¹, −1 mm⁻¹≤kᵢ<−0.2 mm⁻¹, −0.5 mm⁻¹≤kᵢ<−0.2 mm⁻¹, −40 mm⁻¹≤kᵢ<−0.5 mm⁻¹, −20 mm⁻¹≤kᵢ<−0.5 mm⁻¹, −10 mm⁻¹≤kᵢ<−0.5 mm⁻¹, −5 mm⁻¹≤kᵢ<−0.5 mm⁻¹, −2 mm⁻¹≤kᵢ<−0.5 mm⁻¹, −1 mm⁻¹≤kᵢ<−0.5 mm⁻¹, −40 mm⁻¹≤kᵢ<−1 mm⁻¹, −20 mm⁻¹≤kᵢ<−1 mm⁻¹, −10 mm⁻¹≤kᵢ<−1 mm⁻¹, −5 mm⁻¹≤kᵢ<−1 mm⁻¹, or −2 mm⁻¹≤kᵢ<−1 mm⁻¹.

Continuous surface segments of the contactor media may have a geometry. The geometry may follow the contour of a geometric curve. The geometric curve may be a theoretical two-dimensional mathematical surface. The two-dimensional mathematical surface may be a minimal surface. Nonlimiting examples of the minimal surface include catenoids, helicoid-catenoids, Scherk surfaces, Henneberg surfaces, Catalan surfaces, Enneper surfaces, Riemann's surfaces, double Enneper surfaces, wavy Enneper surfaces, planar surfaces, catenoid-Enneper surfaces, symmetric 4-noid surfaces, skew 4-noid surfaces, saddle towers, twisted Scherk surfaces, Lopez-Ros No-Go theorem surfaces, catenoid chain surfaces, inverted boy surfaces, Kusner surfaces, Chen Gackstatter surfaces, Costa surfaces, catenoid fence surfaces, Shoen No-Go theorem surfaces, catenoid field surfaces, Karcher JE saddle tower surfaces, Karcher JD saddle tower surfaces, Scherk with handle surfaces, Costa-Hoffman-Meeks surfaces, and triply periodic minimal surfaces. Nonlimiting examples of triply periodic minimal surfaces include Schwarz H family surfaces, lidinoid surfaces, Schwarz PD family surfaces, gyroid surfaces, neovirus surfaces, Schoen HT hexagonal family surfaces, Schoen TW family surfaces, and Fujimori Weber surfaces.

The contactor media may include continuous surface segments with different geometries. For example, a first continuous surface segment may have a first geometry and a second continuous surface segment may have a second geometry. For example, a first continuous surface segment may have a first geometry, a second continuous surface segment may have a second geometry, and a third continuous surface segment may have a third geometry. For example, a first continuous surface segment may have multiple geometries within the same surface segment. The different geometries may be any of those described herein.

The contactor media may include continuous surface segments with a thickness. The first continuous surface segment may have a thickness of about 1 μm to about 100 mm (e.g., about 10 μm to about 10 mm, about 50 μm to about 1 mm, about 100 μm to about 750 μm, about 200 μm to about 500 μm, about 250 μm to about 350 μm, or about 300 μm). A second continuous surface segment may have a thickness of about 1 μm to about 100 mm (e.g., about 10 μm to about 10 mm, about 50 μm to about 1 mm, about 100 μm to about 750 μm, about 200 μm to about 500 μm, about 250 μm to about 350 μm, or about 300 μm). A third continuous surface segment may have a thickness of about 1 μm to about 100 mm (e.g., about 10 μm to about 10 mm, about 50 μm to about 1 mm, about 100 μm to about 750 μm, about 200 μm to about 500 μm, about 250 μm to about 350 μm, or about 300 μm). The first continuous surface segment, second continuous surface segment, and third continuous surface segment may be the same thickness or a different thickness.

The contactor media may have a total liquid hold-up through surface wetting of about 1 kg/m³ to about 800 kg/m³ (e.g., 10 kg/m³ to 800 kg/m³, 100 kg/m³ to 800 kg/m³, 200 kg/m³ to 800 kg/m³, 300 kg/m³ to 800 kg/m³, 400 kg/m³ to 800 kg/m³, 500 kg/m³ to 800 kg/m³, 600 kg/m³ to 800 kg/m³, or 700 kg/m³ to 800 kg/m³) at a predetermined temperature and predetermined relative humidity. The total liquid hold-up may be dependent on factors including but not limited to contactor media materials, liquid viscosity, the surface tension of adhesion (which is dependent on the material chosen for the contactor media and the gas flowing through the contactor media) the geometry of the contactor media, the fluid flow and material being pushed into the system, and the gas flow and material being pushed into the system.

Static liquid hold-up through surface wetting can occur at a range of about 0.1 kg/m³ to about 700 kg/m³ (e.g., 1 kg/m³ to 700 kg/m³, 10 kg/m³ to 600 kg/m³, 20 kg/m³ to 500 kg/m³, 30 kg/m³ to 400 kg/m³, 40 kg/m³ to 300 kg/m³, 50 kg/m³ to 200 kg/m³, 50 kg/m³ to 100 kg/m³, 50 kg/m³ to 70 kg/m³, 10 kg/m³ to 700 kg/m³, 20 kg/m³ to 700 kg/m³, 30 kg/m³ to 700 kg/m³, 40 kg/m³ to 700 kg/m³, 50 kg/m³ to 700 kg/m³, 60 kg/m³ to 700 kg/m³, 70 kg/m³ to 700 kg/m³, 80 kg/m³ to 700 kg/m³, 90 kg/m³ to 700 kg/m³, 100 kg/m³ to 700 kg/m³, 200 kg/m³ to 700 kg/m³, 300 kg/m³ to 700 kg/m³, 400 kg/m³ to 700 kg/m³, 500 kg/m³ to 700 kg/m³, or 600 kg/m³ to 700 kg/m³) at a predetermined time, predetermined temperature, and predetermined relative humidity. This range will change depending on factors including but not limited to the liquid viscosity, the surface tension of adhesion (which is dependent on the material chosen for the contactor media and the gas flowing through the contactor media) and the geometry of the contactor media. The predetermined time may be, for example, about 45 minutes, about 60 minutes, about 90 minutes, about 120 minutes, about 140 minutes, or about 200 minutes. The temperature may be, for example, about 18° C. to about 30° C., about 20° C. to about 25° C., or about 20° C. The relative humidity may be about 80% to about 100%, about 90% to about 100%, or about 100%.

For example, in a gas-liquid contactor media for carbon dioxide capture made of an acrylate/methacrylate based photopolymer and having a gyroid geometry with an air flow frontal velocity of 1.5 m/s through the contactor media, and a 1 M KOH liquid flow of 0.5 L·s⁻¹·m⁻², the observed total liquid hold-up is in the range of 30 kg/m³ to 120 kg/m³ and the static liquid hold-up at a time of 1 hour ranges from 10 kg/m³ to 120 kg/m³. In any embodiment, lower liquid hold-up values may primarily result from evaporation rather than flow of the liquid out of the contactor media. The static liquid hold-up of the contactor media may be about 0.1% to about 99.9% of the total liquid hold-up (e.g., 0.1% to 20%, 10% to 40%, 30% to 60%, 50% to 80%, 70% to 90%, 85% to 95%, 90% to 99%, or 95% to 99.9%).

The liquid, for which total liquid hold-up and static liquid hold-up values are provided herein, may have a fluid viscosity of about 1 cPs to about 10,000 cPs (e.g., 1 cPs to 10 cPs, 10 cPs to 100 cPs, 100 cPs and 1,000 cPs, 1,000 cPs to 5,000 cPs, or 5,000 cPs to 10,000 cPs). The liquid may have a surface tension of about 10 mN/M² to about 5000 mN/m² (e.g., 10 mN/m² to 50 mN/m², 50 mN/m² to 200 mN/m², 200 mN/m² to 1000 mN/m², 1000 mN/m² to 3000 mN/m², or 3000 mN/m² to 5000 mN/m²). The liquid may have a density of about 0.5 g/mL to about 20 g/mL (e.g., 0.5 g/mL to 2 g/mL, 2 g/mL to 5 g/mL, 5 g/mL to 10 g/mL, 10 g/mL to 15 g/mL, or 15 g/mL to 20 g/mL). The liquid may have a three-phase contact angle on the contactor media of less than 100° (e.g., 0 to 100° C., 0° C. to 30° C., 30° C. to 60° C., or 60° C. to 100° C.).

The contactor media may be formed of a polymer, metal, ceramic, or a combination of any two or more thereof. Nonlimiting examples of polymer may include epoxide polymers, acrylic polymers, polyethylene, polypropylene, polyvinyl chloride, polystyrene, polylactic acid, acrylonitrile butadiene styrene, polyethylene terephthalate, polyurethane, polyamide, acrylonitrile styrene acrylate, polycarbonate, polyvinyl alcohol, polyether ether ketone, or a combination of any two or more thereof. Nonlimiting examples of metals may include stainless steel, titanium, aluminum, Inconel, copper, cobalt chrome, bronze, nickel alloys, steel, gold, titanium alloys, and combinations of any two or more thereof. Nonlimiting examples of ceramics may include aluminum oxide, zirconium dioxide, silicon dioxide, titanium dioxide, calcium phosphate, barium titanate, magnesium oxide, silicon nitride, carbon composites, and combinations of any two or more thereof. In some cases, the contactor may be formed from a substrate material (e.g., printed or otherwise formed polymer), with a metal coating to improve chemical resistance and/or wettability. The contactor media may be formed of a hydrophilic material. The hydrophilic material may include a polymer. In some embodiments, the polymer includes polyethylene, polypropylene, polyvinyl chloride, polystyrene, para-aramid polymers, or other polymers. The hydrophilicity of the contactor media material and surface area of the contactor media may provide a Gibbs free energy of adhesion of the liquid to the contact medium.

The contactor media may be manufactured using 3D printing, thermoforming, molding, knitting of fibers, or by subtractive milling/ablating processes. The contactor media may be printed using stereolithography 3D printing, where light is used to cure liquid resin in a layer-by-layer fashion. The contactor media may be manufactured using a serial process wherein 2D coatings are printed or formulated on a layer-by-layer basis utilizing any suitable 3D printing or manufacturing technologies. The contactor media may be made using other manufacturing techniques, including thermoforming thermoplastic sheets, and molding thermoset polymers.

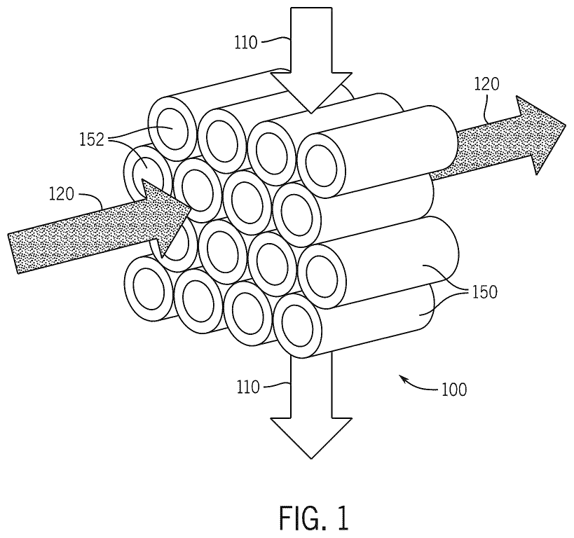

The contactor media may include one or multiple continuous surface segments in the form of a shape. The size and shape of the continuous surface segments and spacing between continuous surface segments may provide reduced pressure drop, improved turbulence and mixing, increased wetting, and other advantages. Nonlimiting examples of shapes of the continuous surface segments include tubes, sheets (also referred to herein as rectangular prisms), chevron-shaped, lamellar structures, corrugated layers, fins, egg crate, jagged wedge, pyramid, ovoid, hemi-ovoid, and other shapes. Continuous surface segments may be oriented relative to other continuous surface segments to have regular spacing between segments. Regular spacing between segments may provide gas flow between segments. FIGS. 1-5 illustrate different example shapes of the contactor media.

Generally, the contactor media disclosed herein have continuous surface segments, forming a contactor body, as described above and below. A first continuous surface segment can have a portion (e.g., at least 50%) of its surface area follow at least one contour selected from the group consisting of (a) a first contour of a first zero-thickness surface having a Gaussian curvature (“G_{c}”) of −400 mm⁻²≤G_{c}<−0.01 mm⁻²; (b) a second contour of a second zero-thickness surface having at least one principal curvature (kᵢ) of −20 mm⁻¹≤kᵢ<−0.1 mm⁻¹, or any combinations thereof. In some embodiments, the contour defines a first continuous capillary flow path extending in a first (bulk flow) direction across the contactor body. In some cases, a second continuous capillary flow path can extend in a second (bulk flow) direction across the contractor body (e.g., substantially parallel with the first direction). In some cases, the second continuous capillary flow path can be disposed below the first continuous capillary flow path. Adjacent continuous capillary flow paths (e.g., first and second substantially parallel capillary continuous flow paths) can be separated by inactive surfaces such that flow between the flow paths crosses the inactive surfaces.

The contactor media may have additional surface treatments to increase the wettability by the liquid. This surface treatment may occur in some embodiments to be applied through the creation of pixels from the 3D printing process (e.g., increased micro-scale (e.g., 1 μm to 10 μm or 1 μm to 250 μm scale) surface roughness). This texture could also be applied through mechanical media blasting (e.g. sand blasting with a course media such as sand, glass, polymer, or a combination of any two or more thereof), polymer or other (e.g., metal) coatings which favor wetting by the liquid, by treatment with plasma or corona discharge to change the surface chemistry of a material, or by etching procedures (e.g., Piranha etching solutions, Aqua Regia, metal or ceramic etchants, etc.).

Referring to FIG. 1, a gas-liquid contactor media 100 is illustrated, in which a liquid 110 may flow crosswise (also referred to herein as radially) to the flow of a gas 120. The gas-liquid contactor media 100 may have continuous surface segments 150 to provide liquid hold-up of the liquid 110. The continuous surface segment 150 is an example of a contactor body as disclosed herein.

In FIG. 1, the gas-liquid contactor media 100 includes continuous surface segments 150. The plurality of continuous surface segments 150 are formed into cylindrical tube shapes. As illustrated, the gas 120 flows through a plurality of openings 152 (e.g., cavities, pores, voids, or negative curvature) in the continuous surface segments 150. Negative curvature may include negative Gaussian curvature, negative mean curvature, or negative principal curvature. The liquid 110 may flow through the continuous surface segments 150 radially to a flow direction of the gas 120. The gas 120 may flow radially to the plurality of openings 152 (i.e., to a plane defined by the openings 152). Aqueous ions in the liquid 110 may react with the gas 120 in a mass transfer reaction (e.g., to sequester CO₂ from the gas). In some embodiments, the segments are of a size such that liquids are retained within the contact media through capillary action, or in other words while there is a not physical impediment to the liquid draining from the top of a contactor media through the bottom (i.e. no pools, cups, or other similar structures) the size and shape of the segments acts to retain liquid within the structure through capillary action and surface adhesion between the liquid and solid media support.

As illustrated, the plurality of continuous surface segments 150 include openings 152. The openings 152 may have a diameter of about 1 mm to about 100 mm (e.g., about 1 mm to about 90 mm, about 1 mm to about 80 mm, about 1 mm to about 70 mm, about 1 mm to about 60 mm, about 1 mm to about 50 mm, about 1 mm to about 40 mm, about 1 mm to about 30 mm, about 1 mm to about 20 mm, or about 1 mm to about 10 mm).

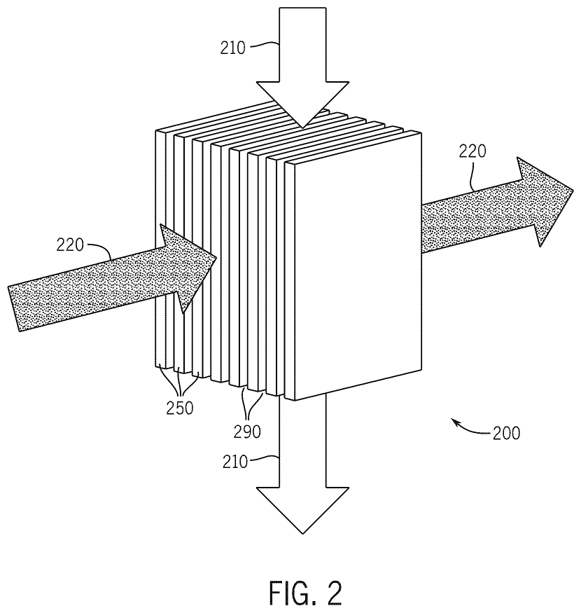

Referring to FIG. 2, a gas-liquid contactor media 200 is illustrated, where the contactor media 200 includes an array of continuous surface segments 250 formed in the shape of sheets. The continuous surface segments 250 formed into a sheet is an example of a contactor body as disclosed herein. A liquid 210 may flow radially to a gas 220 through the contactor media 200 as described with respect to FIG. 1. The gas 220 and the liquid 210 may flow in other configurations and directions in relation to each other, as described with respect to FIG. 1. The gas 220 and the liquid 210 may flow axially the continuous surface segments 250. The plurality of continuous surface segments 250 may have a rectangular profile shape. The plurality of continuous surface segments 250 may have a curved profile shape. The plurality of sheet contactor media 250 may include other geometries. The gas-liquid contactor media 200 may include spacing 290 between the continuous surface segments 250. The gas 220 may flow through the spacing 290 between the plurality of continuous surface segments 250. The spacing 290 may have a width of about 1 mm to about 100 mm (e.g., about 1 mm to about 90 mm, about 1 mm to about 80 mm, about 1 mm to about 70 mm, about 1 mm to about 60 mm, about 1 mm to about 50 mm, about 1 mm to about 40 mm, about 1 mm to about 30 mm, about 1 mm to about 20 mm, or about 1 mm to about 10 mm).

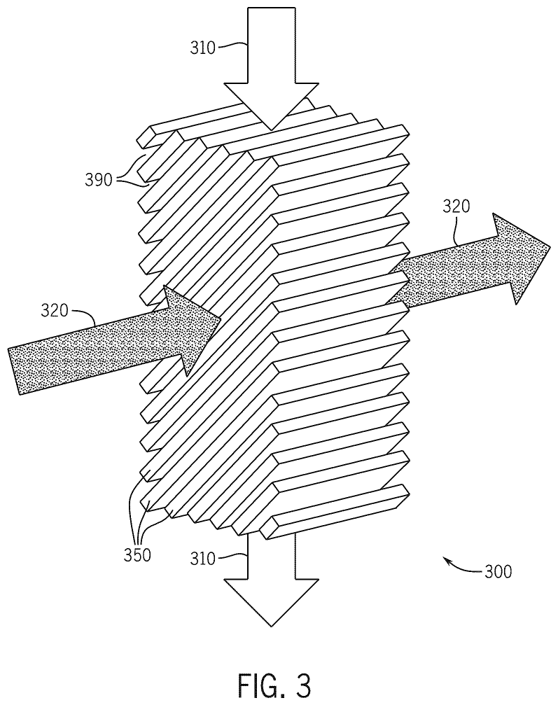

Referring to FIG. 3, a gas-liquid contactor media 300 is illustrated, where the contactor media 300 includes an array of continuous surface segments 350 formed in the shape of sheets. The continuous surface segments 350 formed in the shape of a sheet is an example of a contactor body as disclosed herein. A liquid 310 may flow radially to a gas 320 in the contactor media 300 as described with respect to FIG. 1. The gas 320 and the liquid 310 may flow in other configurations and directions in relation to each other as described with respect to FIG. 1. The gas 320 may flow axially to a plurality of continuous surface segments 350 and the liquid 310 may flow diagonally to the plurality of continuous surface segments 350. The gas 320 may flow axially to a plurality of continuous surface segments 350 and the liquid 310 may flow diagonally to the plurality of continuous surface segments 350. The gas 320 and the liquid 310 may flow diagonally to the plurality of continuous surface segments 350. The plurality of continuous surface segments 350 may have a rectangular profile shape. The plurality of continuous surface segments 350 may have a curved profile shape. The plurality of continuous surface segments 350 may include other geometries. The gas-liquid contactor 300 may include spacing 390 between the continuous surface segments 350. The gas 320 may flow through the spacing 390. The spacing 390 may have a width of about 1 mm to about 100 mm (e.g., about 1 mm to about 90 mm, about 1 mm to about 80 mm, about 1 mm to about 70 mm, about 1 mm to about 60 mm, about 1 mm to about 50 mm, about 1 mm to about 40 mm, about 1 mm to about 30 mm, about 1 mm to about 20 mm, or about 1 mm to about 10 mm).

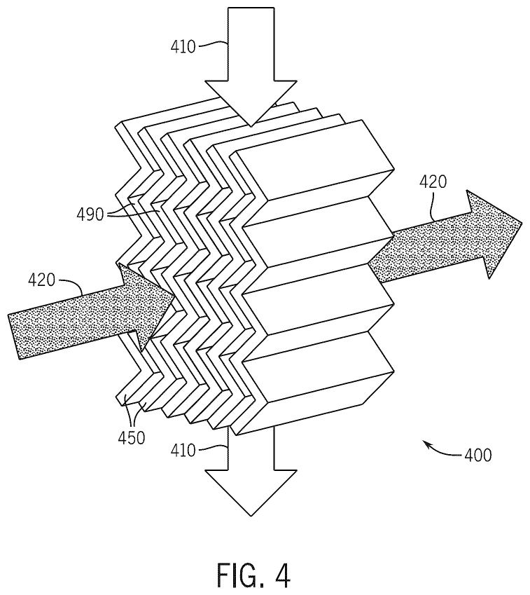

Referring to FIG. 4, a gas-liquid contactor media 400 is illustrated, where the contactor media 400 includes an array of continuous surface segments 450 formed in the shape of chevron shapes. The continuous surface segments 450 formed in the shape of a chevron is an example of a contactor body as disclosed herein. A liquid 410 may flow radially to a gas 420 in the contactor media 400. The gas 420 and the liquid 410 may flow in other configurations and directions in relation to each other as described with respect to FIG. 1. The gas 420 and the liquid 410 may flow axially to the chevron-shaped continuous surface segments 450. For example, at least one of the gas 420 and the liquid 410 may flow radially to the plurality of chevron-shaped continuous surface segments 450. At least one of the gas 420 and the liquid 410 may flow diagonally to the plurality of chevron-shaped continuous surface segments 450. The gas-liquid contactor media 400 may include spacing 490 between the plurality of continuous surface segments 450. The gas 420 and the liquid 410 may flow through the spacing 490. The spacing 490 may have a width of about 1 mm to about 100 mm (e.g., about 1 mm to about 90 mm, about 1 mm to about 80 mm, about 1 mm to about 70 mm, about 1 mm to about 60 mm, about 1 mm to about 50 mm, about 1 mm to about 40 mm, about 1 mm to about 30 mm, about 1 mm to about 20 mm, or about 1 mm to about 10 mm).

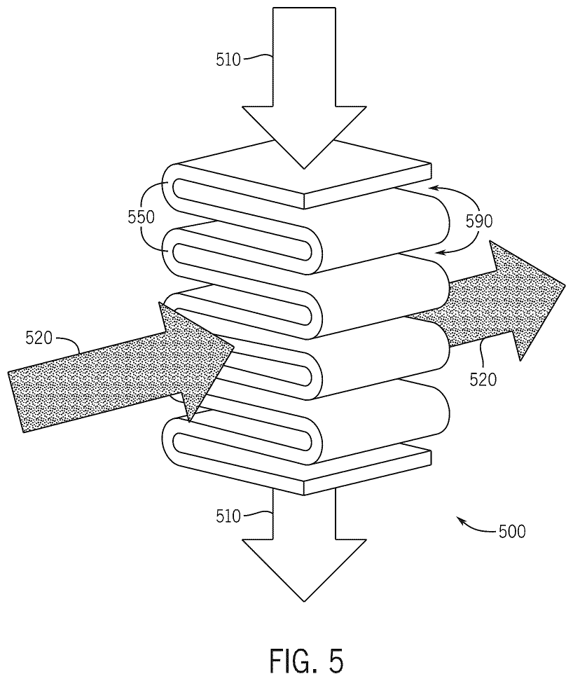

Referring to FIG. 5, a gas-liquid contactor media 500 is illustrated, where the contactor media 500 includes an array of continuous surface segments 550 formed in the shape of lamellar layers. The continuous surface segment 550 is an example of a contactor body as disclosed herein. A liquid 510 may flow radially to a gas 520 in the contactor media 500. The gas 520 and the liquid 510 may flow in other configurations and directions as described herein. In some embodiments, the gas 520 may flow axially to a plurality of the lamellar continuous surface segments 550 and the liquid 510 may flow radially to the plurality of lamellar continuous surface segments 550. The gas 520 may flow radially to the plurality of lamellar continuous surface segments 550 and the liquid 510 may flow axially to the plurality of lamellar layers of continuous surface segments 550. The gas 520 and the liquid 510 may flow radially to the plurality of continuous surface segments 550. The gas 520 and the liquid 510 may flow axially to the plurality of layers of lamellar continuous surface segments 550. The gas-liquid contactor media 500 may include spacing 590 between the continuous surface segments 550 as described herein. The gas 520 and the liquid 510 may flow through the spacing 590 as described herein. The spacing 590 may have a width of about 1 mm to about 100 mm (e.g., about 1 mm to about 90 mm, about 1 mm to about 80 mm, about 1 mm to about 70 mm, about 1 mm to about 60 mm, about 1 mm to about 50 mm, about 1 mm to about 40 mm, about 1 mm to about 30 mm, about 1 mm to about 20 mm, or about 1 mm to about 10 mm).

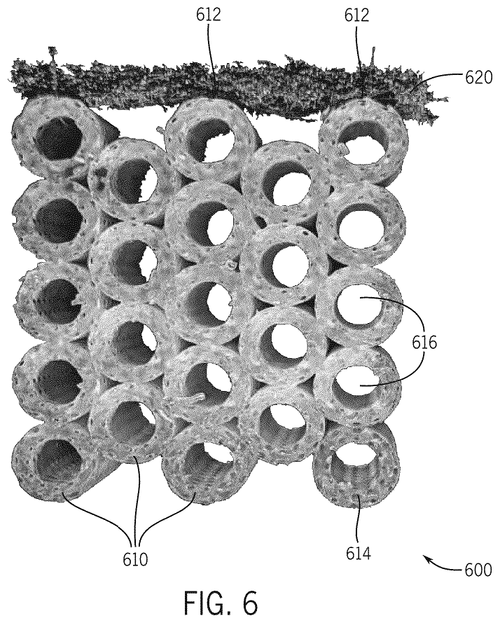

Referring to FIG. 6, a photograph of a gas-liquid contactor media 600 is shown. The gas-liquid contactor media 600 may include a plurality of continuous surface segments 610. The continuous surface segment 610 is an example of a contactor body as disclosed herein. The gas-liquid contactor media 600 may include a liquid distributor 620. In some embodiments, the liquid distributor 620 is configured to disperse liquid flow evenly across the plurality of continuous surface segments 610. The source of the liquid may include a single inlet pipe. The source of the liquid may include multiple inlet pipes or other liquid sources. In some embodiments, the liquid distributor 620 is located on an outside surface 612 of the plurality of continuous surface segments 610. The liquid distributor 620 may be located on a top surface of the plurality of contactor media 610. The gas-liquid contactor media 600 appears blue (alternatively identified by darker grey shading) because of static liquid hold-up of a liquid including blue dye for visualization.

In any embodiment, the plurality of continuous surface segments 610 include at least one continuous surface segment formed into a tube 614. For example, the continuous surface segment may have a gyroidal geometry. The continuous surface segments 610 may include a plurality of openings 616. The liquid distributor 620 may be disposed radially to the plurality of openings 616. In other embodiments, the liquid distributor 620 may be disposed axially to the plurality of openings 616. The liquid distributor 620 may be disposed along a length of the plurality of continuous surface segments 610.

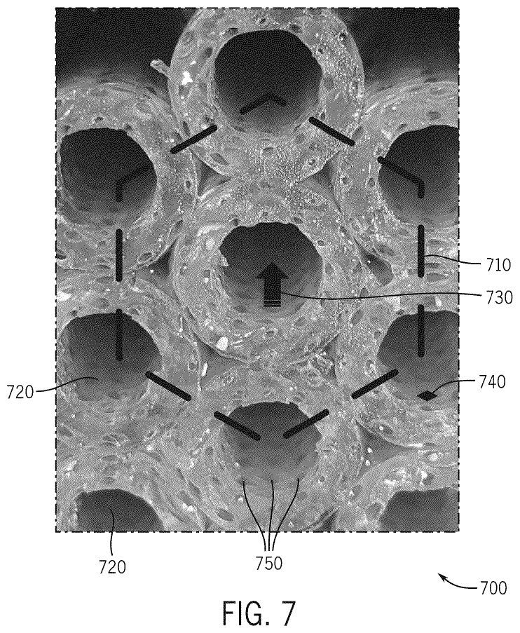

Referring to FIG. 7, a photograph of an array of tube-shaped contactor media 700 is shown. The tube-shaped contactor media 700 includes continuous surface segments arranged in a hexagonal array 710. The contactor media 700 may be configured to receive a liquid. The contactor media 700 may include a plurality of openings 720. The plurality of openings 720 may be configured to provide a gas flow 730. The gas flow 730 is into the plane of the page. The plurality of openings 720 may facilitate gas flow through the contactor media 700. The surface geometry of the continuous surface segments of the contactor media 700 may provide a gas-liquid contact area 740. The geometry of the continuous surface segments may increase the gas-liquid contact area 740. The contactor media 700 may be configured to facilitate liquid flow through the contactor media 700. For example, liquid may trickle through the continuous surface segments, filling surface features 750 disposed within the continuous surface segments. The contactor media 700 appears blue (alternatively identified by darker grey shading) because of static liquid hold-up of a liquid including blue dye for visualization at the gas-liquid contact areas 740.

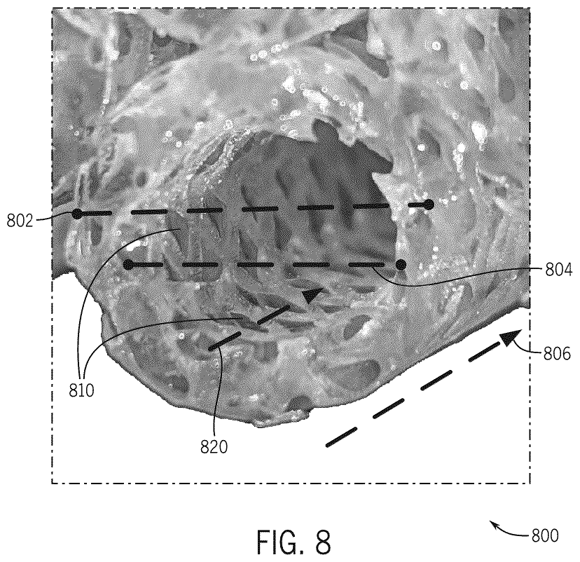

Referring to FIG. 8, a photograph of a tube-shaped contact medium 800 is shown. The plurality of surface features 810 disposed within the contact medium 800 may be configured to fill with a liquid. The contactor medium 800 appears green (alternatively identified by darker grey shading) because of static liquid hold-up of a liquid including green dye for visualization. At least one of the plurality of surface features 810 may be oval-shaped. At least one of the plurality of surface features 810 may be oval-shaped with a constriction, forming a bilobed (‘peanut’) shaped channel. At least one of the plurality of surface features 810 may be spheroid-shaped. The contact medium 800 may include an opening 820 configured to facilitate gas flow. The contact medium 800 may include an outer diameter 802 and an inner diameter 804. The inner diameter 804 may be a diameter of the opening 820. The outer diameter 802 may be a width of the gyroidal tube contact medium 800. In some embodiments, the inner diameter 804 is about 1 mm to about 100 mm (e.g., 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, or 100 mm; 1 mm to 50 mm, 5 mm to 25 mm). For example, the inner diameter 804 may be about 5 mm to about 9 mm or about 6 mm to about 8 mm. The outer diameter 802 may be about 1 mm to about 200 mm (e.g., 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 30 mm, 40 mm, 50 mm, 60 mm, 70 mm, 80 mm, 90 mm, 100 mm, or 200 mm). For example, the outer diameter 802 may be about 8 mm to about 18 mm or about 11 mm to about 15 mm. The contact medium 800 may include a length 806. The length 806 of the contact medium 800 may be about 10 mm to about 10 m (e.g., about 25 mm to about 10 m, about 100 mm to about 10 m, or about 1 m to about 10 m, about 5 m to about 10 m, or about 8 m to about 10 m.).

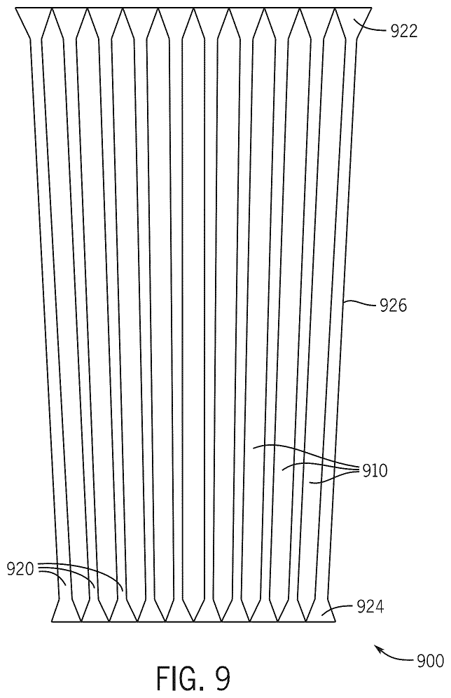

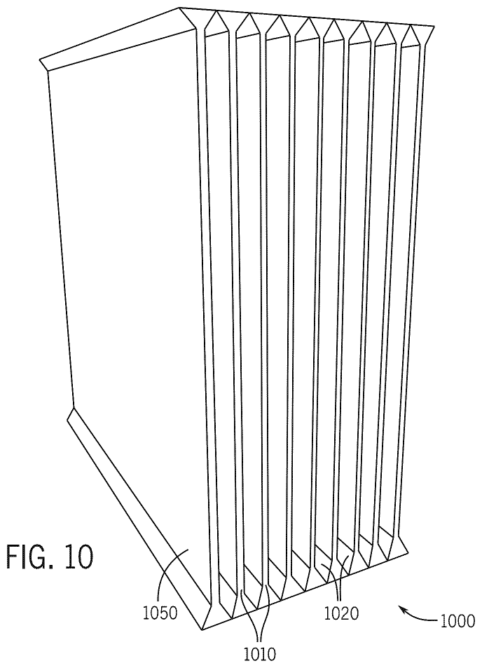

Referring to FIG. 9, a cross-sectional view of a plurality of I-beam sheet contactor media 900 is shown. Generally, the I-beam sheet has a Y-shaped upper portion (e.g., upper terminal end) and a Y-shaped lower portion (e.g., lower terminal end) separated by a sheet (e.g., which may extend between terminal sides that, in turn, extend between the upper and lower terminal ends, as shown in the example of FIG. 10). The Y-shaped upper portion is configured to collect liquid from a distributer and direct (or “funnel”) it into a network of passages in the sheet, while the Y-shaped lower portion is also configured to redistribute the liquid to a liquid collector at the bottom of the sheet. More, specifically, the contactor media 900 may include continuous surface segments as disclosed herein. The plurality of I-beam sheet contactor media 900 may include spaces 910 between the plurality of I-beam sheet contactor media. In some examples, an I-beam shape may exhibit a relatively widened structure at a terminal end that includes geometry other than the illustrated Y-shaped example.

The plurality of I-beam sheet contactor media 900 may be configured to facilitate gas-liquid interaction. The plurality of I-beam sheet contactor media 900 may include at least one I-beam sheet 920. An I-beam sheet 920 is an example of a contactor body as disclosed herein. The I-beam sheet 920 may include two or more unit cells. In some embodiments, a top piece 922 and a bottom piece 924 of the I-beam sheet 920 include a first unit cell. Middle pieces 926 of the I-beam sheet 920 may include a second unit cell as a repeating unit. A dimensional length of the I-beam sheet may be dictated by the number of second unit cells located between the top piece 922 of the I-beam sheet 920 and the bottom piece 924 of the I-beam sheet 920. For example, the unit cells may include gyroidal structures. A method of forming the I-beam sheet 920 may include arraying the first unit cells and second unit cells into a two-dimensional array. The method may include arraying the second unit cells between the first unit cells. In some embodiments, the first unit cells are opposite ends of the I-beam sheet 920.

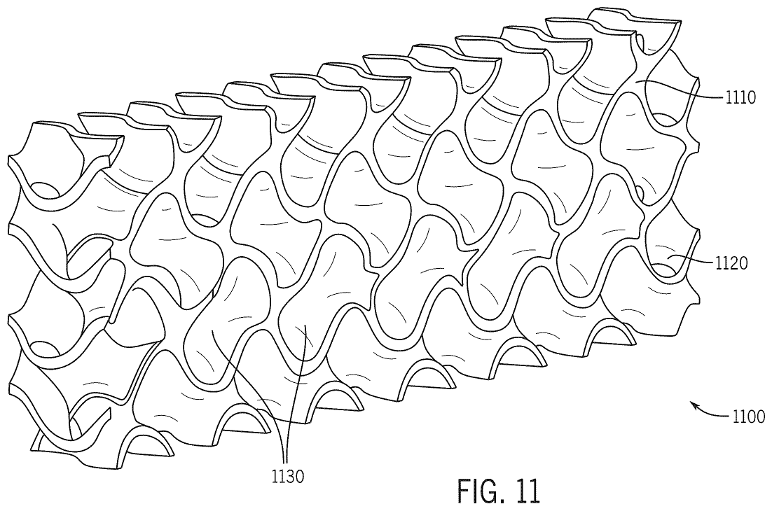

Referring to FIG. 10, a side view of the I-beam sheet contactor media 1000 is shown (e.g., formed from multiple adjacent instances of the I-beam sheet 920 of FIG. 9). The plurality of I-beam sheet contactor media 1000 may include a first unit cell, a second unit cell, spaces between the plurality of I-beam sheet contactor media 1010, and a dimensional length. In some embodiments, the plurality of I-beam sheet contactor media further include a gyroidal structure and/or surface features 1050 (see FIGS. 11, 14A-14B, 18-22, 28A-28C, 29A-C, 42-50 for examples of gyroidal structure and/or surface features). A quantity of second unit cells may determine the dimensional length of the plurality of I-beam sheet contactor media 1000. Spacing 1020 between I-beam sheet contactor media 1010 may be even or uneven, as described herein. For example, I-beam sheet contactor media 1010 may be spaced in a radial arrangement as shown in FIG. 16B.

Referring to FIG. 11, an illustration of a rectangular section of a contact medium 1100 with continuous surface segments 1110 having a gyroidal geometry with a porous surface 1120 is shown. The continuous surface segments may include openings 1130 on each side of the rectangular section that are interconnected. The rectangular section may include repeated unit cells. The rectangular section of a contact medium 1100 may be a contactor body or a subsection of a contactor body.

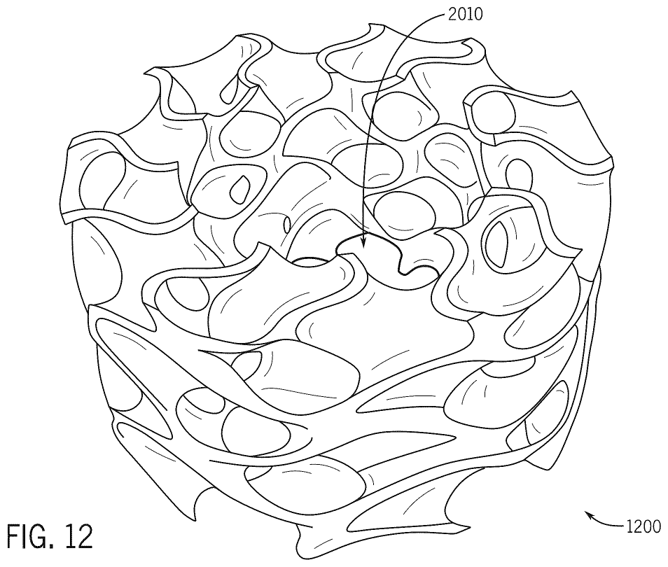

Referring to FIG. 12, an illustration of a tube-shaped section of a contact medium 1200 is shown. The continuous surface segments may have a gyroidal geometry and a tube-shaped profile, with an aperture 1210, may be generated by rotation distortion of the rectangular section of the contact medium shown in FIG. 11. The continuous surface segments may have a gyroidal geometry, and a tube-shaped profile is an example of a contactor body, or a subsection of a contactor body, as disclosed herein. The contact medium 1200 may include repeating unit cells that is similar to the unit cell in FIG. 11 but with rotation distortion.

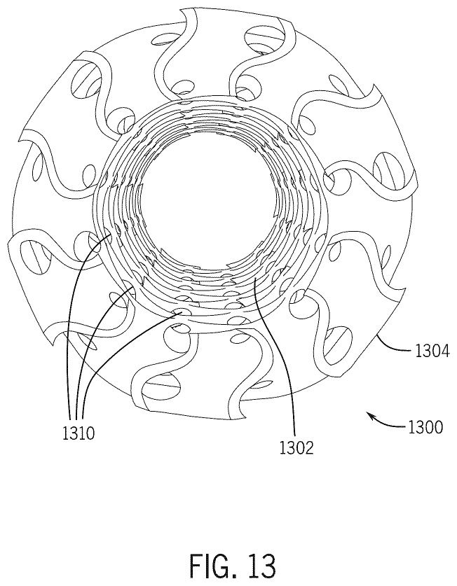

Referring to FIG. 13, an illustration of a contact medium 1300 is shown from an axial direction. The contact medium 1300 may have a gyroidal geometry and a tube-shaped profile. The contact medium 1300 may include surface features 1310 disposed on an inside surface 1302 and on an outside surface 1304 of the contact medium. In some embodiments, the contact medium includes repeating units. In some embodiments, the contact medium includes alternating units. The contact medium 1300 may be assembled by stacking unit cells onto each other or connecting them through other means such as stacking or printing. The surface features 1310 disposed on the inside surface 1302 and the outside surface 1304 may be interconnected. The interconnection of the surface features 1310 disposed on the inside surface 1302 and the surface features disposed on the outside surface 1304 may facilitate liquid flow through the contact medium 1300. The surface features 1310 disposed on the inside surface 1302 and the outside surface 1304 may be configured to retain liquid. In some embodiments, the surface features 1310 may increase adhesive surface energy of the liquid.

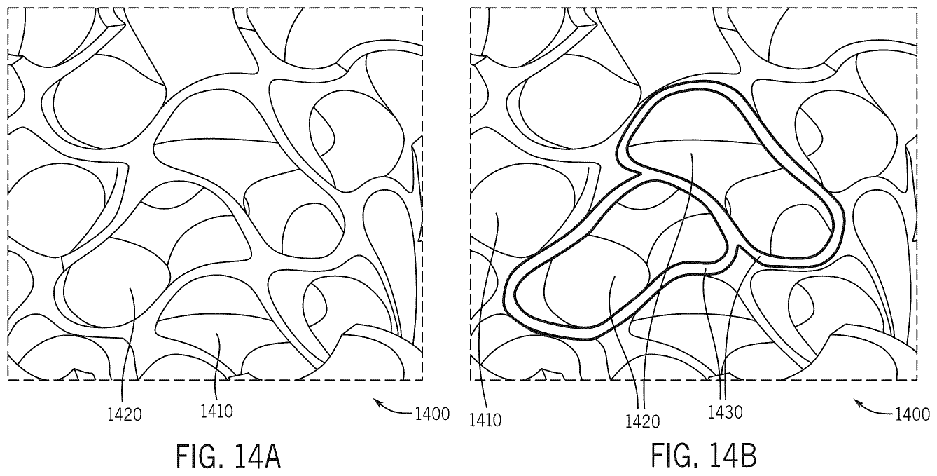

Referring to FIG. 14A, a contact medium 1400 includes regions of continuous surface segments 1410 that may include repeating geometrical voids 1420. The geometrical voids 1420 may include gyroidal geometry. The continuous surface segments 1410 may further include segments with amorphous geometry. Each continuous surface segment 1410 may follow a negative Gaussian curvature and/or negative principal curvature as disclosed herein. The repeating geometrical features 1420 may include channels, surface features, pores, or voids, or a combination of any two or more thereof. For example, the surface features, pores, or voids may be spheroidal. These channels may be interconnected across the entire surface media.

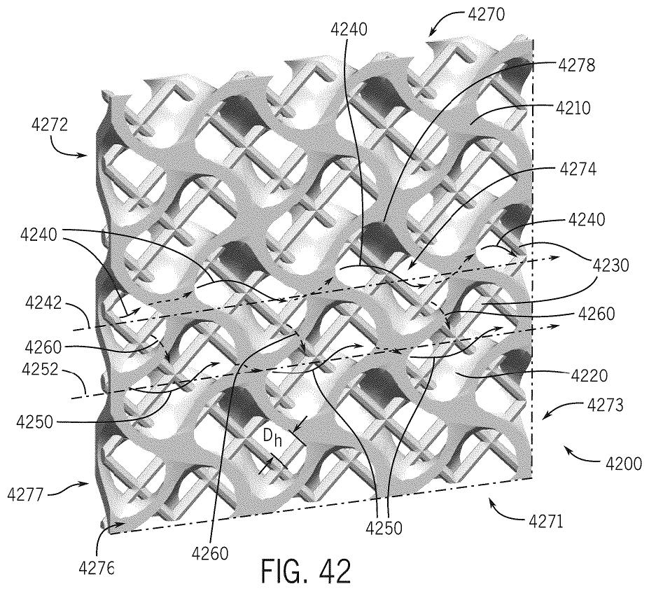

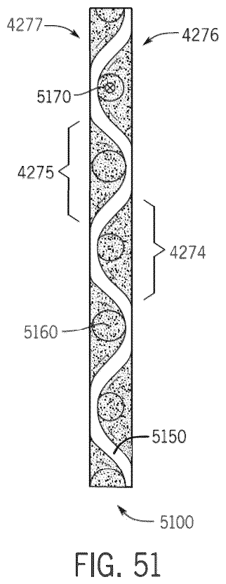

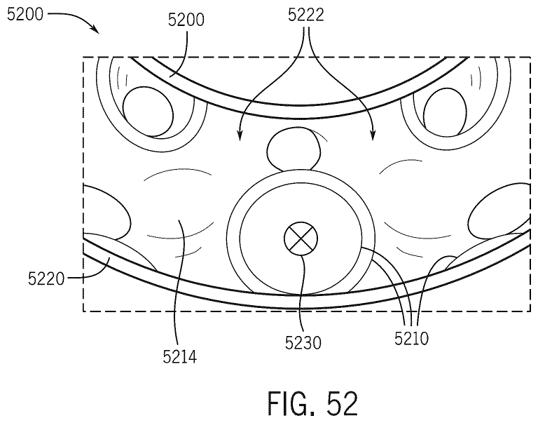

FIG. 14B is the illustration in FIG. 14A with shading indicating surface features 1420 for surface wetting. The sections indicated with bold lines 1430 are inactive surface areas where capillary action and static second phase hold-up are not favored. In contrast, the interior sections 1420 are active surface areas where capillary action and static liquid hold-up are favored. See Examples below for further description of active surface areas for wetting. The active surface area features 1420 may have a bilobed-shaped cross-section (e.g., peanut-shaped). The contact medium 1400 may include an active surface area of surface wetting in the active surface area features 1420. The active surface area may be configured to expose a liquid surface area to gas to facilitate gas-liquid interactions. In some embodiments, the active surface area may be the outward, air interfacing surface area of the liquid retained in the interconnected active surface area features 1420. See also, for example, the first opening 4274 and second opening 4275 of the contactor media shown in FIGS. 42 and 51, described below (or surfaces 5220 of FIG. 52 described below). In some embodiments, active surface area features 1420 may include channels, cavities, pores, voids, or any combination of two or more thereof, which may be interconnected to other active surface area features 1420 including channels, cavities, pores, voids, or any combination of two or more thereof, to create a longer interconnected active surface area which may extend across the width or length of the contactor media.

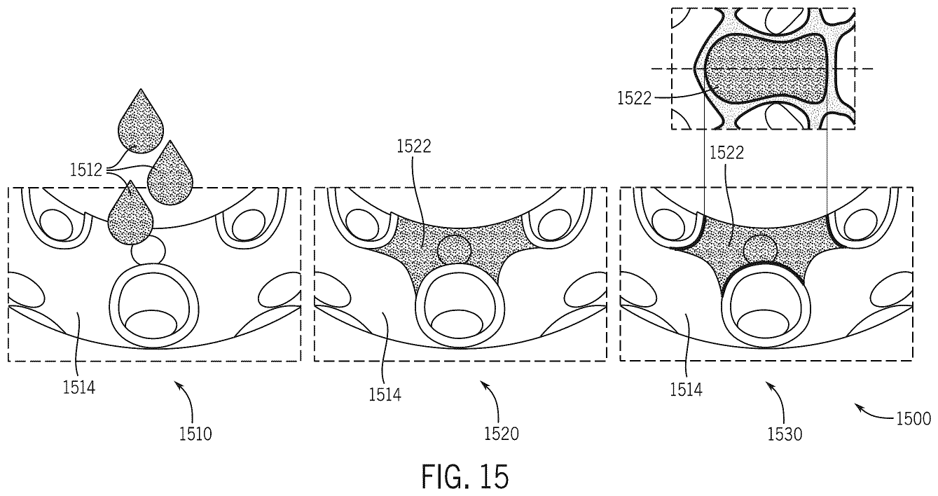

FIG. 15 is a cross-sectional illustration of surface wetting of the gyroidal contactor medium in FIG. 14A. The gyroidal contactor medium has a large active surface area for the second phase to wet, helping to better stabilize the droplet of the second phase. Additionally, because the active surface area has a closed contour (the peanut shape (also referred to herein as a bilobed shape)), the droplet is further stabilized. There are other cross-sections of the gyroidal contactor medium (e.g., sine wave shapes) that do not have a closed contour where the second phase may not stabilize, providing less liquid hold-up. The ‘peanut’ shape of the active surface area in the gyroidal contactor medium provides higher active surface area compared to conventional contactor media having node-strut geometry (e.g., lattice geometry, skeletal gyroid). The node-strut geometry, even though it has a higher active surface area, provides very little active surface area per volume for mass transport. The peanut shape of the active surface area makes better use of the volume of liquid that it holds up by making it more available to the gas flow for mass transport.

Referring to FIG. 15, a method 1500 of wetting a contact medium 1514 is illustrated. The method 1500 may include providing a plurality of liquid droplets 1512 and the contact medium 1514. In some embodiments, the method 1500 includes filling a plurality of active surface area features 1522 disposed within the contact medium 1514 with the plurality of liquid droplets 1512. The method may include stabilizing the plurality of liquid droplets 1512 with the active surface area features 1522. In some embodiments, the active surface area features 1522 facilitates increased wetting and resistance of the plurality of liquid droplets 1512 to surface tension. The resistance of the plurality of liquid droplets 1512 to surface tension may prevent or reduce droplet beading. In some embodiments, the active surface area features 1522 may facilitate resistance of the plurality of liquid droplets 1512 to gravitational forces. This may prevent the liquid from draining out of the contact medium 1514.

### Contactor Media Systems

Referring to FIG. 16A, a contactor media system 1600 is illustrated. The contactor media system 1600 may include an inlet pipe 1610 including a first end 1612 and a second end 1614. In some embodiments, the first end 1612 of the inlet pipe 1610 is connected to a liquid source. The second end 1614 of the inlet pipe may be connected to a liquid distributor 1620. The liquid distributor 1620 may be disposed on a first exterior surface 1634 of a plurality of contactor media 1630. The contactor media 1630 may be any of the contactor media disclosed herein. In some embodiments, the liquid distributor 1620 may be disposed above the plurality of contactor media 1630. The liquid distributor may be configured to apply or spray a liquid 1604 into the plurality of contactor media 1630. The plurality of contactor media may include a spacing 1632. The spacing 1632 may facilitate gas flow. In some embodiments, a collection structure 1640 is disposed on a second exterior surface 1636 of the plurality of contactor media. In other embodiments, the collection structure 1640 is disposed under the plurality of contactor media 1630. The second exterior surface 1636 may be disposed on an opposing side of the contactor media 1630 from the first exterior surface 1634. The collection structure 1640 may be configured to collect the liquid 1604. The liquid 1604 may flow through the contactor media into the collection structure 1640. In some embodiments, the collection structure 1640 includes at least one trough, bowl, tank, pipe, funnel, or other structure configured to collect liquid. The collection structure 1640 may be connected to a first end of an outlet pipe (not shown). In some embodiments, a second end of the outlet pipe may be configured to drain the liquid to a secondary reactor, structure, tank, or other liquid receiver. The plurality of contactor media 1630 may include any of the contactor media structures shown in FIGS. 1-15. In some embodiments, the plurality of contactor media 1630 are positioned within a housing 1650. The housing 1650 may be configured to receive a gas 1602. In some embodiments, the gas 1602 flows through the contactor media 1630 and interacts with the liquid 1604. The gas may flow out of the housing through a vent 1642.

FIG. 16B is an illustration of a radial contactor media reactor 1660. The illustration is a cross-sectional top-down view of the reactor 1660. The reactor 1660 includes a fan 1664 disposed in the center of a radial arrangement of contactor media fins 1662. The contactor media fins 1662 are contactor media as disclosed herein. In the reactor, gas (e.g., air) 1666 is pulled through the radial arrangement of contactor media fins 1662 by the fan 1664, facilitating mass transport between the gas and the liquid in the contactor media, and the gas 1668 flows out of the reactor 1660 via the center of the radial arrangement of contactor media fins 1662 through the fan 1664.

Where the contactor media is used for CO₂ capture, the gas flowed through the contactor media may include CO₂. Nonlimiting examples of the gas may include air in the atmosphere of earth, including atmospheric air in areas with greater emissions (e.g., landfills, agricultural sites), and flue gas. The mass transfer reaction between the liquid and the gas in the contactor media may remove CO₂ from the gas. The liquid may retain carbon extracted from the gas.

Where the contactor media is used for CO₂ capture, the liquid may include a CO₂ capture liquid including an ionic compound that can react with CO₂ gas. For example, the CO₂ capture liquid may include an amine, water, ionic liquid, glycerol, or metal hydroxides. Nonlimiting examples of the CO₂ capture liquid comprises MEA (monoethanolamine), DEA (diethanolamine), TEA (triethanolamine), MDEA (methyl diethanolamine), piperazine, glycine, KVO₃ (potassium metavanadate), KOH (potassium hydroxide), NaOH (sodium hydroxide), LiOH (lithium hydroxide), Ca(OH)₂ (calcium hydroxide), an amino acid, or a combination of any two or more thereof. For example, the liquid may be 0.5 M to 1.5 M (e.g, 1 M) NaOH or 0.5 M to 1.5 M (e.g, 1 M) KOH.

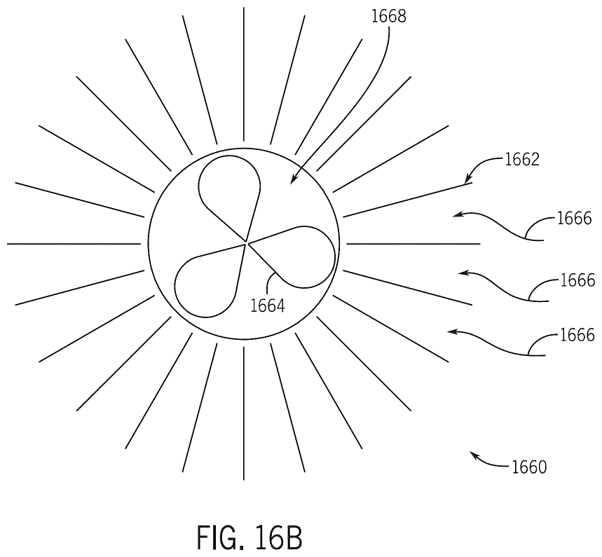

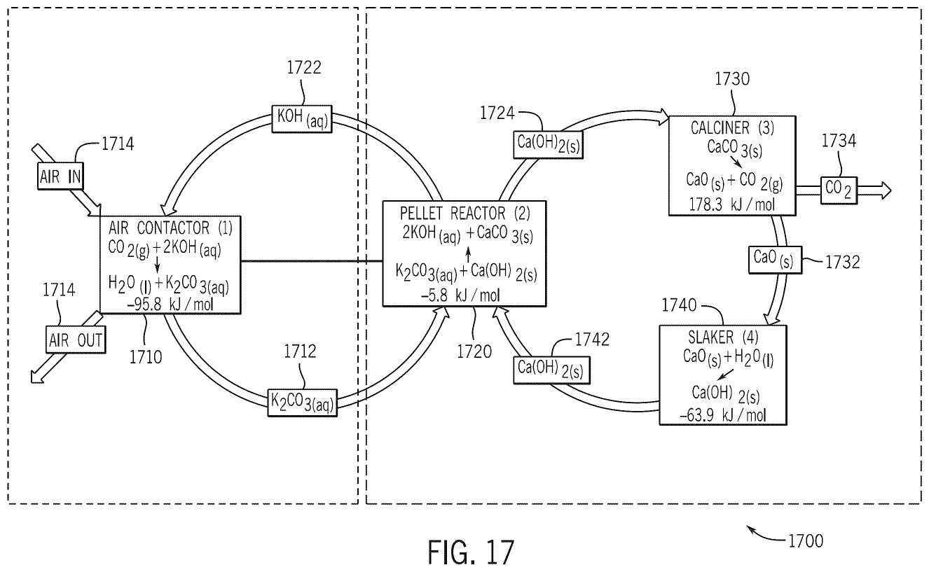

Referring to FIG. 17, a reaction scheme 1700 for the reaction of CO₂ gas with a metal hydroxide is illustrated. The carbon capture process may include an air contactor reaction 1710, a pellet reactor reaction 1720, a calciner reaction 1730, and a slaker reaction 1740. The air contactor reaction 1710 may include gaseous carbon dioxide reacting with aqueous potassium hydroxide to form liquid water and aqueous potassium carbonate as shown below:

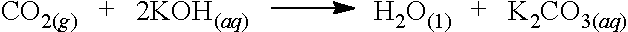

The pellet reactor reaction 1720 may include aqueous potassium carbonate reacting with solid calcium hydroxide to form aqueous potassium hydroxide and solid calcium carbonate precipitate as shown below:

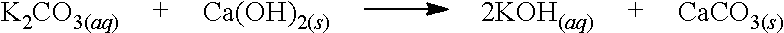

The calciner reaction 1730 may include calcium carbonate decomposing into calcium oxide and carbon dioxide. The slaker reaction 1740 may include calcium oxide and water as reactants in a formation reaction with a calcium hydroxide product. Alternatively, the slaker/calciner system may be replaced with an electrochemical cell and solids collector unit which is responsible for regeneration of the caustic CO₂ liquid absorbent.

In some embodiments, a potassium carbonate product 1712 from the air contactor reaction 1710 is transferred from an air contactor to a pellet reactor for use as a reactant in the pellet reactor reaction 1720. A potassium hydroxide product 1722 from the pellet reactor reaction 1720 may be transferred from the pellet reactor to the air contactor for use as a reactant in the air contactor reaction 1710. In some embodiments, a calcium carbonate product 1724 of the pellet reactor reaction 1720 may be transferred from the pellet reactor to a calciner for use as a reactant in the calciner reaction 1730. A calcium oxide product 1732 from the calciner reaction 1730 may be transferred from the calciner to a slaker for use as a reactant in the slaker reaction 1740. In some embodiments, a calcium hydroxide product 1742 of the slaker reaction 1740 may be transferred from the slaker 1740 to the pellet reactor for use as a reactant in the pellet reactor reaction 1720. In some embodiments, a carbon dioxide product 1734 of the calciner reaction 1730 is recycled from the calciner into the air contactor for use as a reactant in the air contactor reaction 1710. Air 1714 may flow through the air contactor to provide carbon dioxide as a reactant for the air contactor reaction 1710. Air 1714 may flow out of the air contactor.

### Contactor Media Unit Cells

The contactor media as disclosed herein may include continuous surface segments with repeating unit cells as disclosed herein.

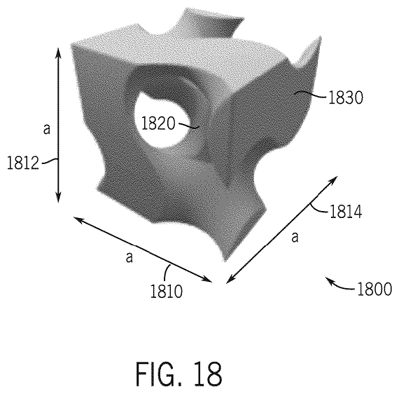

Referring to FIG. 18, a skeletal gyroid unit cell 1800 includes a first length along the x-axis 1810, a second length along the y-axis 1812, and a third length along the z-axis 1814. The skeletal gyroid unit cell 1800 may include a two-dimensional surface 1820. In some embodiments, a structure 1830 of the skeletal gyroid unit cell 1800 may include the contour of a zero-thickness surface. The structure 1830 of the skeletal gyroid unit cell 1800 may include a Gaussian curvature of −400 mm⁻² and −0.01 mm⁻². In some embodiments, the skeletal gyroid unit cell 1800 includes a minimal surface geometry.

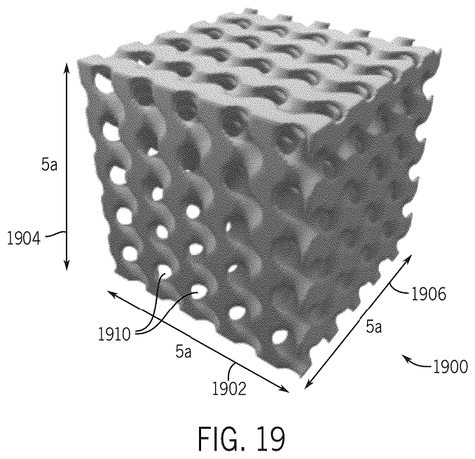

Referring to FIG. 19, a three-dimensional array 1900 of skeletal gyroid unit cells, as shown in FIG. 18, is illustrated. The three-dimensional array 1900 of skeletal gyroid unit cells with continuous surface segments 1910 may include a first length along the x-axis 1902, a second length along the y-axis 1904, and a third length along the z-axis 1906.

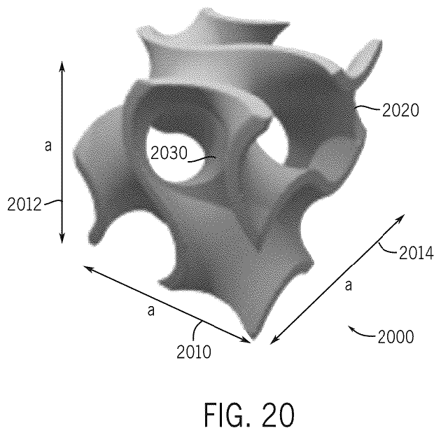

Referring to FIG. 20, a sheet gyroid unit cell 2000 includes a first length along the x-axis 2010, a second length along the y-axis 2012, and a third length along the z-axis 2014. The sheet gyroid unit cell 2000 may have a defined thickness. In some embodiments, the structure 2020 of the sheet gyroid unit cell may include a continuous surface with a given thickness 2030. The sheet gyroid unit cell 2000 may include a two-dimensional surface 2020. In some embodiments, a structure 2030 of the sheet gyroid unit cell 2000 may include the contour of a zero-thickness surface. The structure 2030 of the skeletal gyroid unit cell 2000 may include a Gaussian curvature of −400 mm⁻² and −0.01 mm⁻². The structure 2030 of the sheet gyroid unit cell 2000 may include a Gaussian curvature between −100 mm⁻² and 0 mm⁻². The sheet gyroid unit cell 2000 is an example of a minimal surface geometry.

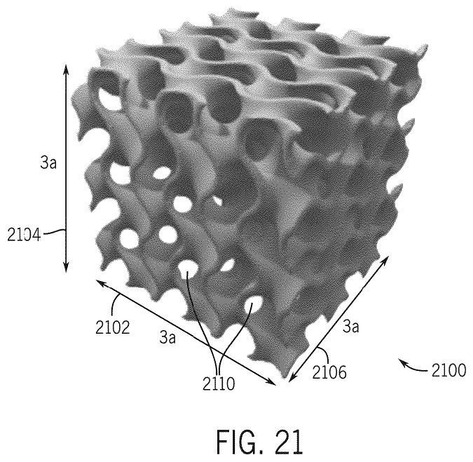

Referring to FIG. 21, a three-dimensional array 2100 of sheet gyroid unit cells, as shown in FIG. 18, is illustrated. The three-dimensional array 2100 of sheet gyroid unit cells may include a first length along the x-axis 2102, a second length along the y-axis 2104, and a third length along the z-axis 2106. In some embodiments, the three-dimensional array 2100 of sheet gyroid unit cells includes continuous surface segments 2110 of the sheet gyroid unit cells shown in FIG. 18. The continuous surface segments 2110 may provide liquid hold-up capacity through surface wetting (e.g., capillary action). In some embodiments, at least 60 percent of the gyroidal continuous surface segments 2110 provide surface wetting for liquid hold-up.

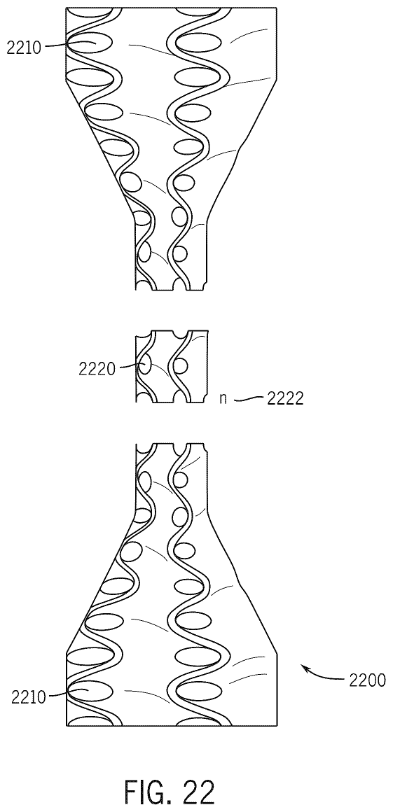

Referring to FIG. 22, an illustration of gyroid unit cells 2200 configured to form an I-beam structure, an example of a contactor body as disclosed herein, is shown. In some embodiments, the gyroid unit cells 2200 are configured to form the I-beam sheet contactor media shown the FIG. 9. The gyroid unit cells 2200 may include a first gyroid unit cell 2210 and a second gyroid unit cell 2220. As described in the FIG. 9 description, a first end of an I-beam structure may include the first gyroid unit cell 2210. A second end of the I-beam structure may also include the first gyroid unit cell 2210. In some embodiments, a middle portion of the I-beam structure includes at least one second gyroid unit cell 2220. The number (n) 2222 of second gyroid unit cells 2220 may determine a height of the I-beam structure.

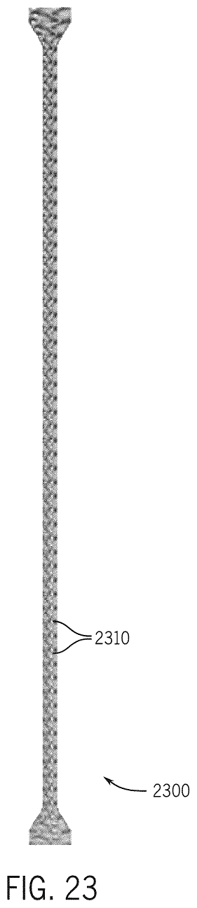

Referring to FIG. 23, an illustration of an example of a contactor body is shown, with the contactor body formed in particular as an I-beam 2300 configured to be arrayed in a two-dimensional pattern to form a gyroid sheet contact medium. The I-beam-shaped contactor media can be a unit cell with a continuous surface that repeats as multiple units are proximally placed. In particular, this approach can be leveraged to create a large block or other assembly of contactor media, as in FIG. 10, which is one continuous surface. The I-beam 2300 may include the gyroid unit cells shown in FIG. 22. The I-beam 2300 may include minimal surface geometry. In some embodiments, the I-beam 2300 may include surface features 2310 described in previous figure descriptions. The I-beam 2300 may include a length defined by a number of unit cells. In some embodiments the dimensions of the unit cells may be distorted to allow for smaller or larger openings (1 mm to 100 mm) through which a gas phase may pass. In some embodiments, the outer dimensions of the unit cell may result in a volume ranging from 0.01 m³ to 1 m³. In some embodiments, there may be additional ‘fins’ per unit volume of bulk contactor media, increasing the total amount of active surface area and correspondingly both total and static liquid hold-up in the aforementioned ranges.

Contactor Media with Liquid Distribution

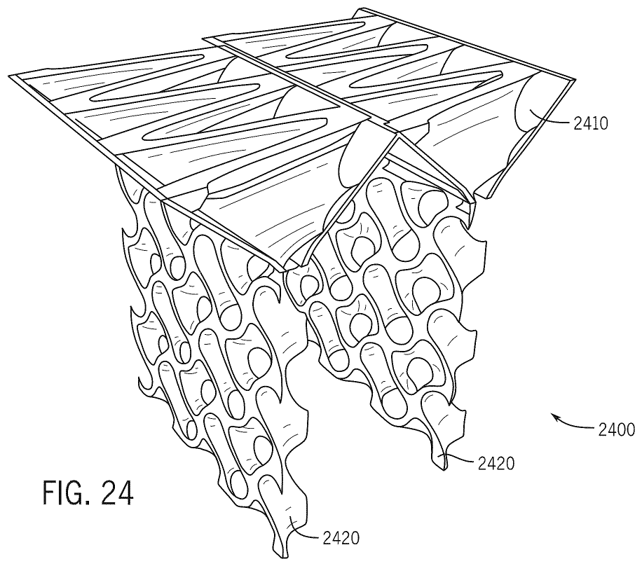

Referring to FIG. 24, an illustration of a liquid distributor 2400 disposed on a liquid introduction side of a gyroidal contactor media configured to funnel liquid into the gyroidal contactor media is shown. The liquid distributor may include a funnel structure 2410 and contactor media 2420, an example of a contactor body as disclosed herein. In some embodiments, the funnel structure 2410 is configured to collect liquid and facilitate liquid flow into the contactor media 2420. The liquid distributor 2400 may include features of liquid distributors described in previous figure descriptions. The contactor media 2420 may include features of contactor media described in previous figure descriptions. The liquid distributor 2400 may be formed using the same processes as are used to form the contactor media 2420, and the liquid distributor 2400 may be directly disposed and continuous with the contactor media 2410. The liquid distributor 2400 may provide control over liquid flow rates, control over contactor media 2420 wetting methods, and even distribution of the liquid across the contactor media 2420. Excess fluid may be transferred (e.g., laterally through internal pores) from one contactor medium continuous surface segment to another. In some embodiments, fluid transfer prevents dry areas from forming in contactor media 2420. In some embodiments, fluid transfers in a more even distribution of fluid across the contactor media 2420.

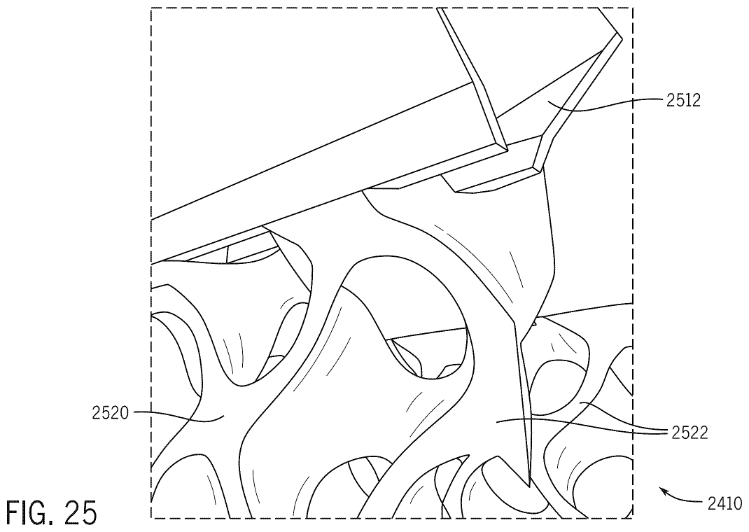

Referring to FIG. 25, an illustration of the funnel structure 2410 of the liquid distributor of FIG. 24 disposed within the liquid distributor disposed on a liquid introduction side of contactor media 2520 is shown. The liquid distributor may be configured to receive a liquid. In some embodiments, the liquid distributor includes a funnel 2512. The funnel 2512 may be configured to direct liquid flow into the contactor media 2520. The liquid distributor may include features of liquid distributors described herein. The contactor media 2520 may also include features of contactor media described herein. Inactive surface areas 2522 are areas where capillary action and static second phase hold-up are not favored.

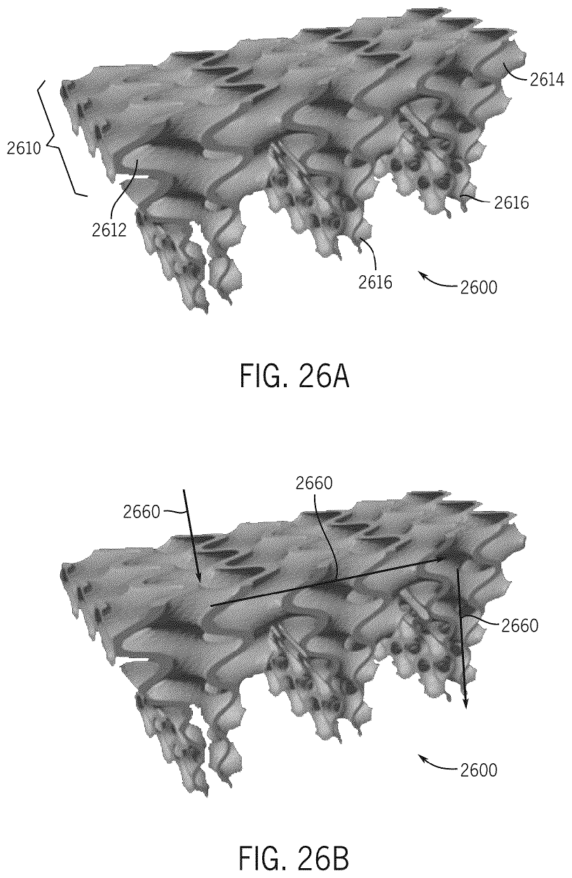

Referring to FIG. 26A, an illustration of a contactor media 2600 with a distributor layer 2610. The distributor layer 2610 includes a distribution inlet 2600 configured to transfer liquid laterally through the distributor layer 2610, from, for example, a first end of the contactor media 2612 to a second end 2614 of the contactor media, as shown by the horizontal arrow in FIG. 26B. The arrows 2660 in FIG. 26B indicate flow of a liquid into the distribution inlet 2600 and laterally across the distributor layer 2610, before entering sheets 2616 of the contactor media, each representing an example of a contactor body as disclosed herein. The distributor layer 2610 is geometrically configured to evenly distribute liquid through the contactor media 2600, and may provide lateral liquid flow directions. The contactor media 2600 is formed of a gyroidal continuous surface for increased liquid hold-up.

The distributor layer 2610 may be formed of the repeating unit cells 2210 in FIG. 22, forming the upper section of the I-beam contactor media 2300 in FIG. 23. Because of the lateral distribution inlets in the distributor layer 2610, the distributor layer 2610 provides for lateral re-distribution of liquid to provide more uniform wetting in the I-beam contactor media 2300.

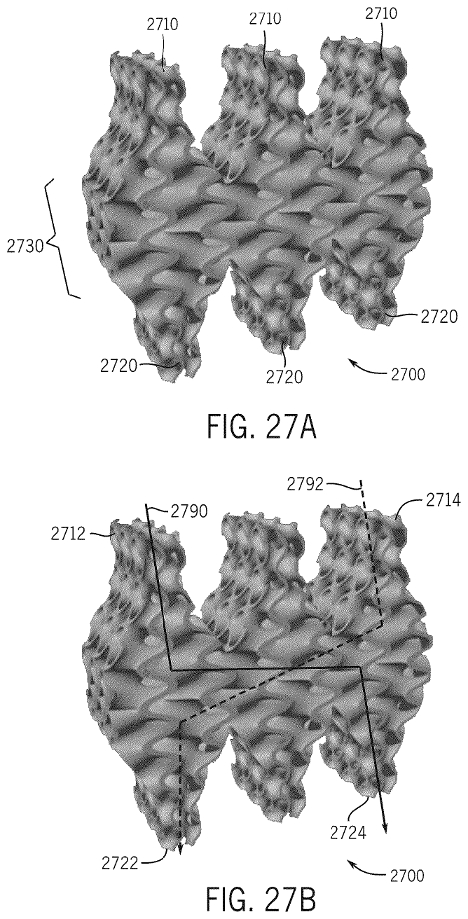

Referring to FIG. 27A, an illustration of a liquid distributor mid-layer 2700 configured to transfer liquid laterally in a contactor media is shown. The liquid distributor mid-layer 2700 includes a distributor layer 2730, a plurality of inlets 2710, and a plurality of outlets 2720. The liquid distributor mid-layer 2700 may be configured to mix heavier flows with lighter flows to evenly distribute liquid flow in the liquid distributor mid-layer 2700 and/or the contactor media.

Referring to FIG. 27B, an illustration of lateral liquid transfer in the liquid distributor mid-layer 2700 is shown. The liquid distributor mid-layer 2700 may transfer an incoming liquid 2790 from a first inlet 2712 to a first outlet 2724 disposed in another segment of the distributor mid-layer. The liquid distributor mid-layer 2700 may transfer an incoming liquid 2792 from a second inlet 2714 to a second outlet 2722 disposed in another segment of the distributor mid-layer. Transferring the liquid 2790 between segments of contactor media may evenly distribute fluid flow throughout the liquid distributor 2700 or external contactor media. In some embodiments, solute-rich streams may be mixed with dilute streams.

The liquid distributor mid-layer 2700 may be disposed between arrays of the continuous surface segments of the contactor media. For example, the liquid distributor mid-layer 2700 may be disposed at a midpoint of the contactor media, or at several intervals throughout the contactor media. The liquid distributor mid-layer 2700 may be configured to re-distribute liquid flow throughout the plurality of continuous surface segments. The liquid distributor mid-layer 2700 may serve to mix the fluid throughout the media to prevent the evolution of liquid flow which favors a certain area of the contactor media, and/or avoids dry pockets of the contactor media from receiving liquid.

Contactor Media with Directed Liquid Flow

The contactor media may be configured to retain the liquid within the contactor media. The contactor media may have a geometry configured to direct liquid flow. For example, the contactor media may have a geometry to retain the liquid when the contactor media is positioned in a first rotation orientation and facilitate flow of the liquid when the contactor media is positioned in a second rotation orientation. The first rotation orientation may include a 90-degree rotation about a singular axis from the second rotation orientation.

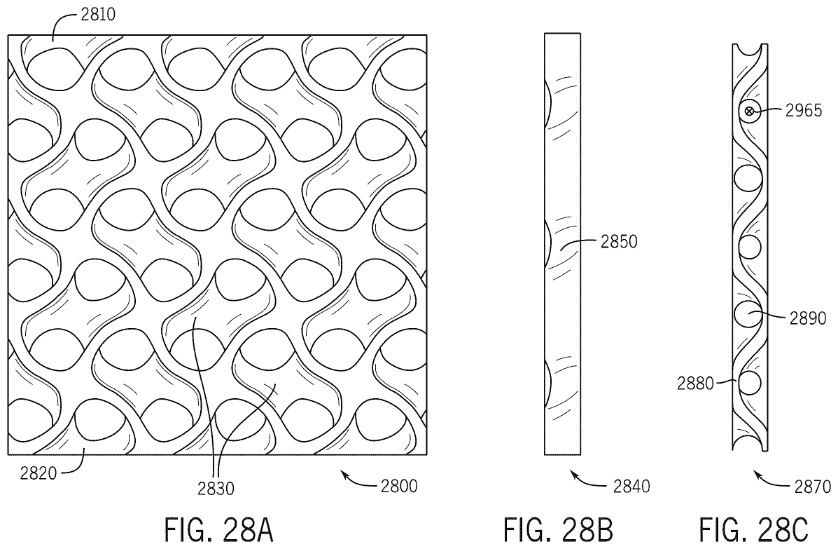

Referring to FIG. 28A, an illustration of a radial view of a gyroidal contactor media 2800 configured to drain liquid vertically is shown. Flow control within the liquid distributor embodiments shown in FIGS. 24-27 may be facilitated by the contactor media 2800. Contactor media 2800 may provide a liquid flow path configured to allow liquid to flow through the contactor media in a predetermined direction. In some embodiments, gravitational forces may generate liquid flow from a first end 2810 of the contactor media 2800 to a second end 2820 of the contactor media 2800. The gyroid unit cell may include surface features 2830 that create the flow path from the first end 2810 to the second end 2820. In some embodiments, liquid flows from a top side of the contactor media to a bottom side of the contactor media.

Referring to FIG. 28B, an illustration of an top view 2840 of the contactor media of FIG. 28A configured to drain liquid vertically is shown. An axial side 2850 of the contactor media may be substantially flat and may block a flow path. The axial side 2850 may include a barrier configured to prevent liquid flow. In some embodiments, the axial side 2850 does not allow liquid to flow out of the axial side 2850 of the contactor media.

Referring to FIG. 28C, an illustration of a top view 2870 of the contactor media of FIG. 28A configured to drain liquid vertically is shown. In some embodiments, a top side 2880 of the contactor media includes surface features 2890. The top side 2880 of the contactor media may be porous, as to form internal flow areas including one or more capillary flow path 2890 For example, as shown in FIG. 28C, the one or more capillary flow paths 2890 may be oriented substantially parallel to axis 2965 oriented perpendicular to the page. In some embodiments, the surface features 2890 on the top side 2880 of the contactor media facilitate liquid flow through the top side 2880 of the contactor media.

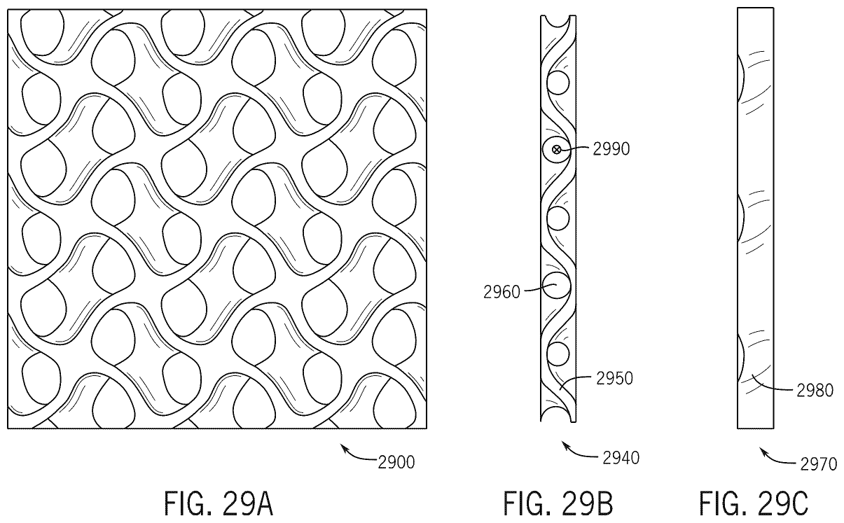

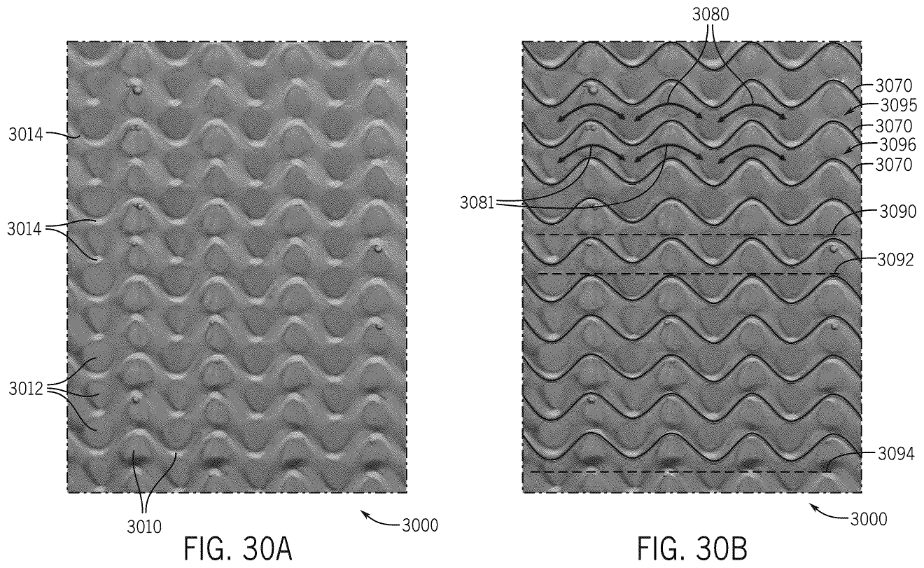

Referring to FIG. 29A, an illustration of a radial view of a contactor media 2900 configured to retain liquid is shown. In some embodiments, the contactor media 2900 is a 90-degree rotation of the gyroid unit cell shown in FIG. 28A. Therefore, liquid may not flow in a gravitational direction. Rather, the liquid may flow in a radially direction to gravitational forces. The contactor media may facilitate lateral liquid flow as shown in the liquid distributor embodiments shown in FIGS. 24-27. By changing the orientation of the contactor media, the contactor media may facilitate liquid retention.

Referring to FIG. 29B, an illustration of an axial view 2940 of the contactor media of FIG. 29A configured to retain liquid is shown. In some embodiments, an axial side 2950 of the contactor media includes surface features 2960. The axial side 2950 of the contactor media may be porous, as to form internal flow areas including one or more capillary flow path 2960. For example, as shown in FIG. 29B, the one or more capillary flow paths 2960 may be oriented substantially parallel to axis 2990 oriented perpendicular to the page. In some embodiments, the surface features 2960 on the axial side 2950 of the contactor media facilitate liquid flow through the axial side 2950 of the contactor media.

Referring to FIG. 29C, an illustration of a top view 2970 of the contactor media of FIG. 29A configured to retain liquid is shown. A top side 2980 of the contactor media may be substantially flat and may block a flow path. The top side 2980 may include a barrier configured to prevent liquid flow. In some embodiments, a substantially flat bottom side may not allow liquid to flow out of the bottom side of the contactor media. Because gravitational forces may pull liquid from the top side 2980 to the bottom side, blocking the flow path from the top side 2980 to the bottom side may cause the contactor media to retain liquid. In some embodiments, the contactor media blocks liquid flow in one direction and facilitates liquid flow in another direction. By orienting contactor media in a particular direction, the contactor media may direct the path of liquid flow.

Comparing the two contactor media geometries in FIGS. 28A-28C and FIGS. 29A-29C, respectively, reveals different liquid hold-up values. When the contactor media is used as a gas-liquid contactor media, with an air flow frontal velocity of 1.5 m/s through the contactor media, and a 1 M KOH liquid flow of 0.5 L·s⁻¹·m⁻², the observed static liquid hold-up for the contactor media in FIGS. 28A-28C was about 35% of the total liquid hold-up. In comparison, under the same conditions, the observed static liquid hold-up for the contactor media in FIGS. 29A-29C was greater than 90% of the total liquid hold-up. These two contactor media used the same contactor media materials, liquids, surface treatments, where the only difference was the geometry.

Referring to FIG. 30A, a photograph of a contactor media 3000 retaining liquid is shown. The contactor media 3000 may include surface features 3010. In some embodiments, the surface features 3010 include a plurality of cavities 3012 and a plurality of barrier structures 3014. The plurality of cavities 3012 may be configured to retain liquid. In some embodiments, the plurality of cavities 3012 may be interconnected across the surface media to create longer connected channels which may facilitate liquid flow (e.g., capillary flow, as discussed above). The barrier structures 3014 may be configured to obstruct liquid flow. In some embodiments, the barrier structures 3014 restrict fluid flow to a lateral direction.

Referring to FIG. 30B, a photograph illustrating liquid flow paths 3080 and extended liquid flow barriers 3070 of the contactor media 3000 shown in FIG. 30A is shown. Liquid may flow in a liquid flow path 3080 axial to the barriers 3070 along a first continuous capillary flow path 3095 in a first direction (e.g., as formed by an interconnected set of the cavities 3012 indicated in FIG. 30A). A second continuous capillary flow path 3096 is created by a second row of liquid flow paths 3081 spaced apart from the flow path 3095 transverse to the first direction (e.g., located below the first continuous capillary flow path 3095, and formed by another interconnected set of the cavities 3012 indicated in FIG. 30A). The first continuous capillary flow path 3095 and the second capillary continuous flow path 3096 are separated from the first continuous capillary flow path 3095 by barriers 3070, which may be formed by corresponding sets of the barrier structures 3014 that extend along and between adjacent flow paths (e.g., the flot paths 3095, 3096. In some examples, the barriers 3070 (and the barrier structures 3014) can be formed by inactive surfaces where capillary action and static second phase hold-up are not favored.

Thus, the barriers 3070 may result in fluid preferentially flowing along rather than between the flow paths 3095, 3096—e.g., at least until liquid has substantially filled the flow paths 3095 (e.g., wetting 90% or more of the surface area thereof). In some cases, the first continuous capillary flow path 3095 and the second capillary continuous flow path 3096 are separated by inactive surfaces of the barriers 3070 such that flow between the first continuous capillary flow path 3095 and second continuous capillary flow path 3096 crosses the inactive surfaces 3070 (e.g., with the flow path 3095 not being otherwise fluidly in communication with the flow path 3096). In particular examples, including as shown, flow from the flow path 3095 to the flow path 3096 can flow across the inactive surfaces in the direction of gravity. In some cases, the barriers 3070 may include a corrugated structure configured to facilitate liquid retention and slow liquid flow.

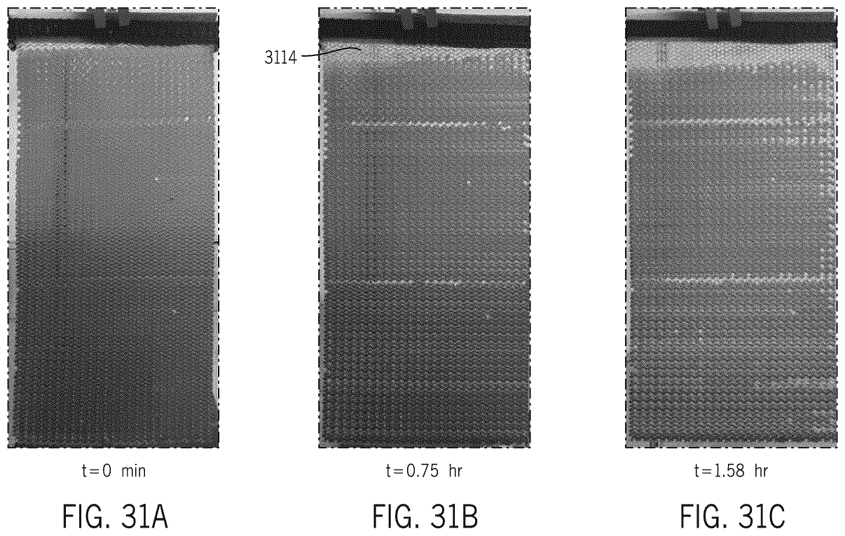

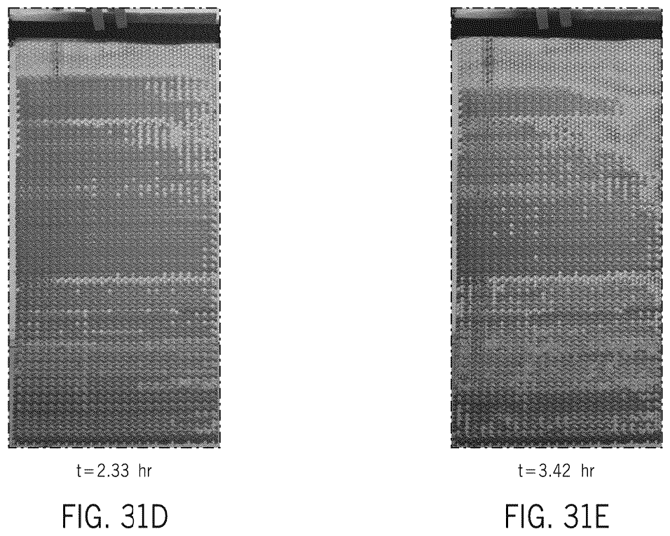

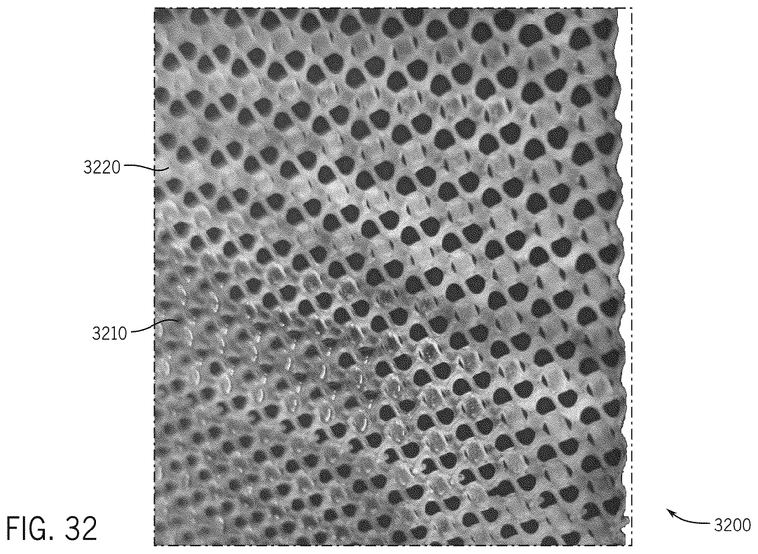

In some embodiments, the barriers 3070 are configured to facilitate a dropping method. The dropping method may include adding a first drop of liquid to a top domain of the contactor media. In some embodiments, the dropping method further includes a chain reaction causing a second drop of liquid to be displaced out of a first barrier plane 3090, falling into a second barrier plane 3092 and displacing a third drop of liquid out of the second barrier plane 3092. The dropping method may further include displacing a singular liquid drop out of a bottom barrier plane 3094. In this regard, as further discussed below relative to FIGS. 31A-32, it may be possible to distribute liquid widely and relatively uniformly across an entire contactor with relatively high efficiency (e.g., with zero or relatively low flow rates of liquid escaping the contactor until the contactor is fully or near-fully wetted). While a drop-by-drop example illustrates the fundamental principle, particular contactors may exhibit similar behavior with higher rate introduction of liquid. In particular, for example, the preferential capillary flow along laterally extending or other flow paths (e.g., the flow paths 3095, 3096) and corresponding interposed barriers (e.g., the barriers 3070) may result in liquid that is received into a top portion of the contactor media 3000 preferentially distributing along an initialcapillary flow path, with an adjacent barrier preventing escape of the fluid into a next (e.g., lower, adjacent) capillary flow path until the first capillary flow path has been filled and additional flow of liquid into the first flow path can then spill over the relevant barrier to the next capillary flow path. This process can then continue for each successive set of capillary flow path and barrier, resulting in a high degree of wetting with relatively low liquid loss.

The present invention, thus generally described, will be understood more readily by reference to the following examples, which are provided by way of illustration and are not intended to be limiting of the present invention.

### EXAMPLES

### Example 1

A contactor media was formed having a gyroidal continuous surface. The gyroidal continuous surface formed a plurality of channels with a bilobed-shaped (e.g., peanut-shaped) cross-section for liquid holdup. The gyroidal continuous surface had a sheet gyroid unit cell that followed the contour of a zero-thickness surface having a Gaussian curvature (“Gc”) of −100 mm⁻²≤Gc<0 mm⁻². The wall thickness of the gyroidal continuous surface was about 300 μm. The contactor media had the macroscopic shape of a rectangular prism.

The contactor media was printed using stereolithography 3D printing, where light was used to cure liquid resin in a layer-by-layer fashion. The surface of the contactor media had features of about 50 μm diameter as a result of the pixel size of the 3D printing process.

Liquid holdup experiments were conducted using water mixed with blue food coloring to visualize liquid holdup. The contactor media was saturated with the liquid media at time 0 and then photographs of the contactor media were taken at different time points to determine liquid holdup over time.

Referring to FIG. 31A, a photograph of contactor media saturated with the liquid at time 0 is shown. FIG. 31B shows a photograph of the contactor media of FIG. 31A retaining liquid at 45 minutes after saturation with said liquid. The contactor media appears blue (alternatively identified by darker grey shading) due to static liquid hold-up of a liquid including blue dye for visualization, where the darker regions indicate liquid holdup in the contactor media. At 45 minutes, a portion of the liquid had been removed from the contactor media due to the force of gravity, as indicated by the lighter region 3114 of the contactor media at the top of the rectangular prism. In addition, a small amount of the liquid had evaporated from the contactor media, as indicated by the non-uniform arrangement of lighter regions of the contactor media. FIG. 31C is a photograph of the contactor media retaining liquid at 95 minutes after saturation with the liquid. At this time, a greater amount of the liquid had been removed from the contactor media by evaporation, but still greater than 75% of the liquid remains, demonstrating the contactor media has a static liquid hold-up of at least 75% at times greater than 60 minutes after saturation. FIG. 31D is a photograph of the contactor media retaining liquid at 135 minutes after saturation with the liquid. At this time, a greater amount of the liquid had evaporated from the contactor media, as indicated by the greater regions of non-uniformity of lighter regions of the contactor media. FIG. 31E is a photograph of the contactor media retaining liquid at 205 minutes after saturation with the liquid. At this time, a larger amount of the liquid had evaporated from the gyroid film.

Referring to FIG. 32, a photograph showing a closer view of the contactor media in FIG. 31E. The photograph shows the evaporation patterns on the contactor media 3200. Darker blue patterning 3210 (alternatively identified by darker grey shading) indicates areas of liquid retention and lighter blue patterning 3220 (alternatively identified by lighter grey shading) indicates areas where the liquid has evaporated, leaving behind traces of the blue dye.

### Example 2

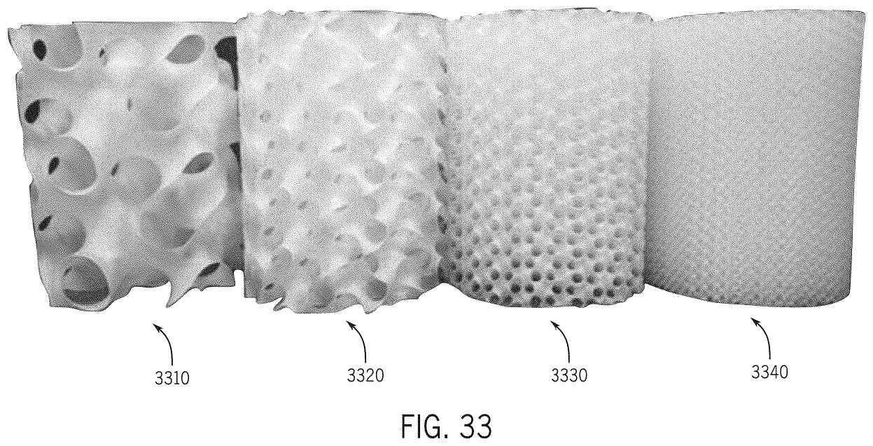

FIG. 33 is a photograph of different gyroidal contactor media 3310, 3320, 3330, and 3340 made of an acrylate/methacrylate based photopolymer that each have a continuous surface that follows a contour of a zero-thickness surface having a Gaussian curvature of decreasing values (left to right; negative values becoming larger in magnitude) and follow a contour of a zero-thickness surface having a principal curvature of decreasing values. Each of the gyroidal contact media 3310, 3320, 3330, and 3340 at least 50% of its surface area follow at least one of: (a) a contour of a first zero-thickness surface having a Gaussian curvature (“G_{c}”) of −400 mm⁻²≤G_{c}<−0.01 mm⁻²; and (b) a contour of a second zero-thickness surface having at least one principal curvature (kᵢ) of −20 mm⁻¹≤kᵢ<−0.1 mm⁻¹.

Each of the gyroidal contactor media 3310, 3320, 3330, and 3340 were used as gas-liquid contactor media for carbon dioxide capture. With an air flow frontal velocity of 1.5 m/s through the contactor media, and a 1 M KOH liquid flow of 0.5 L·s⁻¹·m⁻², the observed total liquid hold-up was in the range of 30 kg/m³ to 120 kg/m³ and the static liquid hold-up at a time of 1 hour ranged from 10 kg/m³ to 120 kg/m³ for all of the contactor media.

### Example 3

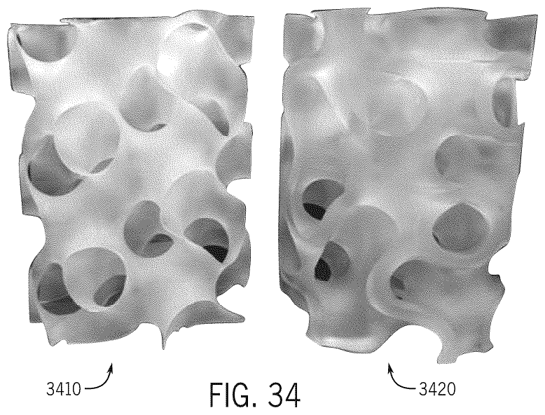

FIG. 34 is a photograph of two different gyroidal contact media that each has a continuous surface with a different thickness, where both contact media follow the same contour of a zero-thickness surface having a Gaussian curvature (“G_{c}”) of −400 mm⁻²≤G_{c}<−0.01 mm⁻², but having two different thicknesses (300 μm for 3410 and 6 mm for 3420).

### Example 4

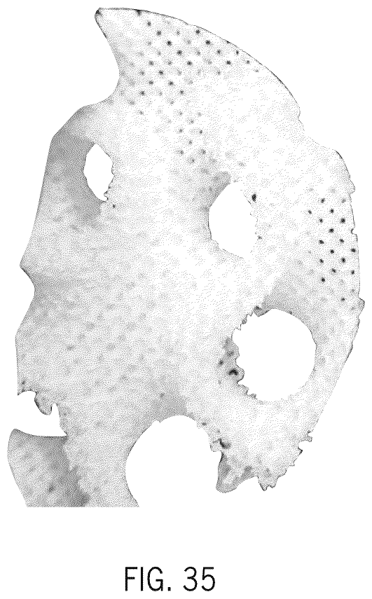

FIG. 35 is a photograph of a gyroidal contact media that has a continuous surface that follows the contour of a zero-thickness surface having a Gaussian curvature (“G_{c}”) of −400 mm⁻²<G_{c}<−0.01 mm⁻², where the geometry is a gyroid of gyroids. The microgeometry (about 3 mm unit cell size) is a sheet gyroid (consistent with the unit cell in FIG. 20), while the larger macro geometry (about 50 mm unit cell size) is either consistent with the skeletal gyroid unit cell in FIG. 18 or the sheet gyroid unit cell in FIG. 20. The gyroid of gyroid contact media has a microgeometry with a continuous surface that has at least 50% of its surface area follow a contour of a first zero-thickness surface having a Gaussian curvature (“G_{c}”) of −400 mm⁻²≤ G_{c}<−0.01 mm⁻², resulting in static liquid hold-up via capillary action. The macrogeometry may be independently defined (here as gyroids, but also may be, e.g., I-beams, tubes, rectangular prisms) so as to provide a predetermined pressure-drop across the system when gas is flowed through the contactor media. In this way, the boundary layer mass transport (e.g., >2 mm length scale) is balanced with the macroscale mass transport (e.g., transport of air over several meters of contactor packing media).

### Example 5

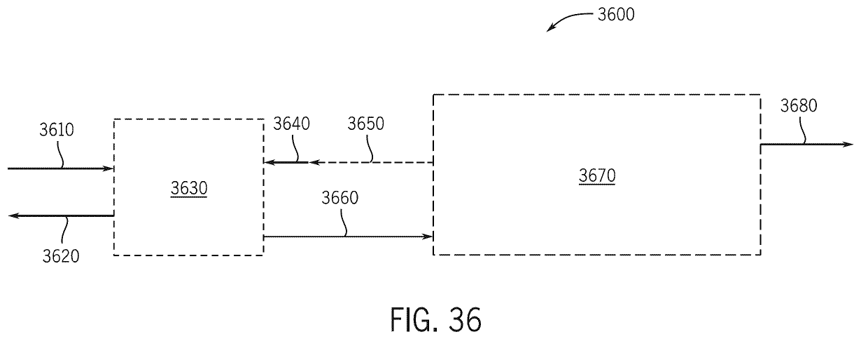

FIG. 36 shows a schematic of an embodiment of a contactor system 3600 as disclosed herein. In one example elaborated on below, the contactor system can be a DAC system may include operational units configured to perform DAC of (gas phase) carbon dioxide using a liquid sorbent. Those skilled in the art will appreciate that the contactor system 3600 may be used to contact various combinations of phases, including gas-gas, liquid-gas, or liquid-liquid. Further, the system described herein can contact, capture, and process materials other than carbon dioxide.

As shown in FIG. 36, the system includes a rich material feed 3610 configured to transfer rich material to a capture unit 3630. The system further includes a deplete material feed 3620 configured to transfer depleted material from the capture unit 3630. The capture unit 3630 contains one or more of the contactor medias as described herein.

In the example of a DAC system, the rich material includes a gas containing carbon dioxide at a higher concentration than the concentration of carbon dioxide in the deplete material feed. The rich material feed 3610 and the deplete material feed 3620 can further include elements for moving and directing gases across the contactor media such as housings, ducts, conduits, fans, pumps, or any combinations thereof, as variously known in the art. The rich material feed 3610 can be configured to move across the contactor media in a counter flow geometry, cross flow geometry, or any combination thereof.

In another aspect, the capture unit 3630 is supplied with a liquid sorbent by a capture liquid feed 3640. In some cases, the liquid sorbent, also referred to as a capture liquid, is a basic aqueous solution. In some cases, the capture liquid includes an aqueous metal hydroxide solution, such as KOH, NaOH, or combinations thereof. Optionally, the capture liquid may be recycled via a recycled capture liquid feed 3650.

The recycled capture liquid feed 3650 may be recycled from downstream regeneration chemistries performed by other operational units, e.g., one or more operation units within the captured materials processing unit 3670. Using DAC as an example, the captured materials processing unit 3670 can be configured to receive, via a captured materials feed 3660, the aqueous metal carbonate produced from the capture unit 3630. For example, the captured materials processing unit 3670 may include a pellet reactor unit configured to accept an aqueous metal carbonate, such as such as potassium carbonate (K₂CO₃), from the capture unit 3630 can be reacted with another solid metal hydroxide, such as calcium hydroxide (Ca(OH)₂), to regenerate the aqueous metal hydroxide and resupply the capture unit 3630 via a recycled capture liquid feed 3650. A metal carbonate precipitate, such as calcium carbonate (CaCO₃) is also produced by the pellet reactor unit. The captured materials processing unit 3670 may also include a calciner unit configured to, for example, accept the metal carbonate precipitate. The metal carbonate precipitate can decompose to a solid oxide, such as calcium oxide (CaO) and carbon dioxide. The carbon dioxide, for example, maybe transferred from the captured materials processing unit 3670 via a processed captured materials feed 3680. The captured materials processing unit 3670 may also include a slaker unit configured to hydrate the metal oxide solid with water to form a metal hydroxide, such as calcium hydroxide (Ca(OH)₂). The metal hydroxide can optionally be resupplied to the pellet reactor unit. In other examples, however, other capture materials processing units can be used, as may be variously known in the art for processing particular capture fluid relative to particular captured species. Alternatively, the slaker unit calciner unit may be replaced with an electrochemical cell and solids collector unit which is responsible for regeneration of the caustic CO₂ liquid absorbent.

### Example 6

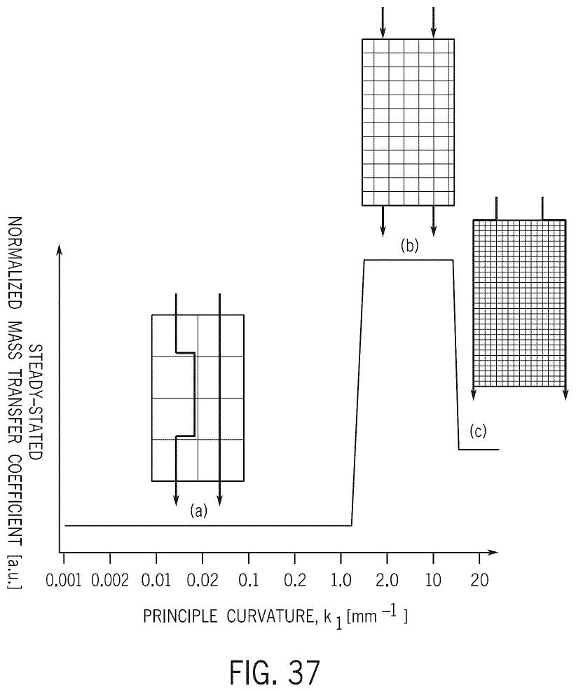

FIG. 37 shows a graphical representation of steady-stated normalized mass transfer coefficient as a function of principle curvature. Three gyroid sheets having unit cells in three size regimes are shown: (a) a unit cell on a scale where capillary action is unlikely to occur across the large pores/openings when the gyroid sheet is wetted with a capture solution and, (b) a gyroid sheet having a unit cell that is within an optimal window for capillary action to occur across the pores/openings when the gyroid sheet is wetted with a capture solution, and (c) a gyroid sheet having pores/openings on a small scale such that capillary action is unlikely to occur.

Surprisingly, the inventors determined that the gyroid unit cell size, a function of the principle curvature, has a strong and non-linear impact on steady state normalized mass transfer coefficient. As shown in FIG. 37, region (a) shows a range of principle curvatures of a gyroid sheet which correspond to unit cells with relatively large pores/openings where capillary action is unlikely to occur across when the gyroid sheet is wetted with a capture solution. Instead, in this regime, the capture solution may channel in a minimal path through the gyroid sheet and may correspondingly exhibit relatively low total liquid hold-up. This, in turn, results in a low, but non-zero, mass transport that is comparable to traditional air contactor media.

Region (b) shows a range of principle curvatures of a gyroid sheet which correspond to unit cells that are within an optimal window for capillary action to occur across the pores/openings when the gyroid sheet is wetted with a capture solution. In this range of principle curvatures, the capture solution will wet the gyroids' surface and fill the pores. As the capture solution wets to the contactor media and forms a film across the openings of the contactor media, a stable surface is formed that allows for, surprisingly, a higher mass-transfer coefficient. Referring to previous discussion, this behavior may result in part from the contrast between capillary flow along corresponding flow paths and the presence of barrier structures (e.g., inactive surfaces) between adjacent capillary flow paths. Thus, as also discussed above, capillary action may result in substantial wetting of each successive flow path before sufficient liquid is retained to flow past an adjacent barrier structure to the next flow path.

Region (c) represents a range of principle curvatures of the gyroid sheet which correspond to unit cells having pores/openings on a small scale where capillary action is unlikely to occur. As the pores/openings in the gyroid sheet become smaller and smaller, the capture solution will no longer flow into the gyroid itself but will, instead, preferentially flow down the outer surface of the gyroid sheet. This exterior “channeling” will result in a substantial drop in mass transfer as compared to region (b).

The specific transitions from region (a) to region (b) and from region (b) to region (c) may depend on a number of physical parameters, such as the solid contactor media material, the liquid capture solution, and the gaseous phase. However, the principles illustrated are believed to be generally applicable.

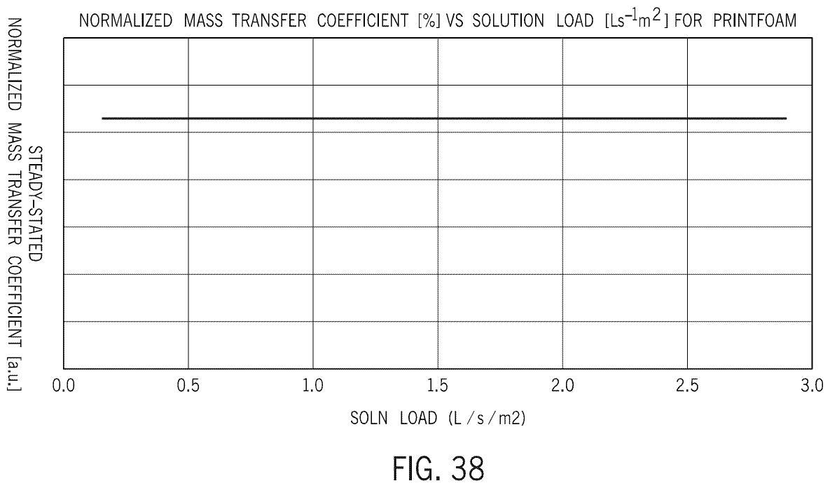

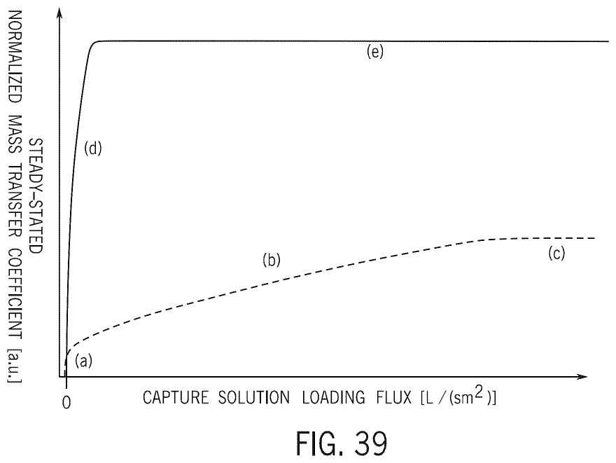

FIG. 38 shows normalized mass transfer coefficient representative of the contactor medias, systems, and methods disclosed herein as a function of solution load. Traditional air-contactor media typically show a linear, or at least proportional, increase with solution loading (see FIG. 39, dashed line, section (b), elaborated on below). The contactor media disclosed herein surprisingly show a much higher performance that exhibits an invariant performance profile with solution loading rates.

Referring now to FIG. 39, traditional packing media (dashed line) shows three domains of performance, as quantified by normalized mass transfer coefficient for a molecule of interest transferring from the gas the liquid phase, based upon the flow/flux of capture solution. In domain (a), at lower flows/fluxes of capture solution, mass transfer of the molecule of interest from the gaseous to liquid phase is rate limited due to saturation of the capture solution. In domain (b), a linear relationship is observed in which the mass transfer coefficient increases at a rate that is proportional to the increase in the flux of the capture solution. This is understood to result from increased wetting of the available surface of the media. At even higher capture solution loading fluxes, in domain (c), a maximal wetting level is achieved, and the performance stagnates—i.e., because addition of further liquid may not provide further interface surface area for mass transver. Further, at higher fluxes a precipitous drop in performance from ‘flooding’ of the air-contactor media may occur (not shown).

Referring to the solid line of FIG. 39, the inventors surprisingly found that the contactor media, systems, and methods disclosed herein have two domains of performance over similar operating conditions as illustrated by dashed line for conventional systems. In domain (d), at lower flows/fluxes of capture solution, mass transfer of the molecule of interest from the gaseous to liquid phase is rate limited due to saturation of the capture solution. At higher capture solution fluxes, in domain (e), an invariant domain can be achieved in which the mass transfer coefficient is relatively stable regardless of the fluid flow/flux. In this domain, which Inventor's believe is achieved and shown in FIG. 38, the wetted surface area of the media is stagnant. Thus, with the disclosed technology, it may be possible to achieve significantly higher mass transfer rates while potentially reducing the necessary fluid flow/flux.

### Example 7

The contactor medias, systems and methods disclosed herein, exhibit surprising and impressive performance over traditional packing materials. For example, a traditional contactor media performing direct air capture of carbon dioxide with 1.5 m/s airflow, a 5% KOH capture solution, and at 77F, will typically achieve about 10 PPM/ft CO₂ capture across the fill with about 10 Pa/ft pressure drop across the fill.

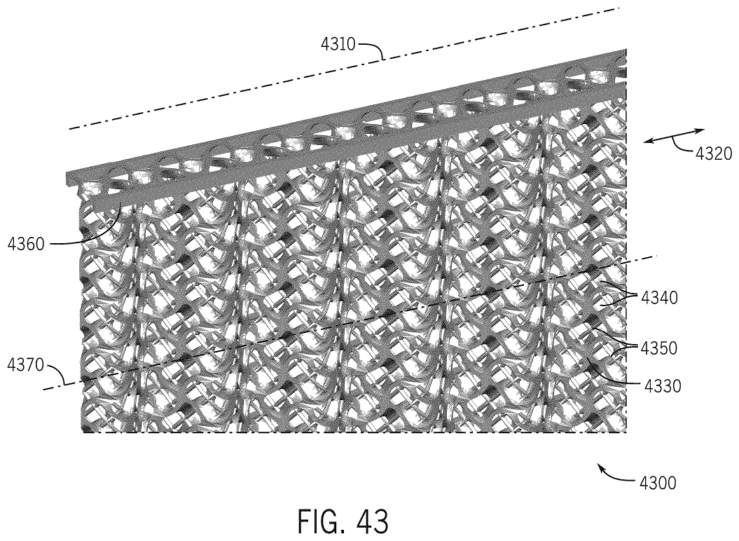

Unexpectedly, the contactor media, systems, and methods disclosed herein outperform traditional packing materials, systems, and methods. For example, using a contactor media with a grid lattice interstitial structure and corrugation, such as those seen in FIG. 43, 45, or 46, performing direct air capture of carbon dioxide with 1.5 m/s airflow, a 5% KOH capture solution, and at 77F, can achieve about 112 PPM/ft CO₂ capture across the fill at about 14 Pa/ft pressure drop across the fill.

In another interpretation of these unexpected performance results on a volumetric basis, for every linear foot of contactor media the air passes through, the contactor medias, systems and methods disclosed herein capture 11.2× more carbon dioxide than traditional packing materials, systems, and methods (per foot, the contactor media disclosed herein capture 112 PPM carbon dioxide while the traditional packing material captures 10 PPM carbon dioxide). Pressure drop is often used as a performance metric, e.g., as it may be directly proportional to the energy cost on the fans used to move air through the contactor media. On a pressure drop basis, for a 14 Pa pressure drop per foot, the contactor medias, systems and methods disclosed herein capture about 112 PPM of carbon dioxide. In contrast, the traditional packing material can capture only about 14 PPM CO₂ with the same pressure drop. Therefore, on a pressure drop basis, the contactor media, systems, and methods disclosed herein demonstrate an unexpected 8-fold improvement in carbon dioxide capture than traditional packing materials, systems, and methods. This corresponds to significant cost savings in electricity required to operate fans.

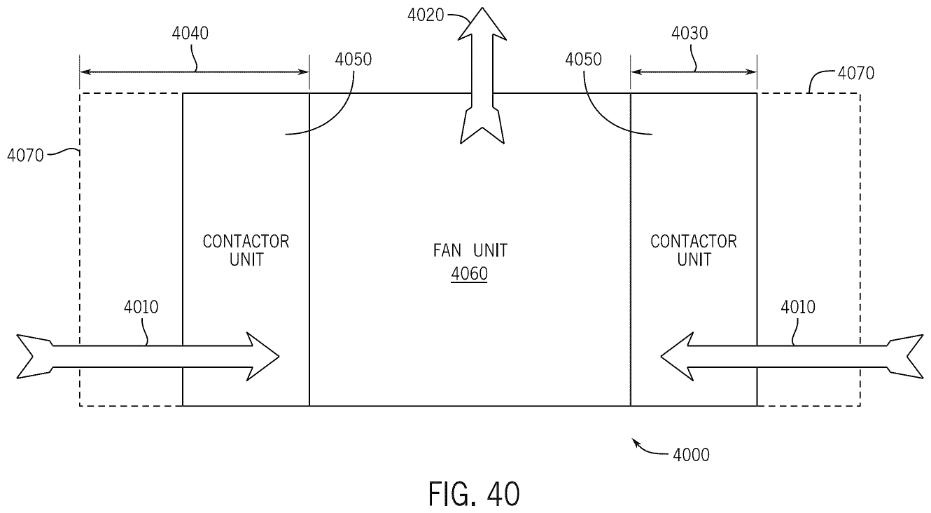

Further, these surprising performance results can be parlayed into further system and method advantages. For example, FIG. 40 shows a schematic of one embodiment of an air contactor unit 4000 as disclosed herein, including contactor media positioned on either side of a central fan unit 4060 configured to create a flow path for air rich in carbon dioxide 4010 to move past the contactor units (4050 or 4070) and to correspondingly create a flow path of air deplete in carbon dioxide out of the air contactor unit 4020. The contactor media 4050 may be one or more of the contactor media as disclosed herein. Indicated in dashed lines are the comparatively larger traditional packing stacks of contactor units 4070 required for equivalent carbon capture performance (not drawn to scale). The substantially reduced dimensions 4030 of the installed contactor media disclosed herein, along the flow direction of the air 4010, as compared to the comparatively larger dimensions 4040 of the traditional packing stacks to achieve the same carbon dioxide capture can correspond to reduced construction material and labor costs. For example, in some cases a required length of the dimension 4040 may be twice or more the required length of the dimension 4030.

### Example 7

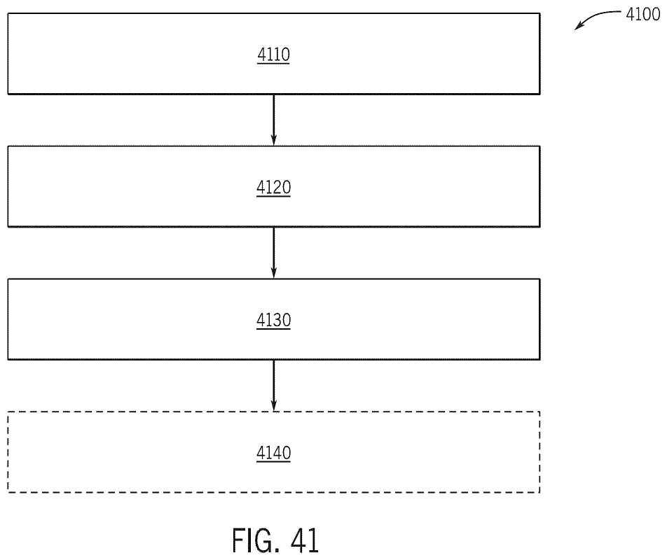

Referring now to FIG. 41, a method 4100 of capturing a material, e.g., carbon dioxide, is disclosed herein. In the illustrated example, dashed lines indicate optional features. The method 4100 includes wetting at least a portion of a contactor media with a capture liquid 4110. Wetting at least a portion of the contactor media can include any methods known in the art for applying a liquid to a solid surface, including misting, showering, pouring, soaking, or spraying the contactor media with a capture liquid. Any capture liquid suitable for carbon dioxide capture can be used, including basic aqueous solutions as described above and below. The capture liquid may wet at least a portion of the contactor media at a flow rate.

Any of the contactor media described herein may be used in this method, including contactor media having continuous surface segments, forming a contactor body, as described above and below. A first continuous surface segment has at least 50% of its surface area follow at least one contour selected from the group consisting of (a) a first contour of a first zero-thickness surface having a Gaussian curvature (“G_{c}”) of −400 mm⁻²≤G_{c}<−0.01 mm⁻²; (b) a second contour of a second zero-thickness surface having at least one principal curvature (kᵢ) of −20 mm⁻¹≤kᵢ<−0.1 mm⁻¹, or any combinations thereof. In some embodiments, the contour defines a first continuous capillary flow path transversing across the contactor body. In some cases, a second continuous capillary flow path transversing across the contractor body disposed below the first a first continuous capillary flow path. The first continuous capillary flow path and the second capillary continuous flow path are separated by inactive surfaces such that flow between the first continuous capillary flow path and second continuous capillary flow path crosses the inactive surfaces.

In some cases, flowing rich material across the contactor media is performed in a crossflow orientation where the flow the rich material is substantially parallel to the first continuous flow path. The crossflow orientation refers to the substantially perpendicular orientation of the flow direction of the rich material and the net flow direction of the capture liquid (e.g., downward, as driven by gravity).

In some cases, flowing rich material across the contactor media is performed in a counterflow orientation where the flow the rich material is substantially perpendicular or otherwise transverse to the first continuous flow path. The crossflow orientation refers to the substantially parallel and opposite to the orientation of the flow direction of the rich material and the net flow direction of the capture liquid.

Another aspect of the method includes flowing a rich material across the contactor media 4120. The rich material may include a fluid, liquid, gas, or any combination thereof. In the example of direct air capture, the rich material includes carbon dioxide. In some cases, the rich material may include ambient atmospheric gases, gases obtained from a point source emitter such as flue gas from industrial facilities, or a combination thereof. Flowing the rich material may include operating fans, pumps, or other known methods for moving a fluid, liquid, or gas at a given flow rate and/or pressure.

Another aspect of the method includes reacting the rich material with capture liquid 4130 to produce a deplete material and a captured material. In some cases, reacting the rich material with the capture liquid includes interacting the rich material and the capture liquid for a time period. In some cases, reacting the rich material with capture liquid may include controlling temperature, humidity, and contact time between the capture liquid and the rich material.

Optionally, the method can include transferring the captured material or the depleted material from the contactor media 4140. In some cases, transferring the captured material from the contactor media includes transferring the captured material to downstream operations for processing or regeneration in a captured materials processing unit, as described elsewhere herein. In some cases, the depleted material is a fluid, liquid, gas, or any combination thereof which has a lower concentration of carbon dioxide as compared to the rich material.

### Example 8

Referring to FIG. 42, the contactor media includes a contactor body 4200 including a first end 4270, a second end 4271. A first side 4272 extends between the upper 4270 and lower 4271 ends. A second side 4273 extends between the first 4270 and second ends 4271 opposite the first side 4272. A rear (or other) face 4277 extends between the first 4270 and second ends 4271 and between the first 4272 and second 4273 sides, and a front (or other) face 4276 extends between the first 4270 and second 4271 ends and between the first 4272 and second 4273 sides. The contactor body 4200 includes continuous surface segments 4210 that define internal flow areas of the contactor body 4200, between the front 4276 and rear 4277 faces, and openings 4274, 4275 at the front and rear faces 4276, 4277 (see also FIG. 51, for example) that open from the internal flow areas out the contactor body 4200. (As used herein, “front,” “rear,” and the like generally refer to the illustrated or potential orientation of particular examples, and are not intended to be limiting relative to the in-use orientation of a particular contactor body.)

The internal flow areas include, for example, a first capillary flow path 4240 and a second capillary flow path 4250. The first capillary flow path 4240 is in fluid communication with the second capillary flow path 4250 via one or more first openings 4274 of the openings. Each of the one or more first openings 4274 including a substantially closed boundary (e.g., closed perimeter 4278) at the front face 4276 of the contactor body 4200. Further, the first capillary flow path 4240 is in fluid communication with the second capillary flow path 4250 via one or more second openings 4275 of the openings, each of the one or more second openings 4275 including a substantially closed boundary (e.g., closed perimeter) at the rear face 4277 of the contactor body 4200.

As also discussed above and below, and applicable to other examples herein with similarly closed-boundary openings, the inclusion of a substantially closed boundary at faces of a contactor body (i.e., a boundary that is closed around 95% or more of the corresponding boundary perimeter at the relevant face of the contactor body) can provide a non-capillary flow path that provides fluid communication between adjacent capillary flow paths of a contactor body. Correspondingly, such openings can provide a path for fluid to move between capillary flow paths that may not be otherwise fluidly in communication (e.g., may not be connected by capillary or other flow paths within an interior flow area of the corresponding contactor body). Further, for example, use of inactive (or similar) surface profiles as boundaries of such openings can effectively provide a bias towards capillary flow along an associated (internal) capillary flow path, so that liquid may preferentially initially spread along a first capillary flow path via capillary action, before spilling over relevant opening boundaries, once the first capillary flow path is relatively full, to be available for capillary flow along a second capillary flow path (e.g., as shown at flow paths 4260 in FIG. 42).

In this regard, a preferred opening boundary may be a closed perimeter boundary (i.e., a continuous boundary around the full perimeter of the opening at the relevant face of the contactor body). This approach, for example, may usefully prevent unwanted (e.g., premature) spillage of liquid from the first capillary flow path via preservation of liquid film across the relevant opening (e.g., the openings 4274). Further, the closed perimeters (or, potentially, other substantially closed boundaries) may help to preserve films of liquids at the openings to provide improved exposure of the liquid for mass transfer (e.g., to cross- or counter-flow fluid streams, as variously discussed herein).

Some examples may include a substantially closed boundary formed as a closed perimeter (e.g., with an inactive surface extending fully around the relevant opening at the relevant face of a contactor body, as illustrated for the openings 4274). In other examples, however, other substantially closed boundaries can be used. Further, some examples may include partially closed boundaries, that are not necessarily substantially closed but include a closed perimeter segment oriented between adjacent (internal) capillary flow paths. In this regard, in some implementations, an inactive surface may be provided as at least part of a boundary of an opening along a first capillary flow path, with the inactive surface extending at least along a portion of the boundary that is interposed between the first capillary flow path and a second capillary flow path relative to a flow direction between the first and second capillary flow paths. For example, an inactive surface may provide a boundary along a lower portion of one or more of the openings 4274 of FIG. 42, interposed between the first and second capillary flow paths relative to a direction of gravity driven flow (e.g., along the flow path 4260).

Further with regard to openings to provide flow paths between internal capillary flow paths of a contactor body, some contactor bodies can include first and second capillary flow paths that are fluidly connected (i.e., in fluid communication with each other) only by one or more openings at one or more faces of the contactor body substantially along a length of the first (or second) capillary flow path (i.e., along at least 90% of the length or more, in total (e.g., at least 95%, at least 99%, etc.)—but not necessarily along 90% of the length continuously). In this regard, a length of the relevant flow capillary path is measured along the bulk direction of the capillary flow. For similar reasons as discussed above and below, such an arrangement can help to promote capillary flow along internal capillary flow paths, while still allowing significant exposure of liquid for mass transfer, and allowing effective overall distribution of liquid between—as well as along—multiple (e.g., parallel, internal) capillary flow paths.

Still referring to FIG. 42, disclosed herein is a contactor media 4200 with continuous surface segments 4210 having a gyroidal geometry containing an interstitial structure 4230 within the porous surface features 4220. In some cases, the interstitial structure may include an interpenetrating network. In some cases, the interstitial structure may include a lattice. In some cases, the lattice may include a square grid, a honeycomb grid, an isogrid, or any combinations thereof. In other cases, the interstitial structure may include non-lattice structures which dispose additional wettable surface area within porous surface features, such as cilia or hook-like structures.

Without wishing to be bound by theory, the addition of an interstitial structure within the gyroidal sheet increases the wettable surface area within the porous surface features 4220, thereby increasing the tendency of the contactor media 4200 to exhibit preferential capillary flow along flow paths in a first direction so that the flow paths are substantially wetted before fluid traverses an adjacent barrier structure to a successive flow path. In this regard, for example, as similarly discussed relative to FIGS. 30A and 30B, the contactor media 4200 may define adjacent flow paths 4240, 4250 (with portions of the flow paths that are hidden from view in FIG. 42 represented in dotted relief). The flow paths 4240, 4250 can provide capillary flow along substantially parallel (bulk) flow directions 4242, 4252, and can be separated by inactive surface barriers as also variously discussed above. Thus, during operation, liquid may preferentially fill the flow path 4240 before cascading over the inactive surfaces along flow paths 4260 and beginning to flow along (and fill) the flow path 4250.

In some examples, this combination of capillary and spill-over flow regimes (see flow paths 4240, 4250 and flow path 4260, respectively) can be enhanced or maintained by inclusion of the interstitial structure 4230 so that a particular (e.g., average) hydraulic diameter is provided along the flow paths 4240, 4250. For example, the interstitial structure 4230 in combination with the first continuous surface segment that defines the flow path 4240 (or 4250) can provide an average (or other) hydraulic diameter, Dh, that is sized between 0.2 mm and 4 mm. In this regard, hydraulic diameter is defined as 4*A/p, with A being the local area section along a plane perpendicular to bulk local flow bounded by a virtual surface (e.g., virtual plane) defined at any openings of the flow path at a face of a contactor (see, for example, virtual planes at a surface area of the first opening 4274 and a surface are of the second opening 4275 in FIG. 51, as defined by the planes of the front face 4276 and the rear face 4277, respectively, at the corresponding opening), and p being the wetted perimeter at the local area section

### Example 9

Referring to FIG. 43, disclosed herein is a contactor media 4300 with continuous surface segments 4330 having a gyroidal geometry containing an interstitial structure 4350 within the porous surface 4340. In some cases, the interstitial structure may include an interpenetrating network. In some cases, the interstitial structure may include a lattice. In some cases, the lattice may include a square grid, a honeycomb grid, an isogrid, or any combinations thereof. As shown in FIG. 43, the interstitial structure 4350 is a rectangular (e.g., square) grid.

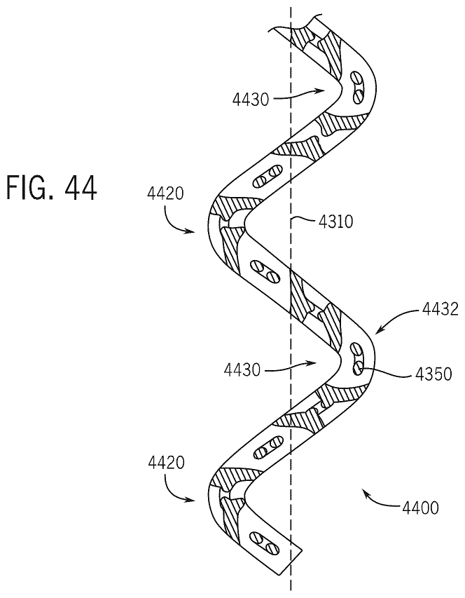

As shown in FIGS. 43 and 44, the contactor media includes corrugations (e.g., repeated smoothly curved ridges and valleys, or other undulations). In particular, the corrugations of the example of FIG. 43 propagate (e.g., are repeated) along an axis 4310 that is substantially parallel to the direction of the first continuous capillary flow path 4320. Correspondingly, for example, continuous capillary flow paths of the contactor media 4300 may extend across one or more of the corrugations (e.g., may traverse multiple corrugations, so as to correspondingly define a locally undulating flow path along a bulk flow direction). The contactor media further includes a rib 4360 positioned at a terminal end for improved structural properties, and may include other similar ribs or structural reinforcements at other locations, as appropriate.

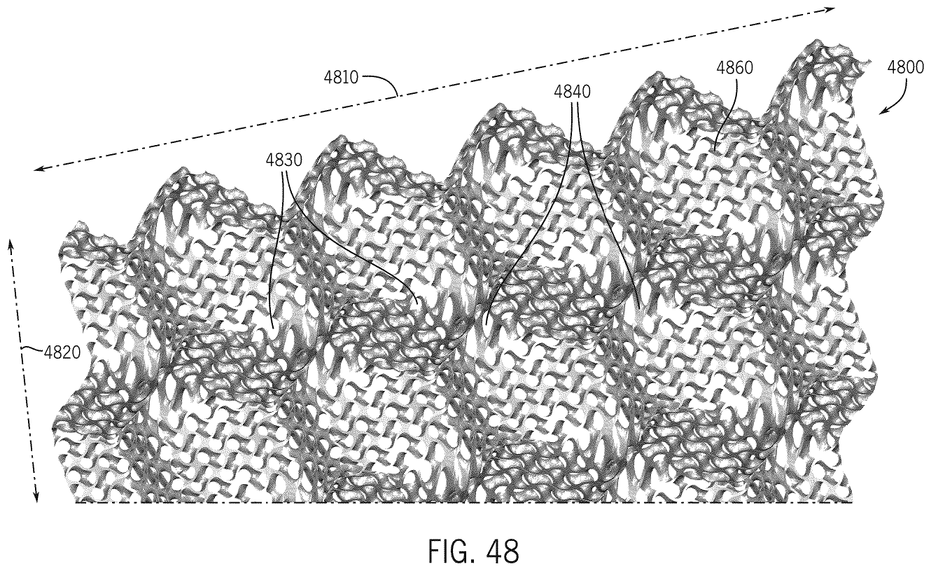

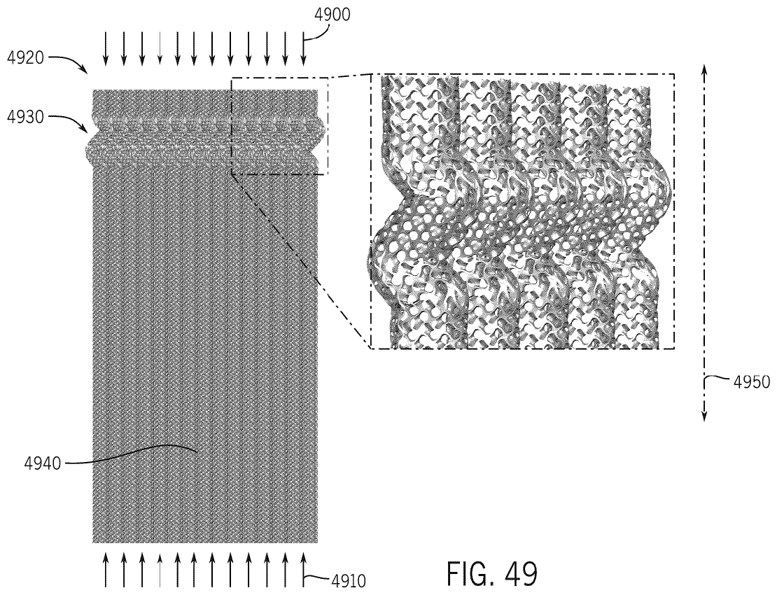

Still referring to FIGS. 43 and 44, the illustrated corrugations are 1D corrugations, meaning that the illustrated peaks and valleys extend along parallel corresponding axes. In particular examples, including as shown in FIG. 43, 1D corrugations may be formed as a series of single-axis corrugations (i.e., corrugations that exhibit bends about a single axis to form a corresponding peak or valley). As also discussed below, multi-axis corrugations may be possible in other examples (i.e., corrugations with peaks and valleys defined by multiple non-parallel (e.g., perpendicular) axes). In some examples, including as illustrated in FIGS. 48 and 49, multi-axis corrugations may be formed as 2D corrugations, in which peaks (e.g., ridges) and valleys are formed by sets of axes extending along two perpendicular directions.

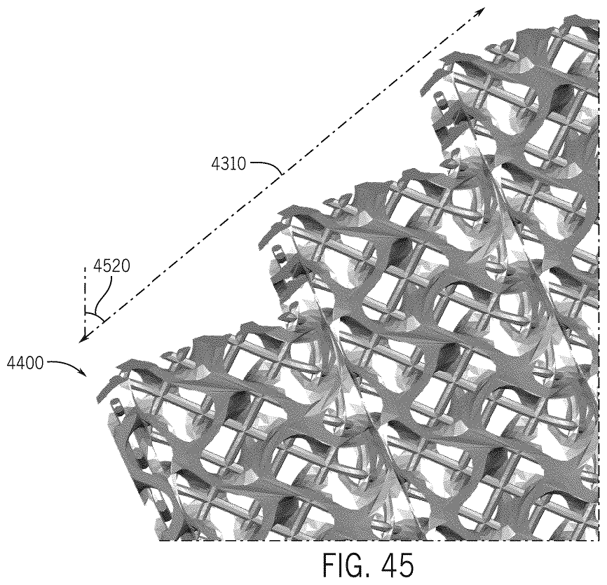

Referring to FIGS. 44 and 45 in particular, a cross section is shown of the contactor media 4400 shown in FIG. 43, taken along cross section plane 4370. It can be seen in FIG. 44, in particular, that the size of openings in the contactor structure may vary along the corrugation, due to the geometric effects of ridges 4420 and valleys 4430, as propagated along axis 4310 (e.g., which is substantially parallel to the direction of the first continuous capillary flow path). In some cases, the axis along which the corrugations propagate may be oriented at any angle 4520 between substantially parallel and substantially perpendicular to the direction of the first continuous capillary flow path). In some cases, the axis may be oriented at about 45 degrees on a first contactor body and about −45 degrees on a second contactor body. The first contactor body may be positioned adjacent to the second contactor body during use. In some cases, the axis may be oriented at about 60 degrees on a first contactor body and about-60 degrees on a second contactor body. The first contactor body may be positioned adjacent to the second contactor body during use.

Interstitial structure may be helpfully implemented at these locations, in addition (or alternatively) to along sections of the contactor media 4400 between the ridges 4420 and valleys 4430. For example, as shown in FIG. 44, an opening 4432 may be comparatively large because located opposite the curvature of the valley 4430. Inclusion of the interstitial structure 4350 within the opening 4432 may help to ensure that capillary flow remains the dominant regime along the corresponding flow path until the flow path is sufficiently filled to allow cascading of fluid over the corresponding inactive surface barrier to the successive flow path (e.g., by preserving sufficiently small local hydraulic diameter, as also discussed above).

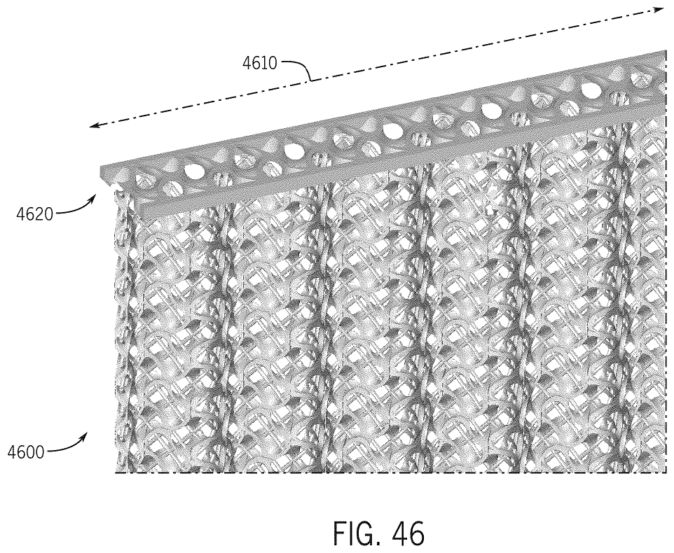

Referring to FIG. 46 one embodiment of a contactor media 4600 as disclosed herein, containing a square grid interstitial structure within a gyroidal contactor media, and including 1D corrugations. The 1D corrugations propagate along axis 4610. The contactor media 4600 further includes a rib 4620 positioned at a terminal end for improved structural properties. The contactor media 4600 may exhibit different overall scales as compared to the contactor media 4500, but otherwise similar structures and expected flow effects.

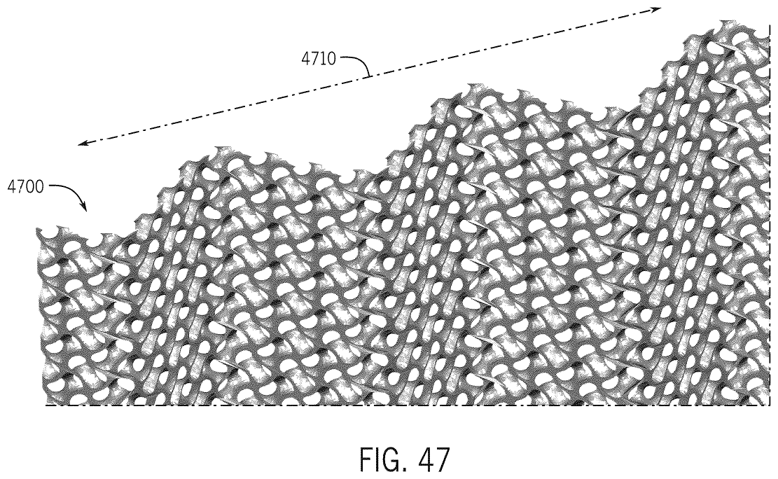

In some examples, as further discussed below, the curvature of peaks (e.g., ridges) and valleys of a corrugation can be varied to control the size of corresponding openings (e.g., to ensure operation in preferable flow regimes, as discussed relative to FIG. 37). For example, referring to FIG. 47, a contactor media 4700 can include 1D corrugations (propagated along axis 4710) that exhibit larger effective radii of curvatures than the contactor media 4400 of FIG. 43 at corresponding peaks and valleys of the corrugation. Accordingly, the relatively larger sizes of the openings along curved portions of the corrugations may be maintained within a desired scale to promote desired capillary flow without necessarily including interstitial structures. However, interstitial structures may still be included in some cases, including to provide structural rigidity or otherwise promote desired performance characteristics.

FIG. 48, shows a drawing of one embodiment of a contactor media 4800 as disclosed herein. This embodiment includes corrugations along multiple non-parallel axes (i.e., includes multi-axis corrugations). In particular, in the illustrated example, the multi-axis corrugations includes corrugations along axis 4810 and along axis 4820, which is substantially perpendicular to axis 4810. Thus, in the illustrated example, the contactor media 4800 includes an egg-carton-like structure having a grid-like array of peaks 4830 and valleys 4840 along substantially perpendicular axes. Aside from providing improved flow and contact characteristics for particular applications, such an arrangement can help to prevent loss of liquid that may otherwise fall along axes of corrugations that are solely aligned with gravity (as also discussed below).

As similarly discussed above, the porous surface features 4860 change in size depending on where they are located relative to a peak 4830 or valley 4840 or on the slope between the two. In some cases, the porous surface features 4860 are larger at the hilltop 4830 and in the valley 4840 as compared to the porous surface features 4860 along the slope between the hilltops 4830 and valleys 4840. Correspondingly, in some cases, interstitial structure can be selectively included along the contactor media 4800 (e.g., as discussed relative to FIGS.>42-47).

### Example 10

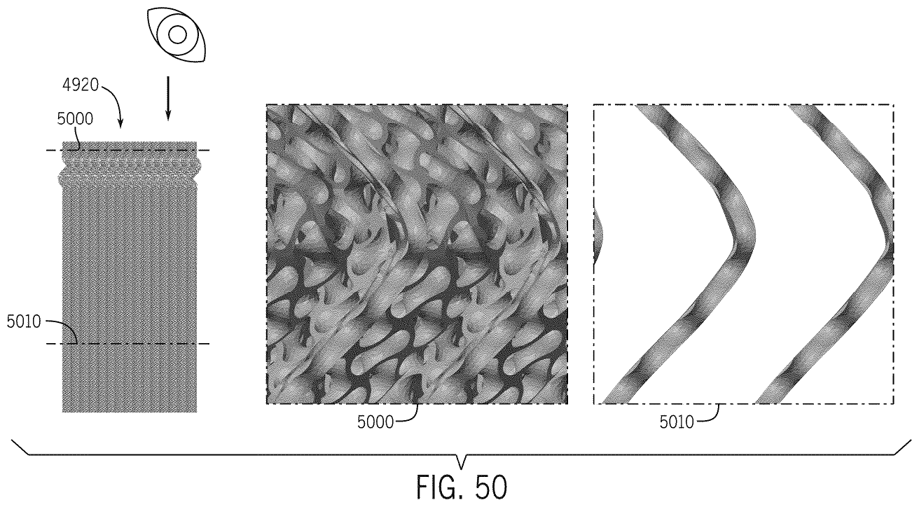

FIG. 49 shows a drawing of one embodiment of a contactor media 4920, used in counter flow geometry, as disclosed herein. The contactor media includes a 2D corrugation positioned proximal to the capture fluid inlet (e.g., within 10% of a length of the contactor media 4920 from a fluid-entrance end). FIG. 50 shows top-down, cross section views of the contactor media 4920, also as used in counter flow operation.

As with other contactor bodies discussed herein, the contactor body can include continuous surface segments. A first continuous surface segment can have at least 50% of its surface area follow at least one contour selected from the group consisting of (a) a first contour of a first zero-thickness surface having a Gaussian curvature (“G_{c}”) of −400 mm⁻²≤G_{c}<−0.01 mm⁻²; (b) a second contour of a second zero-thickness surface having at least one principal curvature (kᵢ) of −20 mm⁻¹≤kᵢ<−0.1 mm⁻¹, or any combinations thereof. In some cases, as similarly illustrated in other figures (e.g., FIGS. 30B and 42), the contour defines a first continuous capillary flow path transversing across the contactor body and a second continuous capillary flow path transversing across the contractor body disposed below the first a first continuous capillary flow path. The first continuous capillary flow path and the second capillary continuous flow path can be separated by inactive surfaces such that flow between the first continuous capillary flow path and second continuous capillary flow path crosses the inactive surfaces.

Referring to FIG. 49, in some cases, a 2D corrugation 4930 positioned proximal to where the capture fluid is introduced to the contactor media 4920 may be used to intercept (e.g., catch) incoming falling capture fluid 4900 and direct the intercepted capture fluid it onto the rest of the 1D corrugated sheet 4940. In FIG. 50, a top-down perspective view shows how the 2D corrugation can allow the contactor media 4920 to intercept, and thereby catch, liquid that would otherwise fall along a downward path without being captured by the contactor media 4920 (e.g., liquid falling along a valley of a 1D corrugation or otherwise between adjacent contactor sheets). In particular, as shown in the inset partial cross-section along plane 5000, the 2D corrugation shown at 5000 presents a (projected) complete barrier to falling fluid. In contrast, as shown in the inset partial cross-section along plane 5010, the 1D corrugation presents (projected) open spaces through which liquid may fall without touching the contactor media 4920. Thus, for example, the initial exposure of liquid to the 2D corrugation can help to prevent loss of fluid that might otherwise fall past the contactor 4920 without being captured for mass transfer.

In the illustrated example, the 2D corrugation propagates along axis 4950, which is substantially parallel to the net direction of the flow of capture fluid, substantially parallel to the net direction of the flow of rich material, and substantially perpendicular to the first continuous capillary flow path. In this embodiment, the direction of the rich material flow 4910 is in a counter flow orientation where the direction of the flow of the rich material and the direction of the flow of the capture fluid are opposite directions. However, similar contactors can be used with other flow arrangements (e.g., with a cross-flow configuration as generally illustrated in FIGS. 1-5). Further, the 2D corrugation can also propagate along axis 4952, which is substantially perpendicular to the axis 4950. In some examples, the 2D corrugation can transition from and to a 1D corrugation that extends along the axis 4950 (or another axis substantially parallel to the falling direction of the capture fluid 4900.

In closing, to further amplify discussion above, it is noted that gas-liquid contactors can be used in large-scale capture of CO₂ from the atmosphere, commonly referred to as DAC of CO₂. DAC processes include passing ambient air containing CO₂ across a CO₂ capture media (sometimes referred to as a ‘contactor’ or an ‘air contactor’ or ‘packing material’) which is commonly either a solid sorbent or a liquid sorbent. The sorbent interacts with gaseous CO₂ to form a CO₂-enriched capture solid or CO₂-enriched capture liquid. Solid sorbents are appealing for their low energy input, low operating cost, and applicability to a wide range of operation scales. Solid sorbents, however, require periodic regeneration to refresh the CO₂-reactive surface by cycling temperature, pressure, and humidity conditions. Liquid sorbents offer several advantages over solid sorbents in that contactor can operate continuously, can be incorporated into established cooling-tower hardware, and the flowing liquid surface is continuously renewed allowing for long contactor lifetimes. Further, the CO₂-enriched capture liquid can be easily pumped to a centralized regeneration unit, without needing to stop the gas-liquid contactor operation.

Basic aqueous solutions, such as aqueous metal hydroxide solutions, can serve as liquid sorbents to enable capture and recovery of CO₂ using established chemistries. These chemistries can be utilized in two connected, recycling loops and can occur across, for example, four operation units: (1) Air Contactor, (2) Pellet Reactor, (3) Calciner, and (4) Slaker to ultimately produce captured CO₂. Within the Air Contactor Unit, the first loop captures CO₂ from the atmosphere by reacting gas-phase CO₂ in the ambient atmosphere with an aqueous metal hydroxide, such as potassium hydroxide (KOH), to form liquid water and aqueous metal carbonate, such as potassium carbonate (K₂CO₃). Within the Pellet Reactor Unit, the aqueous metal carbonate can be reacted with another solid metal hydroxide, such as calcium hydroxide (Ca(OH)₂), to regenerate the aqueous metal hydroxide used in the Air Contactor Unit and a solid metal carbonate precipitate, such as calcium carbonate (CaCO₃). The metal carbonate can be supplied to a second chemistry loop in a Calciner Unit, which decomposes the metal carbonate to a solid oxide, such as calcium oxide (CaO) and carbon dioxide. The metal oxide solid can be, in a Slaker Unit, be hydrated with water to form a metal hydroxide, such as calcium hydroxide (Ca(OH)₂), which can then be resupplied to the Pellet Reactor Unit, completing the loop.

The initial interaction of gaseous CO₂ in ambient atmosphere with a liquid sorbent a gateway to the efficiency, cost-effectiveness, and performance of the overall DAC process. This interaction, enabled by an air contactor, is typically limited by a reaction-diffusion process occurring in the liquid film of the liquid sorbent flowing through the air contactor structure. Operational costs of the air contactor, including the energy required for powering pumps to flow the liquid sorbent across the air contactor and fans to flow the ambient atmosphere across the air contactor, represent a large portion of the capital costs of the overall DAC process described above. Accordingly, the technology presented herein can address a significant need in the field for contactor medias which have increased gas-liquid interactive surface areas while also using a geometry that decreases operational costs.

### Example 11

FIG. 51 shows an axial view illustration of contactor media 5100 (e.g., the contactor media of FIG. 29A) looking down axis 5170 oriented perpendicular to the page. The contactor media has a front face 4276 and a rear face 4277. The front face 4276 includes a first opening 4274. The rear face 4277 includes a second opening 4275. When the contactor is wetted (shown in grey shading), these openings contain liquid which, along the plane of the front face 4276 and the rear face 4277 where mass transfer can occur, forming an active mass transfer surface area. Penetrating at least a portion of the contactor media are internal flow areas including continuous capillary flow paths, such as a first continuous capillary flow path 5160. Separating the continuous capillary flow paths is mass transfer inactive surface area 5150, oscillating between the front face 4276 and a rear face 4277. Mass transfer inactive surface area 5150 is inactive in mass transfer because it is either not wetted or it is located far enough removed from the front face 4276 to not be exposed to mass transfer exchange with the relevant external flow (e.g., located more than about 50 micrometers from the front face 4276 or rear face 4277).

Referring to FIG. 52, which shows a cross-sectional illustration of full surface wetting of a gyroidal contactor medium 5200, as similarly shown in FIG. 15 partially wetted. Penetrating at least a portion of the contactor media are internal flow areas including continuous capillary flow paths, such as a first continuous capillary flow path running substantially parallel to axis 5230 oriented perpendicular to the page. When the contactor media volume 5214 is wetted (e.g., at wetted volume 5222, indicated by grey shading), the bounds of the internal flow areas are defined by active wetted surfaces 5210, which are inactive mass-transfer surfaces, and by active mass transfer surfaces 5220.

Still referring to FIG. 52, the active wetted surfaces 5210, which are inactive mass-transfer surfaces, are defined by boundary regions where the curvatures (e.g., mean curvature, principle curvature, etc.) do not favor wetting (i.e. Gibbs free energy of wetting the surface is unfavorable; e.g., ΔG_{wetting}⁵²¹⁰≥0). The wetted volume 5222 are regions where the curvatures do favor wetting (i.e. Gibbs free energy of wetting the surface is favorable; e.g., ΔG_{wetting}⁵²²²≤0). As such, a liquid would inherently be repelled from the active wetted surface 5210 and pulled spontaneously into the wetted volume 5222 (i.e., ΔG_{wetting}⁵²²²<ΔG_{wetting}⁵²¹⁰) via capillary forces. Inventors surprisingly identified the range of these curvatures which gives rise to the capillary action using the contactor media disclosed herein, as well as the slices and other geometric approaches discussed herein that can exploit this relationship for beneficial contactor geometry (and correspondingly improved liquid flow and related transfer phenomenon).

The contactor media disclosed herein include a bi-lobed shaped cross-section (e.g., peanut-shaped) openings (see, for example 1420 in FIG. 14B or the openings 4274 and 4275 in FIGS. 42 and 51). The bi-lobed shaped cross-section maximizes the contact area for liquid-gas exchange along, for example, the front face 4276 and rear face 4277, when the contactor is wetted. The Inventors discovered approaches to contactor construction that effectively isolate and otherwise exploit a bi-lobed shaped cross-section in gyroid geometries, which maximizes the wetted volume surface area (for example, the surface areas bounded by the openings 4274 and 4275 of FIG. 51) while minimizing the surface area of the active wetted areas (which are areas inactive in mass-transfer, see for example 5210 in FIG. 52). Other TPMS structures may have another ideal cross-sectional cut of their unit cell which may also (and similarly) maximize the liquid-gas exchange rate or other flow phenomenon, as variously disclosed herein.

### Example 13

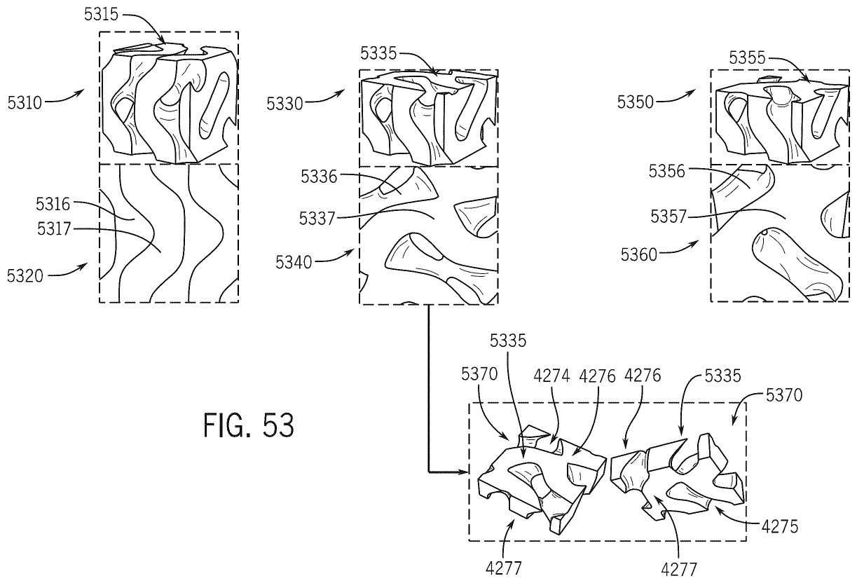

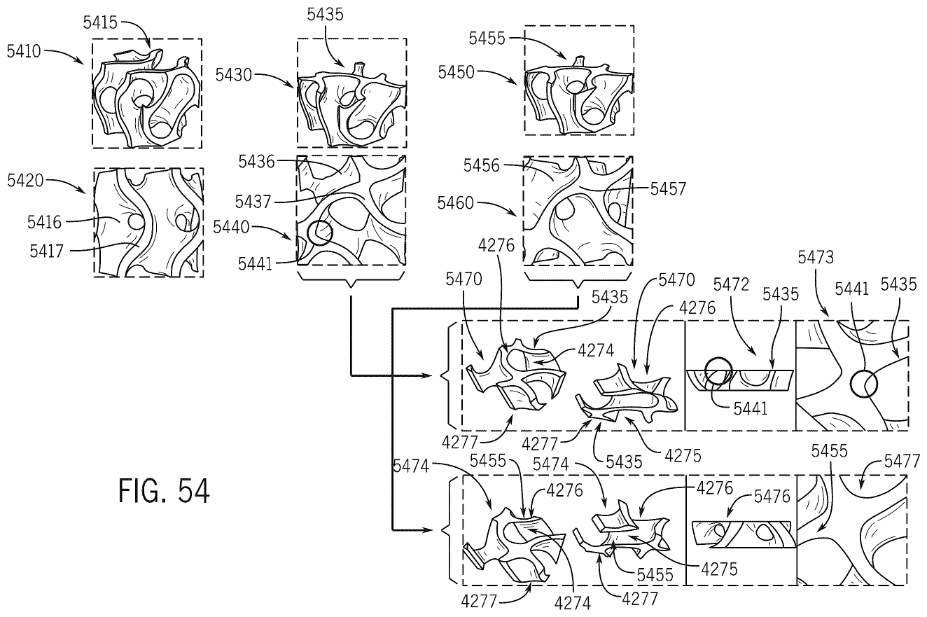

FIGS. 53-54 show illustrations, in axonometric view, of a 5 mm gyroidal contactor unit cell with a 1 mm and 0.3 mm wall thickness, respectively.

Referring to FIG. 53, the left panel shows the full unit cell of a 5 mm gyroidal contactor unit cell 5310 with a 1 mm wall thickness, having a top plane 5315. A top-down view 5320 shows open surface area 5316 which, when the contactor unit cell 5310 is wetted, is wettable volume surface area. Also shown are areas of inactive surface area 5317, which may not wet under desired conditions, and thus may not contribute to mass transfer.

The center panel of FIG. 53 shows a view of a 73% portion of the unit cell 5330 of a 5 mm gyroidal contactor unit cell with a 1 mm wall thickness is shown. The 73% portion of the unit cell 5330 is produce by sectioning the full unit cell along plane 5335, 73% of a unit length from the bottom of the unit cell. A top-down view 5340 shows open surface area 5336 which, when the contactor unit cell 5330 is wetted, is wettable volume surface area. Also shown are areas of inactive surface area 5337, which may not contribute to mass transfer.

FIG. 53 further shows top view and bottom view of a slice 5370 beginning at about a 73% portion of the full unit cell 5330. In some cases, the slice may be about a 25% slice of the full unit cell 5430. In some cases, the slice may begin (or end) at a different percentage portion (or offset) of a unit cell. As shown, the about 25% slice 5370 corresponds to about a 1.25 mm slice thickness.

As used herein, a “slice” refers to a portion of a whole unit cell which has at least two planar (or other) boundaries, each of which extend across the unit cell, between a first end and a second end of the unit cell, and which collectively exclude a portion of the unit cell from the slice. The planar boundaries, as show in FIG. 53, can be substantially parallel to one another with a constant distance separating the planar boundaries. In some cases, the distance between the planar boundaries is variable. In some cases, the planar boundaries are substantially perpendicular to one another. In some cases, the planar boundaries are oriented at an angle respective to one another. In some cases, there are more than two planar boundaries defining a slice. Using FIG. 53 as an example, the planar boundaries can be a front face 4276 and a rear face 4277 and the distance between the front face 4276 and the rear face 4277 can correspond to about 25% of the full unit cell. In some cases, the distance between the planar boundaries can be about 1.25 mm.

Shown in the top (left) and bottom (right) views of the slice 5370 are bi-lobed shaped cross-section (e.g., peanut-shaped) openings exposed by the front face 4276 and the rear face 4277, including a first opening 4274 and a second opening 4275. As shown in FIG. 53, the openings are positioned on opposite side of the slice.

Still referring to FIG. 53, the right panel shows an axonometric view of a 62.5% of the unit cell 5330 of a 5 mm gyroidal contactor unit cell with a 1 mm wall thickness, having a top plane 5315. A top-down view 5360 shows open surface area 5316 which, when the contactor unit cell 5356 is wetted, is wettable volume surface area. Also shown are areas of inactive surface area 5357, which does not wet and does not contribute to mass transfer.

With respect to FIG. 53, in view of the discussion above, it can be seen that the slice 5370 can be repeated in adjacent arrangement to form a contactor body with inactive closed-perimeter openings on opposing faces, and with a series of internal capillary flow paths (e.g., as variously discussed above, and illustrated in FIG. 42, etc.). In this regard, in particular, the resulting internal capillary flow paths may not be connected by internal flow paths. In other words, the resulting contact body may not include an internal (or other) capillary flow path arranged to provide substantial capillary flow from a first (internal) capillary flow path and a second (internal) capillary flow path. Correspondingly, the beneficial flow patterns discussed relative to FIG. 42 and elsewhere can be readily obtained.

Referring now to FIG. 54, the left panel shows the full unit cell of a 5 mm gyroidal contactor unit cell 5410 with a 0.3 mm wall thickness in axonometric view, having a top plane 5415. A top-down view 5420 shows open surface area 5416 which, when the contactor unit cell 5410 is wetted, is wettable volume surface area. Also shown are areas of inactive surface area 5417, which does not wet and does not contribute to mass transfer.

In the center panel of FIG. 54, an axonometric view of a 73% portion of the unit cell 5430 of a 5 mm gyroidal contactor unit cell 5430 with a 0.3 mm wall thickness is shown. The 73% portion of the unit cell 5430 is produce by sectioning the full unit cell along plane 5435. A top-down view 5440 shows open surface area 5436 which, when the contactor unit cell 5430 is wetted, is wettable volume surface area. Also shown are areas of inactive surface area 5437, which does not contribute to mass transfer. A sharp corner 5441 is shown in the top-down view. In some examples, a more rounded corner may be desirable, although benefits of a closed/inactive boundary as discussed above may still result.

FIG. 54 further shows top and bottom views of a slice 5470 of a 73% portion of the full unit cell 5430. In some cases, the slice may be about a 25% slice of the full unit cell 5430, although the slice may begin (or end) at a different percentage portion (or offset) of a unit cell. Using FIG. 54 as an example, the planar boundaries can be a front face 4276 and a rear face 4277 and the distance between the front face 4276 and the rear face 4277 can correspond to about 25% of the full unit cell. In some cases, the distance between the planar boundaries can be about 1.25 mm.

Shown in the top (left) and bottom (right) views of the slice 5470, taken from the 73% portion of the unit cell 5430, are bi-lobed shaped cross-section (e.g., peanut-shaped) openings exposed by the front face 4276 and the rear face 4277, including a first opening 4274 and a second opening 4275. As shown in FIG. 53, the openings are positioned on opposite side of the slice. Also shown are an axial view and a closer top-down view of slice 5470, taken from the 73% portion of the unit cell 5430.

Still referring to FIG. 54, the right panel shows an axonometric view of a 62.5% portion of the unit cell 5450 of a 5 mm gyroidal contactor unit cell with a 0.3 mm wall thickness, having a top plane 5455. A top-down view 5460 shows open surface area 5456 which, when the contactor unit cell 5450 is wetted, is wettable volume surface area. Also shown are areas of inactive surface area 5457, which does not wet and does not contribute to mass transfer.

Shown in the top (left) and bottom (right) views of the slice 5474, taken from the 62.5% portion of the unit cell 5450, are bi-lobed shaped cross-section (e.g., peanut-shaped) openings exposed by the front face 4276 and the rear face 4277, including a first opening 4274 and a second opening 4275. As shown in FIG. 54, the openings are positioned on opposite side of the slice. Also shown are an axial view and a closer top-down view of slice 5474, taken from the 73% portion of the unit cell 5450.

With respect to FIG. 54, as similarly discussed relative to FIG. 53 and again in view of the discussion above, it can be seen that the slices 5470, 5474 can be repeated in adjacent arrangement to form respective contactor bodies with inactive closed-perimeter openings on opposing faces, and with a series of internal capillary flow paths (e.g., as variously discussed above, and illustrated in FIG. 42, etc.). In this regard, in particular, the resulting internal capillary flow paths may not be connected by internal flow paths. In other words, the resulting contact body may not include an internal (or other) capillary flow path arranged to provide substantial capillary flow from a first (internal) capillary flow path and a second (internal) capillary flow path. Correspondingly, the beneficial flow patterns discussed relative to FIG. 42 and elsewhere can be readily obtained

### Example 14

The contactor media disclosed herein may have a range of sizes, wall thicknesses, and curvatures. It may be desirable to select unit cell sizes and wall thicknesses of gyroidal contactor media which generate curvatures and opening sizes that favor liquid wetting of the contactor media surface. In some cases, maximized wetted surface area for maximized mass transfer is desirable. Inventors discovered that, in some cases, one or more subsections or slices of the unit cell may expose curvatures and openings on scales and orientations which create flow paths, including one or more continuous capillary flow paths, which favor liquid wetting (e.g., enhance retention of the liquid in the contactor media) of the contactor media surface and maximized wetted surface area for maximized mass transfer at a liquid-gas interface.

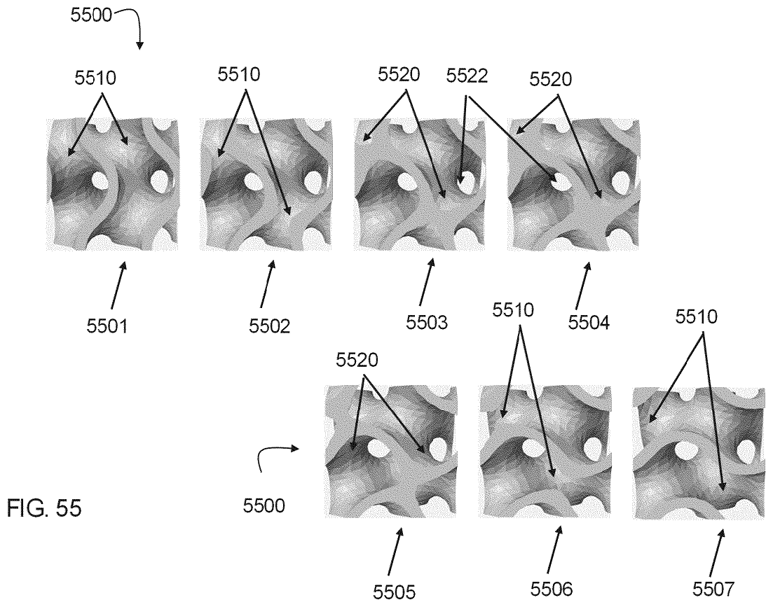

FIG. 55 shows top-down cross section views of a 5 mm gyroidal unit cell 5500 at various offsets (e.g., a cross-sectional plane bisecting the unit cell at a position offset from an outer surface of the full unit cell) within the unit cell 5500. The offset can be described as a percentage (e.g., the location of the cross-sectional plane bisecting the unit cell/unit cell size=%). Offsets which expose one or more open paths 5510 at the surface of the contactor body may not provide desired flow geometry, due to the inclusion of external continuous capillary flow paths that could lead to undesired fluid draining. In contrast, offsets which expose one or more closed boundaries 5520 at the surface of the contactor body may form desired flow geometry, including one or more internal continuous capillary flow paths with openings 5522, e.g., with inactive surfaces inhibiting external capillary flow, and (e.g., with appropriate slice percentages) without internal fluid connection between those flow paths. This latter approach can remarkably enhance retention of the liquid in the contactor media and result in maximized wetted surface area for maximized mass transfer at a liquid-gas interface.

Referring to the particular example shown in FIG. 55, an offset of 0% (0.00 mm location of the cross-sectional plane bisecting the unit cell/5 mm unit cell) of a 5 mm unit cell 5501 shows open external paths 5510. An offset of 9.6% (0.48 mm location of the cross-sectional plane bisecting the unit cell/5 mm unit cell) of a 5 mm unit cell 5502 also shows open external paths 5510. An offset of 11.4% (0.57 mm location of the cross-sectional plane bisecting the unit cell/5 mm unit cell) of a 5 mm unit cell 5503 shows closed boundaries 5520 and correspondingly closed-off capillary flow paths. An offset of 12.5% (0.63 mm location of the cross-sectional plane bisecting the unit cell/5 mm unit cell) of a 5 mm unit cell 5504 shows similar closed boundaries 5520, as does an offset of 18.0% (0.90 mm location of the cross-sectional plane bisecting the unit cell/5 mm unit cell) of a 5 mm unit cell 5505. An offset of 19.4% (0.97 mm location of the cross-sectional plane bisecting the unit cell/5 mm unit cell) of a 5 mm unit cell 5506 shows open external paths 5510, as does an offset of 25.0% (1.25 mm location of the cross-sectional plane bisecting the unit cell/5 mm unit cell) of a 5 mm unit cell 5507.

As also discussed above, surprisingly beneficial flow performance can be obtained by selecting appropriate offset(s) of the gyroidal contactor media unit cell that expose the closed boundaries 5520 on two or more opposing sides of the resulting slice (e.g., while preserving internal capillary flow paths that are not internally connected for substantial capillary flow). In some cases, it may be desirable to select two or more offsets of the gyroidal contactor media unit cell which exposes closed boundaries 5520 on one side of the resulting slice.

A person of skill in the art will appreciate that the nature of repeating unit cells allows for repetition (e.g., multiples of) of cross sections which expose substantially equivalent slices. For example, in some cases a slice of the gyroid unit cell having a thickness of about 25% of a unit thickness of the gyroid unit cell may have desirable features. Multiples of 25% (i.e. half a unit cell, 75% of a unit cell, 100% of a unit cell, 125% of a unit cell . . . 250% of a unit cell . . . 2,500% of a unit cell) produce substantially equivalent slices. As noted above, however, it may be desirable in some cases for a slice thickness to exhibit external openings with closed boundaries in combination with internal capillary flow paths that are not in fluid communication via interlinking internal flow paths.

### Example 15

Using the 5 mm unit cell with 0.3 mm thick walls seen in FIG. 54 as an example, there are a range of unit cell sizes and wall thicknesses of the gyroid, h, which give rise to surface contours with geometries that, when wetted, form flow paths, including one or more continuous capillary flow paths, which remarkably enhance retention of the liquid in the contactor media and result in maximized wetted surface area for maximized mass transfer at a liquid-gas interface. For example, for a Unit Cell Size=a, and Thickness Off of Zero-Thickness 2D Surface=h:

$$\begin{matrix}for 1 mm < a < 10 mm , 0.01 < h / a < 0.5 \\ for 0.2 mm < a < 1 mm , 0.05 < h / a < 0.5\end{matrix}$$

Again, using the 5 mm unit cell with 0.3 mm thick walls seen in FIG. 54 as an example, selecting a slice of the gyroidal unit cell which maximizes the wetted surface area to maximize liquid/gas transfer without detrimentally limiting strength can be achieved with the following guidelines:
(i) (h/a) minimized while still meeting structural requirements to hold the weight of the total liquid hold-up (e.g., a=5 mm and h/a=0.06); and

$$( ii ) ( α + 0.25 n ) < ( Offset / a ) < ( α + 0.1 + 0.25 n ) for n = 0 , 1 , 2 , 3 , 4 , 5 , 6$$

α=0.08 for the 5 mm unit cell with a 0.3 mm wall thickness shown in FIG. 54. Accordingly, the Offsets which correspond to slices showing desirable wetted surface area to maximize liquid/gas transfer occur at these ranges: 8%-18%; 33%-43%; 58%-68%; 83%-93%; 108%-118%; 133%-143%, and beyond. In this regard, it can be seen that choosing adjacent sets of Offset ranges (as above, or as similarly determined for other gyroid geometries) can provide slices with beneficial flow characteristics (e.g., as also variously described above).

### Example 16

In some cases, the contactor media disclosed herein may be used as mist eliminators. Mist eliminators can be critical components in gas-liquid separation systems, specifically designed to capture fine liquid droplets entrained in gas streams. In many industrial processes-including absorption, distillation, or scrubbing-mist eliminators prevent liquid carryover, reduce product loss, and protect downstream equipment.

Corrugated plastic mist eliminators can include engineered plastic sheets, e.g., formed into wave-like or chevron patterns. These corrugations create a high-surface-area network of passageways that force the gas stream through sharp turns and narrow channels. As the gas flows through these paths, entrained droplets are subjected to inertial impaction, interception, and coalescence on the surface of the corrugations. Once coalesced into larger droplets, gravity or capillary forces direct the liquid away from the gas stream, thus achieving efficient mist removal.

In counter-flow systems, gas flows upward while the collected liquid drains downward through the corrugated channels. The corrugation geometry enhances liquid-gas disengagement by maximizing surface contact and enabling drainage without re-entrainment. In cross-flow reactors, where gas travels horizontally and liquid drains vertically, the structured corrugations channel the gas across a tortuous path, enhancing droplet impingement and separation efficiency. This geometry also minimizes pressure drop while maintaining a high degree of mist capture, especially useful when handling high gas velocities or fine aerosol mists.

In some examples, layered plastic corrugations, e.g., in multiple orientations, can optimize droplet capture for specific operating conditions. The use of plastic materials allows for lightweight, corrosion-resistant designs ideal for harsh chemical environments, including in chlorine gas drying, acid scrubbers, or caustic absorbers.

In some implementations, it may be preferred to use contactor media disclosed herein with corrugations, to provide improved demister performance. In some such examples, the spacings between contactor bodies which, for example, may be arranged as sheets, and curvature of the corrugations may be varied as appropriate, so as to minimize pressure drop while also maximizing entrained fluid droplets. The droplets can be entrained through inertial impaction, interception, and coalescence.

Additionally, the geometries discussed elsewhere herein (e.g., having numerous capillary flow paths) would have the ability to route (e.g., wick) fluid away (e.g., down) through internal flow paths, thus removing the fluid and preventing re-aerosolization into the gas stream. This capability can provide a significant advantage over traditional solid sheets of thermoplastic, which cannot perform comparably. Further, because the contactor media and geometries disclosed herein can have more readily wetted surfaces than conventional media, droplets are more likely to be entrained upon impact with the surface, as opposed to first wetting a solid surface and having to collide with other droplets while on this surface.

Additionally, because many of the disclosed approaches can be implemented with 3D printing technology, more extreme curvatures of corrugation can be produced than can be conventionally thermo-formed or bent from plastic and/or metal sheeting. Consequently, geometries can be achieved (higher amplitude of corrugation with shorter wavelengths in the direction of gas flow) which result in higher inertial impaction rates, thus facilitating enhanced coalescence.

### Example 17

In some implementations, the contactor media disclosed herein may be used in liquid distribution and interstitial re-distribution trays. For example, efficient liquid distribution can be essential to the performance of structured packing systems (e.g., as used in mass transfer operations including distillation, absorption, and stripping). Uniform distribution of the liquid phase across the packing cross-section can help to ensure optimal surface wetting, maximized interfacial area, and consistent mass transfer rates. In contrast, poor distribution can lead to (liquid) channeling, dry spots, and reduced efficiency. To address these performance aspects, internal media of conventional packed columns can incorporate advanced (e.g., and costly) distribution technologies-including interstitial distribution trays—to ensure precise liquid delivery over structured packing beds.

Conventional interstitial distribution trays are typically thin, perforated trays embedded directly within the structured packing bed. These trays can be spaced at regular intervals along a column (e.g., every 4 to 6 meters) to intercept and redistribute the liquid, e.g., through an array of calibrated drip points or orifices, ensuring uniform wetting of the downstream packing section).

Further, structured packings, typically composed of simple metal or plastic sheets (or other simple structures), may rely on gravity-driven film flow over inclined surfaces to create a high-surface-area interface between phases. For this flow regime to be effective, liquid must enter the packing uniformly both axially and radially. Achieving desired uniformity can be especially challenging in large-diameter columns or when operating under low liquid load conditions.

In this regard, liquid distributors can be installed above the packing to provide initial distribution, e.g., in the form of troughs, orifices, or spray nozzles. However, even with a well-designed top distributor of this type, redistribution may become necessary at intervals along the column height (e.g., to correct for any developing maldistribution or wall-flow effects). In conventional approaches,

Using contactor media disclosed herein, Inventors observed enhanced mixing and distribution capabilities over and above those produced by traditional orifice/drip point based systems. For example, improved performance relative to conventional systems can be provided by the distribution contactor media shown in FIG. 26B or the interstitial distribution contactor media shown in FIG. 27B. Thus, these and other contactor media configurations disclosed herein can provide improved top and interstitial distribution, which may significantly improve the ability to evenly dispense liquid that arrives in the tray.

Further, because these features can be directly integrated into the designs of the contactor media disclosed herein, liquid can be routed directly onto the contactor body with flow paths described herein (e.g., rather than using additional different structures as in some conventional approaches). An example of this is shown in FIG. 49 in which a corrugated segment is used to ‘catch’ falling fluid, through impaction and interception, so that it enters the capillary domain within the structured sheet. This capture and routing of liquid, in turn, feeds the remainder of the contactor media below this region for corresponding beneficial performance as variously discussed herein. Moreover, although only a limited region of corrugation is illustrated in some examples herein, it is possible to include corrugations as often as needed—and at any variety of appropriate locations-including without requiring a separate tray. In this way, aspects of the above-described embodiments may enable hybrid type systems in which liquid distribution and re-distribution is an integrated part of packing media design.

Furthermore, the methodologies described above could be used in conjunction with conventional distribution apparatuses (e.g. simple sheet, in combination with misters). Through these design strategies, one may be able to reduce the cost and complexity of the traditional distribution apparatus. For example, in an orifice distributor, the cost and number of orifices are correlated. Accordingly, increasing the pitch between orifices in combination with the contactor media disclosed herein may offer a more cost-effective solution than conventional approaches while still maintaining the performance of a shorter-pitch design.

### Example 18

In another aspect, the contactor media disclosed herein may be used as random packing. In some cases, one or more contactor bodies as described above may be used as random packing.

The contactor bodies used for random packing may be uniform in shape and dimension or they may have a range of size and shapes. In some cases, the contactor bodies used for random packing may have at least one dimension of about 0.1 inches to about 40.0 inches, about 0.25 inches to about 10.0 inches, of about 0.50 inches to about 5.00 inches, or about 0.50 inches to about 2.00 inches. In some cases, the contactor body may be cubic, spherical, conical, cylindrical, prismatic, or any combination thereof.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation, or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

As used herein, unless otherwise specified or limited, “substantially parallel” indicates a direction that is within ±12 degrees of a reference direction (e.g., within ±6 degrees or ±3 degrees), inclusive. Similarly, unless otherwise specified or limited, “substantially perpendicular” similarly indicates a direction that is within ±12 degrees of perpendicular a reference direction (e.g., within ±6 degrees or ±3 degrees), inclusive. Correspondingly, “substantially vertical” indicates a direction that is substantially parallel to the vertical direction, as defined relative to the reference system (e.g., a local direction of gravity, by default), with a similarly derived meaning for “substantially horizontal” (relative to the horizontal direction). Discussion of directions “transverse” to a reference direction indicate directions that are not substantially parallel to the reference direction. Correspondingly, some transverse directions may be perpendicular or substantially perpendicular to the relevant reference direction.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A contactor media comprising:
continuous surface segments, forming a contactor body;
wherein at least 50% of a surface area of a first continuous surface segment follows at least one contour selected from the group consisting of (a) a first contour of a first zero-thickness surface having a Gaussian curvature (“G_{c}”) of −400 mm⁻²≤G_{c}<−0.01 mm⁻²; (b) a second contour of a second zero-thickness surface having at least one principal curvature (kᵢ) of −20 mm⁻¹≤kᵢ<−0.1 mm⁻¹, or any combinations thereof.

2. The contactor media of claim 1, wherein the at least one contour defines a first continuous capillary flow path extending in a first direction across the contactor body;
wherein the contactor body further defines a second continuous capillary flow path extending in the first direction across the contactor body and spaced apart from the first continuous capillary flow path transverse to the first direction; and
wherein the first continuous capillary flow path and the second capillary continuous flow path are separated by one or more inactive surfaces such that flow from the first continuous capillary flow path to second continuous capillary flow path crosses the inactive surfaces transverse to the first direction.

3. The contactor media of claim 2, wherein the contactor body includes a first terminal end, a second terminal end disposed opposite the first terminal end, a first terminal side, and a second terminal side disposed opposite the first terminal side, the first and second terminal sides extending between the first and second terminal ends; and
wherein the first direction of the first continuous flow path extends in a direction from the first terminal side of the contactor body to the second terminal side of the contactor body.

4. The contactor media of claim 2, wherein the contactor body forms a corrugation with an axis substantially parallel to the first continuous capillary flow path, the first continuous capillary flow path extending onto or along the corrugation.

5. The contactor media of claim 2, wherein the contactor body includes a corrugation with an axis substantially perpendicular to the first continuous capillary flow path, the first continuous capillary flow path extending across the corrugation.

6. The contactor media of claim 2, wherein the contactor body includes a multi-axis corrugation.

7. The contactor media of claim 1, further comprising an interstitial structure extending from the first continuous surface segment into a continuous flow path defined by the at least one contour.

8. The contactor media of claim 7, wherein the interstitial structure is a lattice structure.

9. The contactor media of claim 8, wherein the lattice structure defines a rectangular grid.

10. The contactor media of claim 7, wherein a hydraulic diameter provided by the interstitial structure in combination with the first continuous surface segment along the continuous flow path is between 0.2 mm and 4 mm.

11. The contactor media of claim 1, wherein the at least one contour defines a first continuous flow path extending in a first direction across the contactor body; and
wherein a hydraulic diameter provided by the at least one contour along the continuous flow path is between 0.2 mm and 4 mm.

12. A contactor system comprising:
a rich material feed configured to transfer rich material to a capture unit;
a capture liquid feed configured to transfer a capture fluid to the capture unit;
the capture unit, including a contactor media that includes continuous surface segments that form a contactor body,
wherein at least 50% of its surface area of a first continuous surface segment of the continuous surface segments follows at least one contour selected from the group consisting of (a) a first contour of a first zero-thickness surface having a Gaussian curvature (“G_{c}”) of −400 mm⁻²≤G_{c}<−0.01 mm⁻²; (b) a second contour of a second zero-thickness surface having at least one principal curvature (kᵢ) of −20 mm⁻¹≤kᵢ<−0.1 mm⁻¹, or any combinations thereof; and
the first continuous surface segment of the contactor media configured to support the rich material to interact with the capture liquid, to produce a captured material.

13. The system of claim 12, wherein the rich material feed includes a fluid.

14. The system of claim 13, wherein the fluid is selected from the group consisting of ambient atmosphere, a point source, or a combination thereof.

15. The system of claim 13, wherein the fluid includes carbon dioxide, a sulfur-containing compound, or any combinations thereof.

16. The system of claim 12, wherein the capture fluid includes a liquid.

17. The system of claim 16, wherein the liquid includes MEA (monoethanolamine), DEA (diethanolamine), TEA (triethanolamine), MDEA (methyl diethanolamine), piperazine, glycine, KVO3 (potassium metavanadate), KOH (potassium hydroxide), NaOH (sodium hydroxide), LiOH (lithium hydroxide), Ca(OH)2 (calcium hydroxide), an amino acid, or any combinations thereof.

18. The system of claim 12, further comprising a recycled capture liquid feed configured to transfer recycled capture liquid from a captured materials processing unit to the capture unit.

19. A method of capturing a material, comprising:
wetting at least a portion of a contactor media with a capture liquid, the contactor media comprising continuous surface segments, forming a contactor body,
wherein wetting at least the portion of the contactor media includes wetting a first continuous surface segment of the continuous surface segments, at least 50% of the surface area of the first continuous surface segment follows at least one contour selected from the group consisting of (a) a first contour of a first zero-thickness surface having a Gaussian curvature (“G_{c}”) of −400 mm⁻²≤G_{c}<−0.01 mm⁻²; (b) a second contour of a second zero-thickness surface having at least one principal curvature (kᵢ) of −20 mm⁻¹≤kᵢ<−0.1 mm⁻¹, or any combinations thereof;
flowing a rich material across the contactor media; and
reacting the rich material with the capture liquid to produce a deplete material and a captured material.

20. The method of claim 19, wherein the contour defines a first continuous capillary flow path transversing across the contactor body;
a second continuous capillary flow path transversing across the contactor body disposed below the first a first continuous capillary flow path; and
wherein the first continuous capillary flow path and the second capillary continuous flow path are separated by inactive surfaces such that flow between the first continuous capillary flow path and second continuous capillary flow path crosses the inactive surfaces.
